(19) United States
(12) Patent Application Publication
(10) Pub. No.: US 2022/0178691 A1
(43) Pub. Date: Jun. 9, 2022

(54) Sleeves and Uses Thereof

(71) Applicant: Bruce R. Prince, Tequesta, FL (US)

(72) Inventor: Bruce R. Prince, Tequesta, FL (US)

(21) Appl. No.: 17/519,912

(22) Filed: Nov. 5, 2021

Related U.S. Application Data
(60) Provisional application No. 63/110,079, filed on Nov. 5, 2020.

(51) Int. Cl. G01C 15/06

(52) U.S. Cl. CPC G01C 15/06

(57) ABSTRACT

Disclosed herein are sleeves for use with horizontal, angular, and vertical protrusions and for use with electrical and liquid conduits. Disclosed herein are methods for using a disclosed sleeve to improve, for example, visibility of a horizontal, angular, or vertical protrusion or an electrical or a liquid conduit. Disclosed herein are methods for protecting a horizontal, angular, or vertical protrusion or an electrical or a liquid conduit from physical damage and/or positional displacement.

### CROSS-REFERENCE TO RELATED APPLICATION

This application claims the benefit of priority to U.S. Provisional Patent Application No. 63/110,079 filed 5 Nov. 2020, the entirety of which is incorporated by reference herein.

### BACKGROUND

Surveying has been an essential element in the history of human development and it is a requirement in the planning and execution of nearly every form of construction. Surveying is the technique and science of accurately determining the terrestrial or three-dimensional position of points and the distance and angles between them. Over time, the basic tools of planar surveying have evolved and those persons skilled in the art commonly employ survey stakes to indicate boundary lines, section corners, and other important locations during the constructions of bridges, buildings, roads, and other structures. Typically, a survey stake is driven into the ground so that the top of the survey stake extends approximately 18″ to 24″ above ground. Because survey stakes are typically located active construction zones (which are busy, noisy, and crowded with people and heavy machinery) or on partially developed or undeveloped land (which can be difficult to access and overgrown with vegetation), this portion of the survey stake is susceptible to physical damage and positional displacement. Moreover, physical damage and positional displacement can also plague other types of protrusions (e.g., vertical, horizontal, or angular protrusions) and conduits (e.g., liquid or electrical conduits) in active construction zones or on partially developed or undeveloped land. What is needed in the art is a way to readily and easily visualize protrusions (such as a vertical protrusion like a survey stake) and conduits (such as a liquid conduit or an electrical conduit) in construction zones or on partially developed or undeveloped land despite difficult conditions (such as the presence and operation of heavy machinery).

### BRIEF SUMMARY

Disclosed herein are sleeves for a vertical, horizontal, or angular protrusion. Disclosed herein are sleeves for an electrical conduit or a liquid conduit.

Disclosed herein is a sleeve for placement on a horizontal or angular protrusion, comprising an elongate body comprising an upper portion and a lower portion, wherein each portion of the elongate body comprises an open end, wherein the upper portion comprises a reflective material, and wherein the lower portion directly contacts a horizontal or angular protrusion. Disclosed herein is a sleeve for placement on a horizontal or angular protrusion, comprising an elongate body comprising an upper portion and a lower portion, wherein the upper portion of elongate body comprises a closed end, and wherein the lower portion of the elongate body comprises an open end, wherein the upper portion comprises a reflective material, and wherein the lower portion directly contacts a horizontal or angular protrusion.

Disclosed herein is a sleeve for placement on a horizontal or angular protrusion, comprising an elongate body comprising an upper portion and a lower portion, wherein each portion of the elongate body comprises an open end, wherein the upper portion comprises a reflective material and one or more wind vents, and wherein the lower portion directly contacts a horizontal or angular protrusion. Disclosed herein is a sleeve for placement on a horizontal or angular protrusion, comprising an elongate body comprising an upper portion and a lower portion, wherein the upper portion of elongate body comprises a closed end, and wherein the lower portion of the elongate body comprises an open end, wherein the upper portion comprises a reflective material and one or more wind vents, and wherein the lower portion directly contacts a horizontal or angular protrusion.

Disclosed herein are sleeves for a vertical protrusion. Disclosed herein is a sleeve for placement on a vertical protrusion, comprising an elongate body comprising an upper portion and a lower portion, wherein each portion of the elongate body comprises an open end, wherein the upper portion comprises a reflective material, and wherein the lower portion directly contacts a vertical protrusion. Disclosed herein is a sleeve for placement on a vertical protrusion, comprising an elongate body comprising an upper portion and a lower portion, wherein the upper portion of elongate body comprises a closed end and wherein the lower portion of the elongate body comprises an open end, wherein the upper portion comprises a reflective, and wherein the lower portion directly contacts a vertical protrusion. Disclosed herein is a sleeve for placement on a vertical protrusion, comprising an elongate body comprising an upper portion and a lower portion, wherein each portion of the elongate body comprises an open end, wherein the upper portion comprises a reflective material and one or more wind vents, and wherein the lower portion directly contacts a vertical protrusion. Disclosed herein is a sleeve for placement on a vertical protrusion, comprising an elongate body comprising an upper portion and a lower portion, wherein the upper portion of elongate body comprises a closed end and wherein the lower portion of the elongate body comprises an open end, wherein the upper portion comprises a reflective material and one or more wind vents, and wherein the lower portion directly contacts a vertical protrusion.

Disclosed herein are sleeves for a survey stake. Disclosed herein is a sleeve for placement on a survey stake, comprising an elongate body comprising an upper portion and a lower portion, wherein each portion of the elongate body comprises an open end, wherein the upper portion comprises a reflective material, and wherein the lower portion directly contacts a survey stake. Disclosed herein is a sleeve for placement on a survey stake, comprising an elongate body comprising an upper portion and a lower portion, wherein the upper portion of elongate body comprises a closed end and wherein the lower portion of the elongate body comprises an open end, wherein the upper portion comprises a reflective material, and wherein the lower portion directly contacts a survey stake. Disclosed herein is a sleeve for placement on a survey stake, comprising an elongate body comprising an upper portion and a lower portion, wherein each portion of the elongate body comprises an open end, wherein the upper portion comprises a reflective material and one or more wind vents, and wherein the lower portion directly contacts a survey stake. Disclosed herein is a sleeve for placement on a survey stake, comprising an elongate body comprising an upper portion and a lower portion, wherein the upper portion of elongate body comprises a closed end and wherein the lower portion of the elongate body comprises an open end, wherein the upper portion comprises a reflective material and one or more wind vents, and wherein the lower portion directly contacts a survey stake.

Disclosed herein are sleeves for an electrical conduit. Disclosed herein is a sleeve for placement on an electrical conduit, comprising an elongate body comprising an upper portion and a lower portion, wherein each portion of the elongate body comprises an open end, wherein the upper portion comprises a reflective material, and wherein the lower portion directly contacts an electrical conduit. Disclosed herein is a sleeve for placement on an electrical conduit, comprising an elongate body comprising an upper portion and a lower portion, wherein the upper portion of elongate body comprises a closed end and wherein the lower portion of the elongate body comprises an open end, wherein the upper portion comprises a reflective material, and wherein the lower portion directly contacts an electrical conduit. Disclosed herein is a sleeve for placement on an electrical conduit, comprising an elongate body comprising an upper portion and a lower portion, wherein each portion of the elongate body comprises an open end, wherein the upper portion comprises a reflective material and one or more wind vents, and wherein the lower portion directly contacts an electrical conduit. Disclosed herein is a sleeve for placement on an electrical conduit, comprising an elongate body comprising an upper portion and a lower portion, wherein the upper portion of elongate body comprises a closed end and wherein the lower portion of the elongate body comprises an open end, wherein the upper portion comprises a reflective material and one or more wind vents, and wherein the lower portion directly contacts an electrical conduit.

Disclosed herein are sleeves for a liquid conduit. Disclosed herein is a sleeve for placement on a liquid conduit, comprising an elongate body comprising an upper portion and a lower portion, wherein each portion of the elongate body comprises an open end, wherein the upper portion comprises a reflective material, and wherein the lower portion directly contacts a liquid conduit. Disclosed herein is a sleeve for placement on a liquid conduit, comprising an elongate body comprising an upper portion and a lower portion, wherein the upper portion of elongate body comprises a closed end and wherein the lower portion of the elongate body comprises an open end, wherein the upper portion comprises a reflective material, and wherein the lower portion directly contacts a liquid conduit. Disclosed herein is a sleeve for placement on a liquid conduit, comprising an elongate body comprising an upper portion and a lower portion, wherein each portion of the elongate body comprises an open end, wherein the upper portion comprises a reflective material and one or more wind vents, and wherein the lower portion directly contacts a liquid conduit. Disclosed herein is a sleeve for placement on a liquid conduit, comprising an elongate body comprising an upper portion and a lower portion, wherein the upper portion of elongate body comprises a closed end and wherein the lower portion of the elongate body comprises an open end, wherein the upper portion comprises a reflective material and one or more wind vents, and wherein the lower portion directly contacts a liquid conduit

Disclosed herein are methods for using a disclosed sleeve for a vertical, horizontal, or angular protrusion or for an electrical conduit or a liquid conduit.

Disclosed herein is a method comprising positioning a sleeve on an exposed aspect of a horizontal or angular protrusion. Disclosed herein is a method comprising identifying a horizontal or angular protrusion and positioning a sleeve onto an exposed aspect of the horizontal or angular protrusion. Disclosed herein is a method comprising positioning a sleeve onto an exposed aspect of a vertical protrusion. Disclosed herein is a method comprising identifying a vertical protrusion and positioning a sleeve onto an exposed aspect of the vertical protrusion. Disclosed herein is a method comprising positioning a sleeve on an exposed aspect of a survey stake. Disclosed herein is a method comprising identifying a survey stake and positioning a sleeve on an exposed aspect of the survey stake. Disclosed herein is a method comprising positioning a sleeve on an exposed aspect of an electrical conduit. Disclosed herein is a method comprising identifying an electrical conduit and positioning a sleeve on an exposed aspect of the electrical conduit. Disclosed herein is a method comprising positioning a sleeve on an exposed aspect of a liquid conduit. Disclosed herein is a method comprising identifying a liquid conduit and positioning a sleeve on an exposed aspect of the liquid conduit.

Disclosed herein are methods of improving visibility of a horizontal, angular, or vertical protrusion. Disclosed herein are methods of improving visibility of an electrical or a liquid conduit. Disclosed herein is a method comprising positioning a sleeve on an exposed aspect of a horizontal or angular protrusion and improving the visibility of the sleeve. Disclosed herein is a method comprising positioning a sleeve on an exposed aspect of a vertical protrusion and improving the visibility of the sleeve. Disclosed herein is a method comprising positioning a sleeve on an exposed aspect of a survey stake and improving the visibility of the sleeve. Disclosed herein is a method comprising positioning a sleeve on an exposed aspect of an electrical conduit and improving the visibility of the sleeve. Disclosed herein is a method comprising positioning a sleeve on an exposed aspect of a liquid conduit and improving the visibility of the sleeve.

Disclosed herein is a kit comprising one or more disclosed sleeves. Disclosed herein is a kit comprising one or more disclosed sleeves and instructions for using the one or more disclosed sleeves. Disclosed herein is a kit comprising one or more disclosed sleeves and reflective material. Disclosed herein is a kit comprising one or more disclosed sleeves, reflective material, and instructions for using the one or more disclosed sleeves. Disclosed herein is a kit comprising one or more disclosed sleeves, reflective material, and instructions for applying reflective material. Disclosed herein is a kit comprising one or more disclosed sleeves, reflective material, instructions for applying reflective material, and instructions for using the one or more disclosed sleeves. Disclosed herein is a kit comprising one or more disclosed sleeves, and instructions for repairing one or more disclosed sleeves, instructions for using the one or more disclosed sleeves, or a combination thereof.

### BRIEF DESCRIPTION OF THE DRAWINGS

FIG. 1A shows a disclosed sleeve positioned on the exposed aspect of a horizontal protrusion.

FIG. 1B shows a disclosed sleeve positioned on the exposed aspect of an angular protrusion.

FIG. 1C shows a disclosed sleeve positioned on the exposed aspect of an vertical protrusion (such as a survey stake) or a conduit (such as an electrical conduit or a liquid conduit).

FIG. 2A is a cross-sectional view showing a disclosed sleeve (solid border) positioned on a protrusion or a conduit having a rectangular cross-sectional shape (hatched).

FIG. 2B is a cross-sectional view showing a disclosed sleeve (solid border) positioned on a protrusion or a conduit having a square cross-sectional shape (hatched).

FIG. 2C is a cross-sectional view showing a disclosed sleeve (solid border) positioned on a protrusion or a conduit having a circular cross-sectional shape (hatched).

FIG. 3A shows a disclosed sleeve for a protrusion or a conduit having reflective material in a chevron pattern.

FIG. 3B shows a disclosed sleeve for a protrusion or a conduit having horizontal stripes or bands of reflective material.

FIG. 3C shows a disclosed sleeve for a protrusion or a conduit having vertical strips or bands of reflective material.

FIG. 4A shows a disclosed sleeve for a protrusion or a conduit having a series of crescent-moon shaped wind vents.

FIG. 4B shows a disclosed sleeve for a protrusion or a conduit having circular-shaped wind vents.

FIG. 4C shows a disclosed sleeve for a protrusion or a conduit having slit-shaped wind vents.

FIG. 5 shows disclosed sleeve having a cap and 3 bands of reflective material.

### DETAILED DESCRIPTION

The present invention can be understood more readily by reference to the following detailed description of the invention.

Before the present compositions and methods are disclosed and described, it is to be understood that they are not limited to specific compositions and methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example compositions and methods are now described.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention.

### A. Definitions

As used in the specification and the appended claims, the singular forms “a”, “an”, and “the” include plural referents unless the context clearly dictates otherwise.

The phrase “consisting essentially of” limits the scope of a claim to the recited components in a composition or the recited steps in a method as well as those that do not materially affect the basic and novel characteristic or characteristics of the claimed composition or claimed method. The phrase “consisting of” excludes any component, step, or element that is not recited in the claim. The phrase “comprising” is synonymous with “including”, “containing”, or “characterized by”, and is inclusive or open-ended. “Comprising” does not exclude additional, unrecited components or steps.

As used herein, when referring to any numerical value, the term “about” means a value falling within a range that is ±10% of the stated value. Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

References in the specification and concluding claims to parts by weight of a particular element or component in a composition denotes the weight relationship between the element or component and any other elements or components in the composition or article for which a part by weight is expressed. Thus, in a compound containing 2 parts by weight component X and 5 parts by weight component Y, X and Y are present at a weight ratio of 2:5, and are present in such ratio regardless of whether additional components are contained in the compound.

As used herein, the terms “optional” or “optionally” means that the subsequently described event or circumstance can or cannot occur, and that the description includes instances where said event or circumstance occurs and instances where it does not. In an aspect, a disclosed method can optionally comprise one or more additional steps, such as, for example, repeating a reusing step.

As used herein, the term “prevent” or “preventing” refers to precluding, averting, obviating, forestalling, stopping, or hindering something from happening, especially by advance action. It is understood that where reduce, inhibit, or prevent are used herein, unless specifically indicated otherwise, the use of the other two words is also expressly disclosed.

As used herein, “modifying the method” can comprise modifying or changing one or more features or aspects of one or more steps of a disclosed method. For example, in an aspect, a disclosed method can be altered by applying one or more additional layers to a disclosed sleeve.

As used herein, “determining” can refer to measuring or ascertaining the dimensions, such as, for example, height, width, length, and diameter, of an exposed protrusion or an exposed conduit. Dimensions include length (how long an object is), depth (how deep an object is), height (how tall an object is), and diameter (the size of the longest chord of the circle). Methods and techniques used to determining the dimensions of a protrusion or a conduit are well known to the art.

As used herein, “protective” refers to the ability of a disclosed sleeve to protect an exposed horizontal, angular, or vertical protrusion and to protect an electrical conduit or a liquid conduit. In an aspect, a disclosed sleeve protects a protrusion or conduit by maximizing visibility and by minimizing physical damage and positional displacement. A disclosed sleeve can also protect a protrusion or conduit from damage incurred by the environment (such as, for example, weather, pollutants, etc.).

The art is familiar with reflectivity and reflective material. Reflectivity does not create its own light, but rather, borrows light from another source. The borrowed light waves strike an object and “bounce” from it. The reflectance of the object—how bright it shines—can depend on the intensity of the light striking it as well as the materials from which it is made. Reflectivity can comprise diffuse reflection, mirror reflection, and retroreflection. Diffuse reflection is the most common type of reflectivity and occurs when light strikes rough surfaces, such as pavement, foliage, clothing, and vehicles. These surfaces cause the light beams to scatter in all directions. Only a small amount of the light is reflected back toward the source. Diffuse surfaces offer low nighttime visibility to drivers. Mirror (specular) reflection occurs when light strikes surfaces that are smooth or glossy. The light reflects off the surfaces at an equal, but opposite angle to the source. If the surface is at an exact right angle to the vehicle, then it will return the light to the source. But most mirror surfaces on the road will be at angles that reflect the light away from the driver's eyes. Retroreflection occurs when surfaces return a portion of the directed light to its source. This is why retroreflective materials appear brightest to observers located near the light source—a driver and the vehicle headlights, for example. This is true for drivers and operators of heavy machinery at almost any viewing angle, which makes retroreflective surfaces.

Disclosed are the components to be used to prepare a disclosed sleeve as well as the components used within the methods disclosed herein. These and other materials are disclosed herein, and it is understood that when combinations, subsets, interactions, groups, etc. of these materials are disclosed that while specific reference of each various individual and collective combinations and permutation of these systems cannot be explicitly disclosed, each is specifically contemplated and described herein. For example, if a particular sleeve is disclosed and discussed and a number of modifications that can be made to that sleeve are discussed, specifically contemplated is each and every combination and permutation of the sleeve and the modifications that are possible unless specifically indicated to the contrary. This concept applies to all aspects of this application including, but not limited to, steps in methods of making and using a disclosed sleeve. Thus, if there are a variety of additional steps that can be performed, then it is understood that each of these additional steps can be performed with any specific embodiment or combination of embodiments of the methods of the invention.

### B. Sleeves

Disclosed herein are sleeves for a vertical, horizontal, or angular protrusion. Disclosed herein are sleeves for an electrical conduit or a liquid conduit.

### 1. Sleeves for a Horizontal or Angular Protrusion

Disclosed herein are sleeves for a horizontal or angular protrusion.

Disclosed herein is a sleeve for placement on a horizontal or angular protrusion, comprising an elongate body comprising an upper portion and a lower portion, wherein each portion of the elongate body comprises an open end, wherein the upper portion comprises a reflective material, and wherein the lower portion directly contacts a horizontal or angular protrusion. Disclosed herein is a sleeve for placement on a horizontal or angular protrusion, comprising an elongate body comprising an upper portion and a lower portion, wherein the upper portion of elongate body comprises a closed end, and wherein the lower portion of the elongate body comprises an open end, wherein the upper portion comprises a reflective material, and wherein the lower portion directly contacts a horizontal or angular protrusion. Disclosed herein is a sleeve for placement on a horizontal or angular protrusion, comprising an elongate body comprising an upper portion and a lower portion, wherein each portion of the elongate body comprises an open end, wherein the upper portion comprises a reflective material and one or more wind vents, and wherein the lower portion directly contacts a horizontal or angular protrusion. Disclosed herein is a sleeve for placement on a horizontal or angular protrusion, comprising an elongate body comprising an upper portion and a lower portion, wherein the upper portion of elongate body comprises a closed end, and wherein the lower portion of the elongate body comprises an open end, wherein the upper portion comprises a reflective material and one or more wind vents, and wherein the lower portion directly contacts a horizontal or angular protrusion.

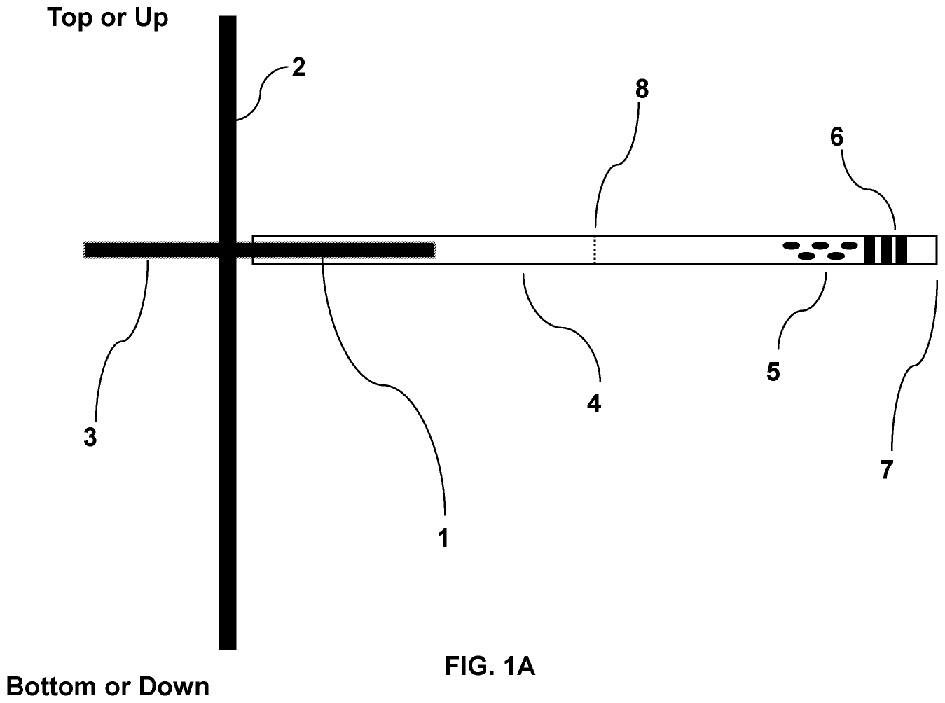

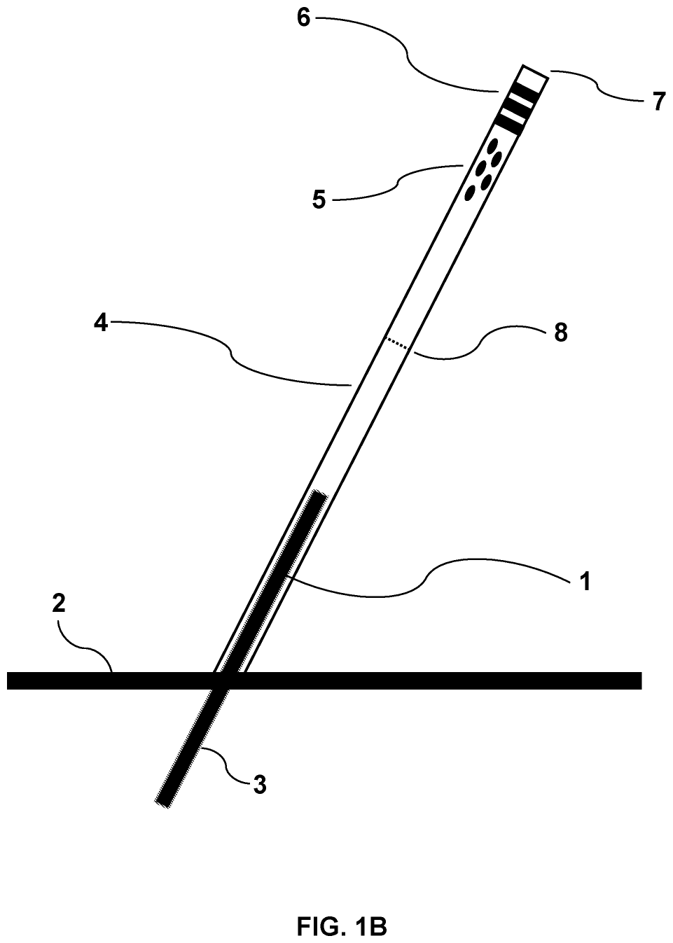

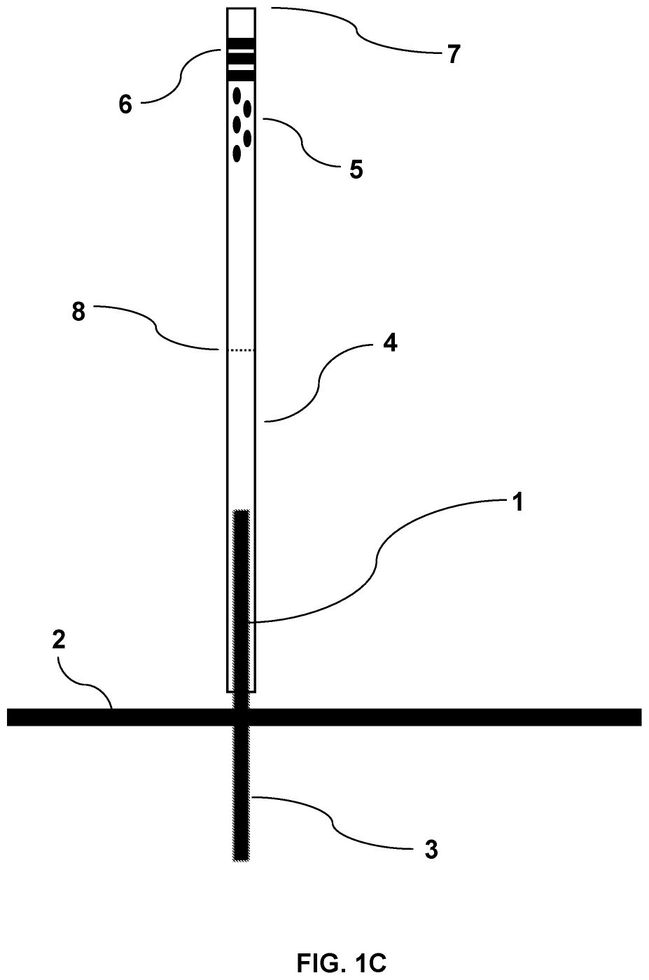

FIG. 1A shows an exemplary disclosed sleeve (4) positioned on the exposed aspect of a horizontal protrusion (1). The lower portion of the exemplary disclosed sleeve directly contacts the exposed aspect (1) of the horizontal protrusion. The unexposed or nonexposed aspect (3) of the horizontal protrusion is behind the surface of a wall or a bulkhead or other surface. The disclosed sleeve comprises an upper portion and a lower portion, which is indicated (for convenience only) by a dotted line (8). The upper portion comprises reflective material (6) and one or more wind vents (5). The end (7) of the upper portion of the disclosed sleeve can either be opened or closed. The orientation for the horizontal protrusion is also shown. Top or Up means above the horizontal protrusion (e.g., towards the ceiling or the sky) while Bottom or Down means below the horizontal protrusion (e.g., towards the floor or the ground).

FIG. 1B shows an exemplary disclosed sleeve (4) positioned on the exposed aspect of an angular protrusion (1). The lower portion of the exemplary disclosed sleeve directly contacts the exposed aspect (1) of the angular protrusion. The unexposed or nonexposed aspect (3) of the angular protrusion is behind the surface of a wall or a bulkhead or other surface or the ground or a floor or a ceiling. The disclosed sleeve comprises an upper portion and a lower portion, which is indicated (for convenience only) by a dotted line (8). The upper portion comprises reflective material (6) and one or more wind vents (5). The end (7) of the upper portion of the disclosed sleeve can either be opened or closed. In an aspect, the upper portion of a disclosed sleeve can comprise a cap.

In an aspect, a disclosed sleeve for a horizontal or angular protrusion can be one piece having no seam. In an aspect, a disclosed sleeve for a horizontal or angular protrusion can be one piece having a connectable or closeable seam along part of or the whole length of the sleeve. In an aspect, a disclosed sleeve for a horizontal or angular protrusion can be one piece having an open seam along part of or the whole length of the sleeve.

In an aspect, a horizontal or angular can comprise a stake or a conduit. In an aspect, a stake can comprise a survey stake. In an aspect, a conduit can comprise a liquid conduit or an electrical conduit. In an aspect, a liquid conduit can comprise a tube, pipe, or channel for conveying water or other fluid. In an aspect, an electrical conduit can comprise a tube or trough for protecting electrical wiring. In an aspect, an electrical conduit can be a rigid metal conduit, an intermediate metal conduit, an electrical metallic tubing, an electrical non-metallic tubing, a flexible metal conduit, a liquid-tight flexible metal conduit, or a rigid polyvinyl chloride conduit.

In an aspect, a disclosed sleeve can be reusable. Reusable means that a disclosed sleeve is capable of being used again or repeatedly.

In an aspect, a disclosed sleeve can be positioned on the exposed aspect of a horizontal or angular protrusion. In an aspect, the term “positioned on” can mean that the inside of a disclosed sleeve can directly contact the exposed aspect of a horizontal or angular protrusion. For example, a disclosed sleeve can fit over and around the exposed aspect of a horizontal or angular vertical protrusion. In an aspect, the term “exposed” can refer to that aspect of a horizontal or angular protrusion that extends from the surface of the ground or the earth, or the surface of a floor or wall or ceiling or roof, or the surface of a construction site, or the like. The non-exposed or unexposed aspect of a horizontal or angular protrusion is that aspect that is below the surface of the ground or the earth, or the surface of a floor or wall or ceiling or roof, or the surface of construction site, or the like.

In an aspect, a disclosed sleeve can directly contact about 12″ to about 60″ or about 24″ to about 48″ of an exposed horizontal or angular protrusion. In an aspect, a disclosed sleeve can directly contact about 24″, about 36″, or about 48″ of an exposed horizontal or angular protrusion.

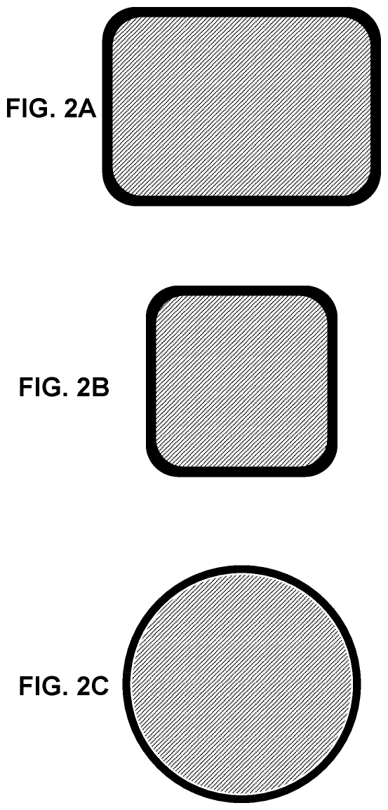

In an aspect, a disclosed sleeve for a horizontal or angular protrusion can comprise a rectangular cross-sectional shape. FIG. 2A is a cross-sectional view showing a disclosed sleeve (solid border) positioned on a protrusion (such as a horizontal or angular protrusion) or a conduit having a rectangular cross-sectional shape (hatched).

In an aspect, disclosed sleeve comprising a rectangular cross-sectional shape can be about ¾″ in width to about ¾″ in width and about 1¼″ to about 1¾″ in height. In an aspect, disclosed sleeve comprising a rectangular cross-sectional shape can be about ½″ in width and about 1½″ in height. In an aspect, a disclosed sleeve comprising a rectangular cross-sectional shape can accommodate the size of any exposed horizontal or angular protrusion also having a rectangular cross-sectional shape. For example, if an exposed horizontal or angular protrusion is about ½″ in width and about 1½″ in height, then the disclosed sleeve is at least ½″ in width and at least 1½″ in height. For example, if an exposed horizontal or angular protrusion is about 1½″ in width and about 1½″ in height, then the disclosed sleeve is at least 1½″ in width and at least 1½″ in height.

In an aspect, a disclosed sleeve for a horizontal or angular protrusion can comprise a square cross-sectional shape. FIG. 2B is a cross-sectional view showing a disclosed sleeve (solid border) positioned on a protrusion (such as a horizontal or angular protrusion) or a conduit having a square cross-sectional shape (hatched).

In an aspect, a disclosed sleeve comprising a square cross-sectional shape can be about ¼″ to about 6″ both in width and in height. In an aspect, a disclosed sleeve comprising a square cross-sectional shape can be about ¾″ in width and in height, or about ½″ in width and in height, or about ¾″ in width and in height, or about 1″ in width and in height, or about 1¼″ in width and in height, or about 1½″ in width and in height, or about 1¾″ in width and in height, or about 2″ in width and in height, or about 2¼″ in width and in height, or about 2½″ in width and in height, or about 2¾″ in width and in height, or about 3″ in width and in height, or about 3V in width and in height, or about 3½″ in width and in height, or about 3¾″ in width and in height, or about 4″ in width and in height, or about 4V in width and in height, or about 4½″ in width and in height, or about 4¾″ in width and in height, or about 5″ in width and in height, or about 5V in width and in height, or about 5½″ in width and in height, or about 5¾″ in width and in height, or about 6″ in width and in height. In an aspect, a disclosed sleeve comprising a square cross-sectional shape can accommodate the size of any exposed horizontal or angular protrusion also having a square cross-sectional shape. For example, if an exposed horizontal or angular protrusion is about 1″ in width and about 1″ in height, then the disclosed sleeve is at least 1″ in width and at least 1″ in height. For example, if an exposed horizontal or angular protrusion is about 2″ in width and about 2″ in height, then the disclosed sleeve is at least 2″ in width and at least 2″ in height.

In an aspect, a disclosed sleeve for a horizontal or angular protrusion can comprise a circular cross-sectional shape. FIG. 2C is a cross-sectional view showing a disclosed sleeve (solid border) positioned on a protrusion (such as a horizontal or angular protrusion) or a conduit having a circular cross-sectional shape (hatched).

In an aspect, a disclosed sleeve comprising a circular cross-sectional shape can be about ¾″ to about 6″ in diameter. In an aspect, a disclosed sleeve comprising a circular cross-sectional shape can be about ¾″ in diameter, about ½″ in diameter, about ¾″ in diameter, about 1″ in diameter, about 1¾″ in diameter, about 1½″ in diameter, about 1¾″ in diameter, about 2″ in diameter, about 2¾″ in diameter, about 2½″ in diameter about 2¾″ in diameter, about 3″ in diameter, about 3¼″ in diameter, about 3½″ in diameter, about 3¾″ in diameter, about 4″ in diameter, about 4V in diameter, about 4½″ in diameter, about 4¾″ in diameter, about 5″ in diameter, about 5V in diameter, about 5½″ in diameter, about 5¾″ in diameter, or about 6″ in diameter. In an aspect, a disclosed sleeve comprising a circular cross-sectional shape can be about ½″ in diameter, about 1″ in diameter, about 2″ in diameter, about 3″ in diameter, about 4″ in diameter, about 5″ in diameter, or about 6″ in diameter. In an aspect, for a disclosed sleeve comprising a circular cross-sectional shape can accommodate the size of a horizontal or angular protrusion also having a circular cross-sectional shape. For example, if an exposed horizontal or angular protrusion is about 2″ in diameter, then the disclosed sleeve is at least 2″ in diameter. For example, if an exposed horizontal or angular protrusion is about 4″ in diameter, then the disclosed sleeve is at least 4″ in diameter. In an aspect, a disclosed sleeve can be about 1.5″ in diameter.

In an aspect, a disclosed sleeve for a horizontal or angular can be about 24″ to about 72″ in length, or about 48″ to about 60″ in length, or about 24″, or about 30″, or about 36″, or about 42″, or about 48″, or about 54″, or about 60″, or about 66″, or about 72″ in length. In an aspect, a disclosed sleeve can about 54″ in length.

Several factors contribute to the determination of the most appropriate length of a disclosed sleeve for a horizontal or angular protrusion. For example, the need for visibility of the horizontal or angular protrusion in the surrounding environment (e.g., an active or inactive construction zone or site, a wooded area, a grassy area, etc.), weather conditions (e.g., rain, sleet, snow, fog, smoke, haze, etc.), the amount of exposed horizontal or angular protrusion, the purpose of the horizontal or angular protrusion, the type of equipment employed in the surrounding environment (e.g., tractors, harvesting machines, dump trucks, cement trucks, excavation equipment, utility trucks, and other heavy machinery).

The width and height of an exposed horizontal or angular protrusion contribute to the determination of the most appropriate width and height of a disclosed sleeve.

Several factors contribute to the determination of the most appropriate wall thickness of a disclosed sleeve for a horizontal or angular protrusion. For example, a disclosed sleeve can have a wall thick enough to confer durability onto the disclosed sleeve. In an aspect, for example, a disclosed sleeve can have wall thick enough to ensure that the sleeve is reusable or that it can be used repeatedly. In an aspect, a disclosed sleeve can have a wall thickness of about 0.01″ to about 0.1″. In an aspect, a disclosed sleeve can have a wall thickness of about 0.04″.

In an aspect, all walls of a disclosed sleeve having a square or rectangular cross-sectional shape can comprise the same thickness. In an aspect, one, two, three, or four walls of a disclosed sleeve having a square or rectangular cross-sectional shape can comprise the same thickness. In an aspect, two of the walls of a disclosed sleeve having a square or rectangular cross-sectional shape can comprise the same thickness. In an aspect, two of the walls of a disclosed sleeve having a square or rectangular cross-sectional shape can comprise the same thickness while the other two walls can comprise the same thickness, which can be (but do not have to be) the same thickness as the first two walls.

In an aspect, a wall of a disclosed sleeve comprising a square or rectangular cross-sectional shape can have a thickness of about 0.01″ to about 0.1″. In an aspect, a disclosed sleeve can have a wall thickness of about 0.04″. In an aspect, a wall of a disclosed sleeve comprising a square or rectangular cross-sectional shape can have a thickness of about 1/16″ to about ⅞″. In an aspect, a wall of a disclosed sleeve comprising a square or rectangular cross-sectional shape can have a thickness of about 3/16″ or about 1/10″. In an aspect, a wall of a disclosed sleeve comprising a square or rectangular cross-sectional shape can have a thickness of about 10 mil to about 300 mil. In an aspect, a wall of a disclosed sleeve comprising a square or rectangular cross-sectional shape can have a thickness of about 10 mil to about 30 mil, about 30 mil to about 50 mil, about 50 mil to about 70 mil, about 70 mil to about 90 mil, about 90 mil to about 110 mil, about 110 mil to about 130 mil, about 130 mil to about 150 mil, about 150 mil to about 170 mil, about 170 mil to about 190 mil, about 190 mil to about 210 mil, about 210 mil to about 230 mil, about 230 mil to about 250 mil, about 250 mil to about 270 mil, or about 270 mil to about 300 mil. In an aspect, a wall of a disclosed sleeve comprising a square or rectangular cross-sectional shape can have a thickness of about 30 mil, about 40 mil, about 50 mil, about 60 mil, about 70 mil, about 80 mil, about 90 mil, or about 100 mil. In an aspect, a disclosed sleeve comprising a circular cross-sectional shape can have a thickness of about 40 mil.

In an aspect, a wall of a disclosed sleeve comprising a circular cross-sectional shape can have a thickness of about 0.01″ to about 0.1″. In an aspect, a disclosed sleeve can have a wall thickness of about 0.04″. In an aspect, a wall of a disclosed sleeve comprising a circular cross-sectional shape can have a thickness of about 1/16″ to about ⅞″. In an aspect, a wall of a disclosed sleeve comprising a circular cross-sectional shape can have a thickness of about 3/16″ or about 1/10″. In an aspect, a wall of a disclosed sleeve comprising a circular cross-sectional shape can have a thickness of about 10 mil to about 300 mil. In an aspect, a wall of a disclosed sleeve comprising a circular cross-sectional shape can have a thickness of about 10 mil to about 30 mil, about 30 mil to about 50 mil, about 50 mil to about 70 mil, about 70 mil to about 90 mil, about 90 mil to about 110 mil, about 110 mil to about 130 mil, about 130 mil to about 150 mil, about 150 mil to about 170 mil, about 170 mil to about 190 mil, about 190 mil to about 210 mil, about 210 mil to about 230 mil, about 230 mil to about 250 mil, about 250 mil to about 270 mil, or about 270 mil to about 300 mil. In an aspect, a wall of a disclosed sleeve comprising a circular cross-sectional shape can have a thickness of about 30 mil, about 40, about 50 mil, about 60 mil, about 70 mil, about 80 mil, about 90, or about 100 mil. In an aspect, a disclosed sleeve comprising a circular cross-sectional shape can have a thickness of about 40 mil.

In an aspect, the lower portion of a disclosed sleeve can be in direct contact with an exposed horizontal or angular protrusion. In an aspect, for example, a disclosed sleeve can fit over and around an exposed horizontal or angular protrusion, whereby the lower portion of the sleeve physically contacts the exposed horizontal or angular protrusion. In an aspect, the physical contact can be direct physical contact. In an aspect, a disclosed sleeve can envelop the exposed aspect of a horizontal or angular protrusion.

In an aspect, the lower portion of a disclosed sleeve can be in direct contact with the entire length of the exposed horizontal or angular protrusion. In an aspect, the lower portion of a disclosed sleeve directly can be in direct contact with about 12″ to about 72″, or about 12″ to about 60″, or about 12″ to about 48″, or about 12″ to about 36″, or about 12″ to about 24″, or about 18″ of the exposed horizontal or angular protrusion. In an aspect, the lower portion of a disclosed sleeve directly can be in direct contact with about 12″ to about 24″, or about 24″ to about 36″, or about 36″ to about 48″, or about 48″ to about 60″, or about 60″ to about 72″ of the exposed horizontal or angular protrusion.

In an aspect, the upper portion of a disclosed sleeve for a horizontal or angular protrusion can comprise about 6″ to about 24″, about 12″ to about 18″, or about 14″ to about 16″ of reflective material. In an aspect, the upper portion of a disclosed sleeve can comprise about 6″, about 7″, about 8″, about 9″, about 10″, about 11″, about 12″, about 13″, about 14″, about 15″, about 16″, about 17″, about 18″, about 19″, about 20″, about 21″, about 22″, about 23″, or about 24″ of reflective material. In an aspect, the upper portion of a disclosed sleeve can comprise about 15″ of reflective material.

In an aspect, about 10% to about 40%, or about 10% to about 15%, or about 15% to about 20%, or about 20% to about 25%, or about 25% to about 30%, or about 30% to about 35%, or about 35% to about 40% of the upper portion of a disclosed sleeve can comprise reflective material. In an aspect, about 10%, about 15%, about 20%, about 25%, about 30%, about 35%, or about 40% of the upper portion of a disclosed sleeve can comprise reflective material.

In an aspect, a disclosed sleeve can comprise about 48″ in length and the upper portion of a disclosed sleeve can comprise about 6″ to about 24″ of reflective material. In an aspect, a disclosed sleeve can comprise about 48″ in length and the upper portion of a disclosed sleeve can comprise about 12″ of reflective material, or about 15″ of reflective material, or about 18″ of reflective material, or about 21″ of reflective material, or about 24″ of reflective material. In an aspect, a disclosed sleeve can comprise about 54″ in length and the upper portion of a disclosed sleeve can comprise about 6″ to about 24″ of reflective material. In an aspect, a disclosed sleeve can comprise about 54″ in length and the upper portion of a disclosed sleeve can comprise about 12″ of reflective material, or about 15″ of reflective material, or about 18″ of reflective material, or about 21″ of reflective material, or about 24″ of reflective material. In an aspect, a disclosed sleeve can comprise about 60″ in length and the upper portion of a disclosed sleeve can comprise about 6″ to about 24″ of reflective material. In an aspect, a disclosed sleeve can comprise about 60″ in length and the upper portion of a disclosed sleeve can comprise about 12″ of reflective material, or about 15″ of reflective material, or about 18″ of reflective material, or about 21″ of reflective material, or about 24″ of reflective material.

In an aspect, a disclosed sleeve can comprise about 54″ in length and the upper portion of a disclosed sleeve can comprise about 3″, about 4″ about 5″, about 6″, about 7″, about 8″, about 9″, or about 10″ to about 24″ of reflective material. In an aspect, a disclosed sleeve can comprise about 54″ in length and the upper portion of a disclosed sleeve can comprise about 8″ of reflective material, about 12″ of reflective material, or about 15″ of reflective material, or about 18″ of reflective material, or about 21″ of reflective material, or about 24″ of reflective material.

In an aspect, reflective material can be continuously or discontinuously applied on the upper portion of a disclosed sleeve. In an aspect, the upper portion of a disclosed sleeve can comprise reflective material applied in a continuous manner or in a discontinuous manner. In an aspect, continuous can mean having an unbroken whole, without interruption, constant, continual, and/or unbroken. In an aspect, discontinuous can mean having intervals or gaps, sporadic, interrupted, patterned, and/or intermittent. In an aspect, the upper portion of a disclosed sleeve can comprise reflective material applied in a continuous manner, such as, for example, a block of reflective material. In an aspect, a block of reflective material can comprise various thicknesses, such as, for example, a 2″ block, a 3″ block, a 4″ block, a 5″ block, a 6″ block, a 9″ block, a 12″ block, a 15″ block, an 18″ block, a 21″ block, or a 24″ block of reflective material. In an aspect, a block of reflective material can be about 2″ to about 24″ thick.

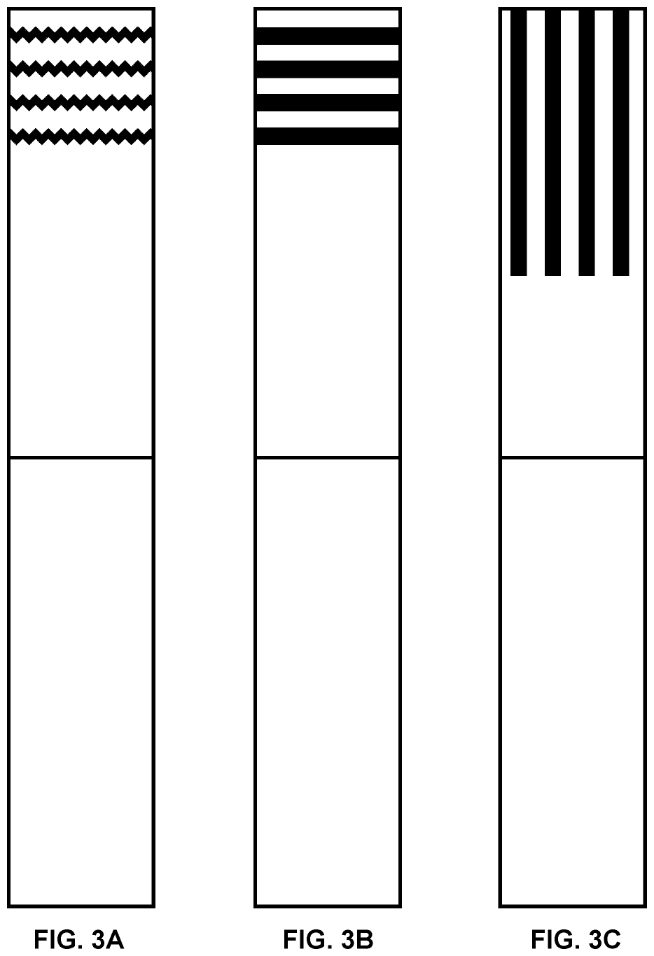

In an aspect, the upper portion of a disclosed sleeve can comprise reflective material applied in a discontinuous manner, such as, for example, a series of stripes, bands, stars, dots, triangles, squares, rectangles, or any other shape, or combination of shapes, or combination of shapes and stripes. For example, in an aspect, reflective material can comprise stripes or bands of reflective material. In an aspect, stripes or bands of reflective material can be horizontal stripes, vertical stripes, or diagonal stripes. FIG. 3B shows a disclosed sleeve for a protrusion (such as a horizontal or angular protrusion) or a conduit having horizontal stripes or bands of reflective material while FIG. 3C shows a disclosed sleeve for a protrusion (such as a horizontal or angular protrusion) or a conduit having vertical strips or bands of reflective material.

In an aspect, a disclosed sleeve can comprise one or more stripes or bands of reflective material. In an aspect, a disclosed sleeve can comprise about 1 strip to about 20 stripes or bands of reflective material. In an aspect, a disclosed sleeve can comprise 1, 2, 3, 4, 5, 6, 7, 8, 9, or 10 stripes or bands of reflective material. The skilled person recognizes that a disclosed sleeve can comprise any number of stripes or bands of reflective material so long as the number or stripes or bands sufficiently performs the role of the reflective material. In an aspect, a disclosed sleeve can comprise 3 strips or bands of reflective material.

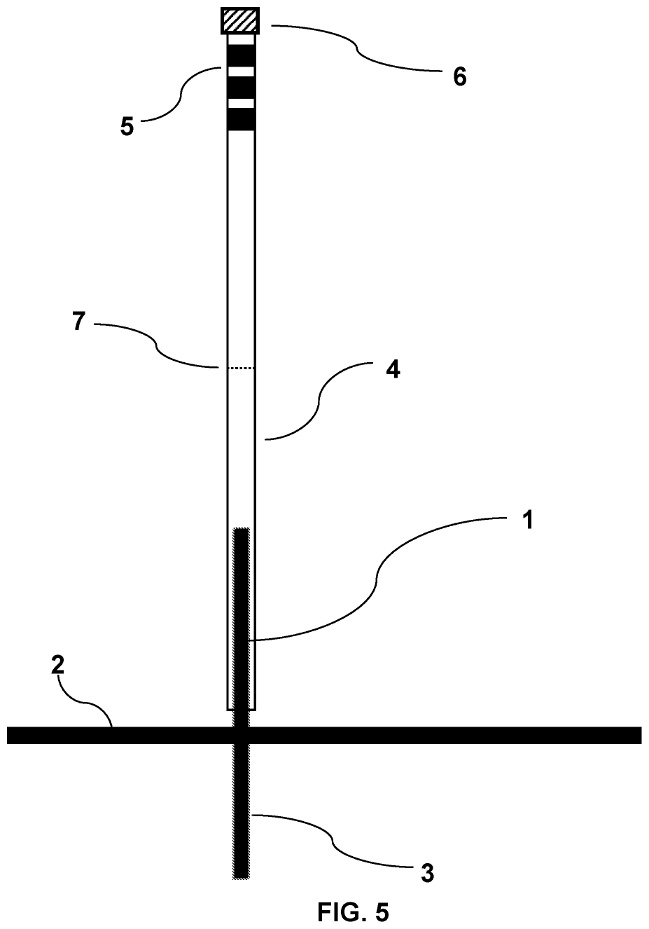

FIG. 5 shows a disclosed sleeve having a cap, no wind vents, and 3 strips or bands of reflective material on the upper portion of the sleeve. FIG. 5 shows an exemplary disclosed sleeve (4) positioned on the exposed aspect of a vertical protrusion or a conduit (1). The lower portion of the exemplary disclosed sleeve directly contacts the exposed aspect (1) of the vertical protrusion or the conduit. The unexposed or nonexposed aspect (3) of the vertical protrusion or the conduit is below the surface of the ground or floor or ceiling or other surface (2). The disclosed sleeve comprises an upper portion and a lower portion, which is indicated (for convenience only) by a dotted line (7). The upper portion comprises 3 strips or bands of reflective material (5). The end of the upper portion of the disclosed sleeve is covered with a cap (6).

In an aspect, each stripe or band of reflective material can be about 0.25″ to about 6″ in width. In an aspect, each stripe or band of reflective material can be about 0.5″, about 1″, about 1.5″, about 2.0″, about 2.5″, about 3″, about 3.5″, about 4.0″, about 4.5″, about 5.0″, about 5.5″, or about 6″ in width. In an aspect, each stripe or band of reflective material can be about 2″ in width. In an aspect, one or more stripes of reflective materials can be spaced apart by about 0.5″ to about 6″. In an aspect, each vertical stripe or band of reflective material can be about 32″ to about 36″ in length. In an aspect, each vertical stripe or band of reflective material can be about 2″, about 3″, about 6″, about 9″, about 12″, about 15″, about 18″, about 21″, about 24″, about 27″, about 29″, about 32″, about 35″, or about 36″ length. In an aspect, a disclosed sleeve can comprise about 2″ to about 3″ strips or bands of reflective material.

In an aspect, each horizontal stripe or band can comprise the same width. In an aspect, each horizontal stripe or band can comprise a different width or a series of different width. In an aspect, it is not necessary for each horizontal stripe or band to be identical in width. In an aspect, each vertical stripe or band can comprise the same length. In an aspect, each vertical stripe or band can comprise a different length or a series of different lengths. In an aspect, it is not necessary for each vertical stripe or band to be identical in width or length.

In an aspect, one or more stripes of reflective materials can be spaced apart by about 0.5″, about 1″, about 1.5″, about 2″, about 2.5″, about 3″, about 3.5″, about 4″, about 4.5″, about 5″ “or, about 5.5, about 6”. In an aspect, stripes or bands of reflective material can be spaced about 0.5″ to about 6″ from the open end of the upper portion of a disclosed sleeve. In an aspect, reflective material can be spaced about 0.5″, about 1″, about 1.5″, about 2″, about 2.5″, about 3″, about 3.5, about 4″, about 4.5″, about 5″, about 5.5″, or about 6″ from the open end of the upper portion of a disclosed sleeve.

In an aspect, a disclosed sleeve can comprise one or more horizontal stripes of reflective material, wherein the one or more stripes of a disclosed width can be spaced apart by a disclosed width, wherein the first of the one or more stripes can be spaced a disclosed width from the open end of the upper portion of a disclosed sleeve. For example, a first 2″ stripe of reflective material can be spaced about 3″ from the open end of a disclosed sleeve, which can be followed by 3″ without a reflective material, which can be followed by a second 2″ stripe of reflective material, which can be followed by 3″ without a reflective material, and which can be followed by a third 2″ stripe of reflective materials. The pattern can continue. In an aspect, for example, a first 1″ stripe of reflective material can be spaced about 3″ from the open end of a disclosed sleeve, which can be followed by 1″ without a reflective material, which can be followed by a second 1″ stripe of reflective material, which can be followed by 1″ without a reflective material, and which can be followed by a third 1″ stripe of reflective materials. The pattern can continue. In an aspect, a disclosed sleeve can comprise one or more stripes or bands of reflective material, wherein the one or more stripes or bands can be about 2″ in width, and wherein the one or more stripes or bands can be spaced apart by about 3″.

In an aspect, a disclosed sleeve can comprise one or more vertical stripes of reflective material, wherein the one or more stripes of a disclosed width can be spaced apart by a disclosed width, wherein the first of the one or more stripes can be spaced a disclosed width from the open end of the upper portion of a disclosed sleeve, wherein the stripes can be a disclosed length. In an aspect, a disclosed sleeve can comprise one or more vertical stripes of reflective material, wherein the one or more stripes can be about 1″ in width, wherein the one or more stripes can be spaced apart by about 2″, and wherein the top of each vertical stripe can be spaced about 3″ from the open end of the upper portion of a disclosed sleeve. For example, the top of each 0.5″ stripe or band of reflective material can be spaced about 3″ from the open end of a disclosed sleeve, and the 0.5″ stripes of reflective material are separated by 1″ without a reflective material, which vertical pattern of reflective and non-reflective material is repeated for the entire diameter of the horizontal or angular protrusion regardless of whether the protrusion is a stake (e.g., a survey stake), for example, or an electrical or liquid conduit, for example. For example, the top of each 1″ stripe or band of reflective material can be spaced about 3″ from the open end of a disclosed sleeve, and the 1″ stripes or bands of reflective material are separated by 1″ without a reflective material, which vertical pattern of reflective and non-reflective material is repeated for the entire diameter of the horizontal or angular protrusion regardless of whether the protrusion is a survey stake, for example, or an electrical or liquid conduit, for example.

In an aspect, reflective material can comprise a chevron pattern or a wavy pattern. FIG. 3A shows a disclosed sleeve for a protrusion (such as a horizontal or angular protrusion) or a conduit having reflective material in a chevron pattern. In an aspect, reflective material can comprise a series of one or more dots, wherein the dots can be arranged in various patterns (e.g., rows, columns, waves, crosses, x's, etc.) or can be randomly placed. In an aspect, reflective material can comprise a series of one or more squares, rectangles, triangles, or a combination thereof, wherein the squares, rectangles, triangles, or the combination thereof can be arranged in various patterns (e.g., rows, columns, waves, crosses, x's, etc.) or can be randomly placed. In an aspect, reflective material can comprise a series of one or more known shapes, or a combination of known shapes, wherein the known shapes, or the combination thereof can be arranged in various patterns (e.g., rows, columns, waves, crosses, x's, etc.) or can be randomly placed.

In an aspect, reflective material can comprise reflective fabric, reflective films, reflective tape, reflective yarn, reflective trims, or a combination thereof. In an aspect, reflective material can be created with tiny spherical glass beads. In an aspect, reflective material can comprise any color such as, for example, red, orange, yellow, green, blue, purple, white, or can comprise multiple colors. In an aspect, reflective tape can be outdoor reflective tape.

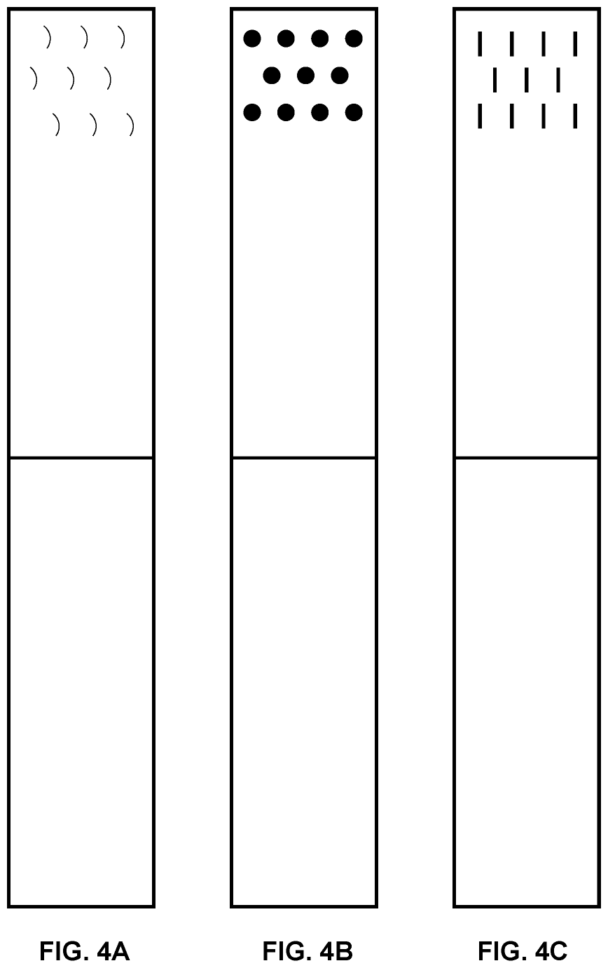

In an aspect, a disclosed sleeve for a horizontal or angular protrusion can be devoid of wind vents. In an aspect, a disclosed sleeve for a horizontal or angular protrusion can comprise 1 to 100 wind vents. As known to the art, wind vents can reduce the wind load on a disclosed sleeve. In an aspect, one or more wind vents can allow for wind and/or air to be safely vented through a disclosed sleeve. In an aspect, one or more vents can prolong the physical integrity, and therefore, usability of a disclosed sleeve. In an aspect, a wind vent can be positioned apart about 0.5″ to about 6″ on the upper portion of a disclosed sleeve. In an aspect, one or more wind vents can be positioned in a row. In an aspect, a wind vent can be positioned about 1″ to about 6″ from the open-end of a disclosed sleeve. In an aspect, one or more wind vents can be positions about 3″ from the open-end of a disclosed sleeve. Wind vents can be various shapes and sizes. For example, in an aspect, a wind vent can comprise a circular shape, a crescent-moon shape, an oblong shape, an egg shape, a rectangular shape, a square shape, a slit shape, or a combination thereof. FIG. 4A shows a disclosed sleeve for a protrusion (such as a horizontal or angular protrusion) or a conduit having a series of crescent-moon shaped wind vents, FIG. 4B shows a disclosed sleeve for a protrusion (such as a horizontal or angular protrusion) or a conduit having circular-shaped wind vents, and FIG. 4C shows a disclosed sleeve for a protrusion (such as a horizontal or angular protrusion) or a conduit having slit-shaped wind vents.

Determining the desired number of wind vents can comprise several factors known to the skilled person in the art. For example, as known to the skilled person, wind vent can serve at least two purposes including venting wind around the disclosed sleeve and venting heat from inside and around the disclosed sleeve.

In an aspect, a disclosed sleeve having a rectangular cross-sectional shape can comprise wind vents along all or a portion of the perimeter. For example, in a disclosed sleeve having a rectangular cross-sectional shape, wind vents can be on all four surfaces, or wind vents can be on the two shorter parallel surfaces, or on the two longer parallel surfaces, or one of each, for example. In an aspect a disclosed sleeve having a square cross-sectional shape can comprise wind vents along all or a portion of the perimeter. In an aspect, in a disclosed sleeve having a square cross-sectional shape, wind vents can be on all four surfaces, or on two parallel surfaces. In an aspect, a disclosed sleeve having a circular cross-sectional shape can comprise wind vents along all or a portion of the perimeter.

In an aspect, about 1% to about 50% of a disclosed sleeve can comprise wind vents. For example, in an aspect, about 1% to about 25% of the upper portion of a disclosed sleeve can comprise wind vents. For example, in an aspect, about 5%, about 10%, about 15%, about 20%, or about 25% of the upper portion of a disclosed sleeve can comprise wind vents. In an aspect, a disclosed sleeve can be devoid of wind vents.

In an aspect, the upper portion of a disclosed sleeve for a horizontal or angular protrusion can comprise a flag or string or ribbon or the like. In an aspect, a disclosed flag, string, ribbon, or the like can be weather resistant and durable. In an aspect, a disclosed flag, string, ribbon, or the like can comprise a fluorescent or neon coloring. In an aspect, a disclosed flag, string, ribbon, or the like can comprise reflective material. In an aspect, a flag, string, ribbon, or the like can serve to improve visibility of a disclosed sleeve for a horizontal or angular protrusion.

In an aspect, a disclosed sleeve for a horizontal or angular protrusion can comprise a plastic. In an aspect, a disclosed sleeve for a horizontal or angular protrusion can comprise a combination of one or more plastics. In an aspect, a disclosed sleeve can comprise a plastic composite. Plastics are diverse. The art is familiar with plastics, which include, but are not limited to, acrylic or polymethyl methacrylate (PMMA), acrylonitrile-butadiene-styrene (ABS), high density polyethylene (PE), low density polyethylene (PE), polyamide (PA), polycarbonate (PC), polyetherimide, polyethylene (PE), polyethylene terephthalate (PETE or PET), polyoxymethylene (POM), polyphenylene sulfide (PPS), polypropylene (PP), polystyrene (PS), polyurethane (PUR), polyvinyl chloride (PVC), polyvinylidene fluoride (PVDF), and combinations thereof.

In an aspect, a disclosed sleeve for a horizontal or angular protrusion can comprise butyrate, a butyrate composite, or a butyrate comprising composition. A disclosed sleeve comprising butyrate (cellulose acetate butyrate) will be transparent and rigid with excellent dimensional stability and high impact strength.

In an aspect, for example, acrylic polymer can be prepared from monomers including but not limited to methyl acrylate, acrylic acid, methacrylic acid, methyl methacrylate, butyl methacrylate, cyclohexyl methacrylate as well as combinations thereof. In an aspect, substituted acrylates and methacrylates such as hydroxyethyl acrylate, hydroxybutyl acrylate, 2-ethylhexyl acrylate, and n-butyl acrylate can also be used. In an aspect, polyesters can be obtained, for example, by reacting an organic polycarboxylic acid with an organic polyol containing primary or secondary hydroxyl groups (e.g., ethylene glycol, butylene glycol, neopentyl glycol, and cyclohexane dimethanol) such as phthalic acid, hexahydrophthalic acid, adipic acid, maleic acid, terephthalic acid, isophthalic acid, sebacic acid, dodecanedioic acid, etc., or anhydrides thereof. In an aspect, polyurethanes can be used to make a disclosed sleeve. Polyurethanes can be prepared by the reaction of polyisocyanates with polyols, polyamines, or water. Examples of polyisocyanates include hexamethylene diisocyanate, toluene diisocyanate, diphenylmethane diisocyanate (MDI), isophorone diisocyanate, and biuret and thiocyanurate of these diisocyanates. Examples of polyols can include but are not limited to low molecular weight aliphatic polyols, polyester polyols, polyether polyols, fatty alcohols and the like. Examples of other materials from which a disclosed sleeve can be made include but are not limited to acrylonitrile-butadiene-styrene, VALOX™ (polybutylene phthalate, commercially available from SABIC's Innovative Plastics), and XENOY™ (LEXAN™ and VALOX™ Blend, commercially available from SABIC's Innovative Plastics).

In an aspect, plastics include thermoplastics, which are softened by heat and can be molded (e.g., injection molded, blow molded, vacuum formed, etc.). Thermoplastics include, but are not limited to, the following: acrylic, polypropylene, polystyrene, polythene, and PVC. Plastics include thermosets, which are formed by a heat process but are then set (for example, like concrete) and cannot change shape by reheating. Thermosets include, but are not limited to, the following: melamine (e.g., kitchen worktops), bakelite (e.g., black saucepan handles), polyester, and epoxy resins.

In an aspect, a plastic or plastic composite may also contain additives such as one or more colorants, one or more release agent, one or more antioxidant, one or more surfactant, plasticizer, one or more infrared absorber, one or more antistatic agent, one or more dispersant, one or more compatibilizer, one or more ultraviolet absorber, and combinations thereof.

In an aspect, a disclosed sleeve for a horizontal or angular protrusion can be resistant to ultraviolet (UV) light, tolerant of ultraviolet (UV) light, ultraviolet (UV) light stable, or a combination thereof. For example, in an aspect, a disclosed sleeve comprising acrylic, polymethyl methacrylate (PMMA), PVDF, PTFE, a combination thereof, or a composite thereof can be UV resistant, UV tolerant, UV stable, or a combination thereof. In an aspect, the inherent UV resistance of a plastic used for a disclosed sleeve for a horizontal or angular protrusion can be improved or enhanced by adding UV stabilizers or UV resistant caps to protect the base polymer. For example, UV stabilizers can be added to a polymer to inhibit one or more photoinitiation processes. UV Stabilizers include ultraviolet absorbers, quenchers, and hindered amine light stabilizers (HALS). Absorbers, quenchers, and HALS are three types of UV stabilizers function by different mechanisms, one or more of them can be combined to create a synergistic effect. In an aspect, for example, benzotriazoles can be combined with HALS to protect pigmented systems from fading and color changes. In an aspect, a composite can comprise a combination of one or more plastics and one or more non-plastic materials. In an aspect, a composite can demonstrate enhanced properties (such as, for example, enhanced physical and mechanical properties).

In an aspect, a disclosed sleeve for a horizontal or angular protrusion can comprise a weather-resistant layer (e.g., a coating). A weather-resistant layer can be applied in various ways, including dipping the plastic substrate at room temperature and atmospheric pressure into the coating solution (i.e., dip coating). weather-resistant layer can also be applied by other methods including, but not limited to, flow coating, curtain coating, and spray coating. A weather-resistant layer can comprise silicon (e.g., silicone hard coat), polyurethane (e.g., polyurethane acrylate), acrylic, polyacrylate (e.g., polymethacrylate, polymethylmethacrylate), polyvinylidene fluoride, esters, epoxides, or combinations thereof. A weather-resistant layer can also comprise one or more ultraviolet absorbing molecules (e.g., hydroxyphenyltazine, hydroxybenzophenone, hydroxylphenylbenzotazol, hydroxyphenyltriazine, polyarylresorcinol, and cyanoacrylate, or a combination thereof). In an aspect, for example, a weather-resistant layer can comprise a silicone hard coat layer (AS4000 or AS4700, commercially available from Momentive Performance Materials). In an aspect, a weathering layer can include a primer layer and a coating (e.g., a topcoat). A primer layer can help with adherence to the sleeve. A primer layer can include, but is not limited to, acrylic, polyester, epoxide, and combinations thereof. A primer layer can contain an ultraviolet absorber in addition to or instead of being present in the top coat of the weathering layer. For example, in an aspect, a primer layer can comprise an acrylic primer (SHP401 or SHP470, commercially available from Momentive Performance Materials).

In an aspect, a disclosed sleeve for a horizontal or angular protrusion can comprise one or more abrasion resistant layer (e.g., a coating or a plasma coating). An abrasion resistant layer can comprise a single layer or multiple layers, and can enhance functionality by improving the abrasion resistance of the glaze. For example, in an aspect, an abrasion resistant layer on a disclosed sleeve can be comprise aluminum oxide, barium fluoride, boron nitride, hafnium oxide, lanthanum fluoride, magnesium fluoride, magnesium oxide, scandium oxide, silicon monoxide, silicon dioxide, silicon oxide, zirconium oxide, zinc oxide, zinc oxide, zinc oxide, zinc sulfide, zirconium oxide, zirconium titanate, zirconium titanate, zirconium titanate, zirconium titanate, zirconium titanate, zirconium titanate, organic coatings, inorganic coatings, and combinations thereof.

In an aspect, a weather-resistant layer can be applied by various deposition techniques such as a vacuum assisted deposition process and an atmospheric coating process. For example, in an aspect, a vacuum assisted deposition processes can include plasma enhanced chemical vapor deposition (PECVD), arc-PECVD, expanding thermal plasma PECVD (PECVD), ion assisted plasma deposition, magnetron sputtering but are not limited to, sputtering, electron beam evaporation, and ion beam sputtering, while atmospheric pressure coating processes can include curtain coating, spray coating, but are not limited to, spin coating, dip coating, and flow coating.

In an aspect, disclosed layer can comprise one or more antioxidants, one or more flow additives, one or more dispersants, one or more antioxidants, one or more surfactants, one or more plasticizers, one or more infrared absorbers, one or more compatibilizing agents, one or more curing catalysts, one or more ultraviolet absorber, and combinations thereof. The skilled person in the art can optimize the amount of each of the aforementioned additives based on desired characteristics and performance of a disclosed sleeve.

In an aspect, a disclosed sleeve for a horizontal or angular protrusion can be formed in various ways well known to the art including, but not limited to, injection molding, extrusion, cold forming, vacuum forming, extrusion molding, transfer molding, thermal forming, and the like.

### 2. Sleeves for a Vertical Protrusion

Disclosed herein are sleeves for a vertical protrusion. Disclosed herein is a sleeve for placement on a vertical protrusion, comprising an elongate body comprising an upper portion and a lower portion, wherein each portion of the elongate body comprises an open end, wherein the upper portion comprises a reflective material, and wherein the lower portion directly contacts a vertical protrusion. Disclosed herein is a sleeve for placement on a vertical protrusion, comprising an elongate body comprising an upper portion and a lower portion, wherein the upper portion of elongate body comprises a closed end and wherein the lower portion of the elongate body comprises an open end, wherein the upper portion comprises a reflective, and wherein the lower portion directly contacts a vertical protrusion. Disclosed herein is a sleeve for placement on a vertical protrusion, comprising an elongate body comprising an upper portion and a lower portion, wherein each portion of the elongate body comprises an open end, wherein the upper portion comprises a reflective material and one or more wind vents, and wherein the lower portion directly contacts a vertical protrusion. Disclosed herein is a sleeve for placement on a vertical protrusion, comprising an elongate body comprising an upper portion and a lower portion, wherein the upper portion of elongate body comprises a closed end and wherein the lower portion of the elongate body comprises an open end, wherein the upper portion comprises a reflective material and one or more wind vents, and wherein the lower portion directly contacts a vertical protrusion.

FIG. 1C shows an exemplary disclosed sleeve (4) positioned on the exposed aspect of a vertical protrusion or a conduit (1). The lower portion of the exemplary disclosed sleeve directly contacts the exposed aspect (1) of the vertical protrusion or the conduit. The unexposed or nonexposed aspect (3) of the vertical protrusion or the conduit is below the surface of the ground or floor or ceiling or other surface (2). The disclosed sleeve comprises an upper portion and a lower portion, which is indicated (for convenience only) by a dotted line (8). The upper portion comprises reflective material (6) and one or more wind vents (5). The end (7) of the upper portion of the disclosed sleeve can either be opened or closed. In an aspect, the upper portion of a disclosed sleeve can comprise a cap (see, e.g., FIG. 5).

In an aspect, a disclosed sleeve for a vertical protrusion can be one piece having no seam. In an aspect, a disclosed sleeve for a vertical protrusion can be one piece having a connectable or closeable seam along part of or the whole length of the sleeve. In an aspect, a disclosed sleeve for a vertical protrusion can be one piece having an open seam along part of or the whole length of the sleeve.

In an aspect, a vertical protrusion can comprise a survey stake or a conduit. In an aspect, a conduit comprises a liquid conduit or an electrical conduit. In an aspect, a liquid conduit can comprise a tube, pipe, or channel for conveying water or other fluid. In an aspect, an electrical conduit can comprise a tube or trough for protecting electrical wiring. In an aspect, an electrical conduit can be a rigid metal conduit, an intermediate metal conduit, an electrical metallic tubing, an electrical non-metallic tubing, a flexible metal conduit, a liquid-tight flexible metal conduit, or a rigid polyvinyl chloride conduit.

In an aspect, a disclosed sleeve is reusable. Reusable means that a disclosed sleeve is capable of being used again or repeatedly.

In an aspect, a disclosed sleeve can be positioned on the exposed aspect of vertical protrusion. In an aspect, the term “positioned on” can mean that the inside of a disclosed sleeve can directly contact the exposed vertical protrusion. For example, a disclosed sleeve can fit over and around an exposed vertical protrusion. In an aspect, the term “exposed” can refer to that aspect of a vertical protrusion that extends from the surface of the ground or the earth, or the surface of a floor or wall or ceiling or roof, or the surface of a construction site, or the like. The non-exposed or unexposed aspect of a vertical protrusion is that aspect that is below the surface of the ground or the earth, or the surface of a floor or wall or ceiling or roof, or the surface of construction site, or the like. In an aspect, a disclosed sleeve can directly contact about 12″ to about 60″ or about 24″ to about 48″ of an exposed vertical protrusion. In an aspect, a disclosed sleeve can directly contact about 24″, about 36″, or about 48″ of an exposed vertical protrusion.

In an aspect, a disclosed sleeve for a vertical protrusion can comprise a rectangular cross-sectional shape. FIG. 2A is a cross-sectional view showing a disclosed sleeve (solid border) positioned on a protrusion (such as a vertical protrusion) or a conduit having a rectangular cross-sectional shape (hatched). In an aspect, disclosed sleeve comprising a rectangular cross-sectional shape can be about ¾″ in width to about ¾″ in width and about 1¼″ to about 1¾″ in height. In an aspect, disclosed sleeve comprising a rectangular cross-sectional shape can be about ½″ in width and about 1½″ in height. In an aspect, a disclosed sleeve comprising a rectangular cross-sectional shape can accommodate the size of any exposed vertical protrusion also having a rectangular cross-sectional shape. For example, if an exposed vertical protrusion is about ½″ in width and about 1½″ in height, then the disclosed sleeve is at least ½″ in width and at least 1½″ in height. For example, if an exposed vertical protrusion is about 1½″ in width and about 1½″ in height, then the disclosed sleeve is at least 1½″ in width and at least 1½″ in height.

In an aspect, a disclosed sleeve for a vertical protrusion can comprise a square cross-sectional shape. FIG. 2B is a cross-sectional view showing a disclosed sleeve (solid border) positioned on a protrusion (such as a vertical protrusion) or a conduit having a square cross-sectional shape (hatched). In an aspect, a disclosed sleeve comprising a square cross-sectional shape can be about ¾″ to about 6″ both in width and in height. In an aspect, a disclosed sleeve comprising a square cross-sectional shape can be about ¾″ in width and in height, or about ½″ in width and in height, or about ¾″ in width and in height, or about 1″ in width and in height, or about 1¼″ in width and in height, or about 1½″ in width and in height, or about 1¾″ in width and in height, or about 2″ in width and in height, or about 2¼″ in width and in height, or about 2½″ in width and in height, or about 2¾″ in width and in height, or about 3″ in width and in height, or about 3¼″ in width and in height, or about 3½″ in width and in height, or about 3¾″ in width and in height, or about 4″ in width and in height, or about 4V in width and in height, or about 4½″ in width and in height, or about 4¾″ in width and in height, or about 5″ in width and in height, or about 5¼″ in width and in height, or about 5½″ in width and in height, or about 5¾″ in width and in height, or about 6″ in width and in height. In an aspect, a disclosed sleeve comprising a square cross-sectional shape can accommodate the size of any exposed vertical protrusion also having a square cross-sectional shape. For example, if an exposed vertical protrusion is about 1″ in width and about 1″ in height, then the disclosed sleeve is at least 1″ in width and at least 1″ in height. For example, if an exposed vertical protrusion is about 2″ in width and about 2″ in height, then the disclosed sleeve is at least 2″ in width and at least 2″ in height.

In an aspect, a disclosed sleeve for a vertical protrusion can comprise a circular cross-sectional shape. FIG. 2C is a cross-sectional view showing a disclosed sleeve (solid border) positioned on a protrusion (such as a vertical protrusion) or a conduit having a circular cross-sectional shape (hatched). In an aspect, a disclosed sleeve comprising a circular cross-sectional shape can be about ¾″ to about 6″ in diameter. In an aspect, a disclosed sleeve comprising a circular cross-sectional shape can be about ¾″ in diameter, about ½″ in diameter, about ¾″ in diameter, about 1″ in diameter, about 1¾″ in diameter, about 1½″ in diameter, about 1¾″ in diameter, about 2″ in diameter, about 2¾″ in diameter, about 2½″ in diameter about 2¾″ in diameter, about 3″ in diameter, about 3V in diameter, about 3½″ in diameter, about 3¾″ in diameter, about 4″ in diameter, about 4V in diameter, about 4½″ in diameter, about 4¾″ in diameter, about 5″ in diameter, about 5V in diameter, about 5½″ in diameter, about 5¾″ in diameter, or about 6″ in diameter. In an aspect, a disclosed sleeve comprising a circular cross-sectional shape can be about ½″ in diameter, about 1″ in diameter, about 2″ in diameter, about 3″ in diameter, about 4″ in diameter, about 5″ in diameter, or about 6″ in diameter. In an aspect, for a disclosed sleeve comprising a circular cross-sectional shape can accommodate the size of vertical protrusion also having a circular cross-sectional shape. For example, if an exposed vertical protrusion is about 2″ in diameter, then the disclosed sleeve is at least 2″ in diameter. For example, if an exposed vertical protrusion is about 4″ in diameter, then the disclosed sleeve is at least 4″ in diameter. In an aspect, a disclosed sleeve can be about 1.5″ in diameter.

Several factors contribute to the determination of the most appropriate length of a disclosed sleeve for a vertical protrusion. For example, the need for visibility of the vertical protrusion in the surrounding environment (e.g., an active or inactive construction zone or site, a wooded area, a grassy area, etc.), weather conditions (e.g., rain, sleet, snow, fog, smoke, haze, etc.), the amount of exposed vertical protrusion, the purpose of the vertical protrusion, the type of equipment employed in the surrounding environment (e.g., tractors, harvesting machines, dump trucks, cement trucks, excavation equipment, utility trucks, and other heavy machinery). In an aspect, a disclosed sleeve for a vertical protrusion can be about 24″ to about 72″ in length, or about 48″ to about 60″ in length, or about 24″, or about 30″, or about 36″, or about 42″, or about 48″, or about 54″, or about 60″, or about 66″, or about 72″ in length. In an aspect, a disclosed sleeve can about 54″ in length.

Several factors contribute to the determination of the most appropriate wall thickness of a disclosed sleeve for a vertical protrusion. For example, a disclosed sleeve can have a wall thick enough to confer durability onto the disclosed sleeve. In an aspect, for example, a disclosed sleeve can have wall thick enough to ensure that the sleeve is reusable or that it can be used repeatedly. In an aspect, a disclosed sleeve can have a wall thickness of about 0.01″ to about 0.1″. In an aspect, a disclosed sleeve can have a wall thickness of about 0.04″.

In an aspect, all walls of a disclosed sleeve having a square or rectangular cross-sectional shape can comprise the same thickness. In an aspect, one, two, three, or four walls of a disclosed sleeve having a square or rectangular cross-sectional shape can comprise the same thickness. In an aspect, two of the walls of a disclosed sleeve having a square or rectangular cross-sectional shape can comprise the same thickness. In an aspect, two of the walls of a disclosed sleeve having a square or rectangular cross-sectional shape can comprise the same thickness while the other two walls can comprise the same thickness, which can be (but do not have to be) the same thickness as the first two walls.

In an aspect, a wall of a disclosed sleeve comprising a square or rectangular cross-sectional shape can have a thickness of about 0.01″ to about 0.1″. In an aspect, a disclosed sleeve can have a wall thickness of about 0.04″. In an aspect, a wall of a disclosed sleeve comprising a square or rectangular cross-sectional shape can have a thickness of about 1/16″ to about ⅞″. In an aspect, a wall of a disclosed sleeve comprising a square or rectangular cross-sectional shape can have a thickness of about 3/16″ or about 1/10″. In an aspect, a wall of a disclosed sleeve comprising a square or rectangular cross-sectional shape can have a thickness of about 10 mil to about 300 mil. In an aspect, a wall of a disclosed sleeve comprising a square or rectangular cross-sectional shape can have a thickness of about 10 mil to about 30 mil, about 30 mil to about 50 mil, about 50 mil to about 70 mil, about 70 mil to about 90 mil, about 90 mil to about 110 mil, about 110 mil to about 130 mil, about 130 mil to about 150 mil, about 150 mil to about 170 mil, about 170 mil to about 190 mil, about 190 mil to about 210 mil, about 210 mil to about 230 mil, about 230 mil to about 250 mil, about 250 mil to about 270 mil, or about 270 mil to about 300 mil. In an aspect, a wall of a disclosed sleeve comprising a square or rectangular cross-sectional shape can have a thickness of about 30 mil, about 40 mil, about 50 mil, about 60 mil, about 70 mil, about 80 mil, about 90 mil, or about 100 mil. In an aspect, a disclosed sleeve comprising a circular cross-sectional shape can have a thickness of about 40 mil.

In an aspect, a wall of a disclosed sleeve comprising a circular cross-sectional shape can have a thickness of about 0.01″ to about 0.1″. In an aspect, a disclosed sleeve can have a wall thickness of about 0.04″. In an aspect, a wall of a disclosed sleeve comprising a circular cross-sectional shape can have a thickness of about 1/16″ to about ⅞″. In an aspect, a wall of a disclosed sleeve comprising a circular cross-sectional shape can have a thickness of about 3/16″ or about 1/10″. In an aspect, a wall of a disclosed sleeve comprising a circular cross-sectional shape can have a thickness of about 10 mil to about 300 mil. In an aspect, a wall of a disclosed sleeve comprising a circular cross-sectional shape can have a thickness of about 10 mil to about 30 mil, about 30 mil to about 50 mil, about 50 mil to about 70 mil, about 70 mil to about 90 mil, about 90 mil to about 110 mil, about 110 mil to about 130 mil, about 130 mil to about 150 mil, about 150 mil to about 170 mil, about 170 mil to about 190 mil, about 190 mil to about 210 mil, about 210 mil to about 230 mil, about 230 mil to about 250 mil, about 250 mil to about 270 mil, or about 270 mil to about 300 mil. In an aspect, a wall of a disclosed sleeve comprising a circular cross-sectional shape can have a thickness of about 30 mil, about 40 mil, about 50 mil, about 60 mil, about 70 mil, about 80 mil, about 90, or about 100 mil. In an aspect, a disclosed sleeve comprising a circular cross-sectional shape can have a thickness of about 40 mil.

In an aspect, the lower portion of a disclosed sleeve can be in direct contact with an exposed vertical protrusion. In an aspect, for example, a disclosed sleeve can fit over and around an exposed vertical protrusion, whereby the lower portion of the sleeve physically contacts the exposed vertical protrusion. In an aspect, the physical contact can be direct physical contact. In an aspect, a disclosed sleeve can envelop the exposed aspect of a vertical protrusion. In an aspect, the lower portion of a disclosed sleeve can be in direct contact with the entire length of the exposed vertical protrusion.

In an aspect, the lower portion of a disclosed sleeve directly can be in direct contact with about 12″ to about 72″, or about 12″ to about 60″, or about 12″ to about 48″, or about 12″ to about 36″, or about 12″ to about 24″ of the exposed vertical protrusion. In an aspect, the lower portion of a disclosed sleeve directly can be in direct contact with about 12″ to about 24″, or about 24″ to about 36″, or about 36″ to about 48″, or about 48″ to about 60″, or about 60″ to about 72″ of the exposed vertical protrusion.

In an aspect, the upper portion of a disclosed sleeve for a vertical protrusion can comprise about 6″ to about 24″, about 12″ to about 18″, or about 14″ to about 16″ of reflective material. In an aspect, the upper portion of a disclosed sleeve can comprise about 6″, about 7″, about 8″, about 9″, about 10″, about 11″ “ ” “ ” “ ” “ ” “, about 12, about 13, about 14, about 15, about 16, about 17, about 18, about 19, about 20, about 21”, about 22″, about 23″, or about 24″ of reflective material. In an aspect, the upper portion of a disclosed sleeve can comprise about 15″ of reflective material. In an aspect, about 10% to about 40%, or about 10% to about 15%, or about 15% to about 20%, or about 20% to about 25%, or about 25% to about 30%, or about 30% to about 35%, or about 35% to about 40% of the upper portion of a disclosed sleeve can comprise reflective material. In an aspect, about 10%, about 15%, about 20%, about 25%, about 30%, about 35%, or about 40% of the upper portion of a disclosed sleeve can comprise reflective material.

In an aspect, a disclosed sleeve for a vertical protrusion can comprise about 48″ in length and the upper portion of a disclosed sleeve can comprise about 6″ to about 24″ of reflective material. In an aspect, a disclosed sleeve for a vertical protrusion can comprise about 48″ in length and the upper portion of a disclosed sleeve can comprise about 12″ of reflective material, or about 15″ of reflective material, or about 18″ of reflective material, or about 21″ of reflective material, or about 24″ of reflective material.

In an aspect, a disclosed sleeve can comprise about 54″ in length and the upper portion of a disclosed sleeve can comprise about 6″ to about 24″ of reflective material. In an aspect, a disclosed sleeve can comprise about 54″ in length and the upper portion of a disclosed sleeve can comprise about 12″ of reflective material, or about 15″ of reflective material, or about 18″ of reflective material, or about 21″ of reflective material, or about 24″ of reflective material.

In an aspect, a disclosed sleeve for a vertical protrusion can comprise about 60″ in length and the upper portion of a disclosed sleeve can comprise about 6″ to about 24″ of reflective material. In an aspect, a disclosed sleeve for a vertical protrusion can comprise about 60″ in length and the upper portion of a disclosed sleeve can comprise about 12″ of reflective material, or about 15″ of reflective material, or about 18″ of reflective material, or about 21″ of reflective material, or about 24″ of reflective material. In an aspect, a disclosed sleeve can comprise about 54″ in length and the upper portion of a disclosed sleeve can comprise about 3″, about 4″ about 5″, about 6″, about 7″, about 8″, about 9″, or about 10″ to about 24″ of reflective material. In an aspect, a disclosed sleeve can comprise about 54″ in length and the upper portion of a disclosed sleeve can comprise about 8″ of reflective material, about 12″ of reflective material, or about 15″ of reflective material, or about 18″ of reflective material, or about 21″ of reflective material, or about 24″ of reflective material.

In an aspect, reflective material can be continuously or discontinuously applied on the upper portion of a disclosed sleeve. In an aspect, the upper portion of a disclosed sleeve can comprise reflective material applied in a continuous manner or in a discontinuous manner. In an aspect, continuous can mean having an unbroken whole, without interruption, constant, continual, and/or unbroken. In an aspect, discontinuous can mean having intervals or gaps, sporadic, interrupted, patterned, and/or intermittent. In an aspect, the upper portion of a disclosed sleeve can comprise reflective material applied in a continuous manner, such as, for example, a block of reflective material. In an aspect, a block of reflective material can comprise various thicknesses, such as, for example, a 2″ block, a 3″ block, a 4″ block, a 5″ block, a 6″ block, a 9″ block, a 12″ block, a 15″ block, an 18″ block, a 21″ block, or a 24″ block of reflective material. In an aspect, a block of reflective material can be about 2″ to about 24″ thick. In an aspect, the upper portion of a disclosed sleeve can comprise reflective material applied in a discontinuous manner, such as, for example, a series of stripes, bands, stars, dots, triangles, squares, rectangles, or any other shape, or combination of shapes, or combination of shapes and stripes.

For example, in an aspect, reflective material can comprise stripes or bands of reflective material. In an aspect, stripes or bands of reflective material can be horizontal stripes, vertical stripes, or diagonal stripes. FIG. 3B shows a disclosed sleeve for a protrusion (such as a vertical protrusion) or a conduit having horizontal stripes or bands of reflective material while FIG. 3C shows a disclosed sleeve for a protrusion (such as a vertical protrusion) or a conduit having vertical strips or bands of reflective material.

In an aspect, a disclosed sleeve can comprise one or more stripes or bands of reflective material. In an aspect, a disclosed sleeve can comprise about 1 strip to about 20 stripes or bands of reflective material. In an aspect, a disclosed sleeve can comprise 1, 2, 3, 4, 5, 6, 7, 8, 9, or 10 stripes or bands of reflective material. The skilled person recognizes that a disclosed sleeve can comprise any number of stripes or bands of reflective material so long as the number or stripes or bands sufficiently performs the role of the reflective material. In an aspect, a disclosed sleeve can comprise 3 strips or bands of reflective material. (see, e.g., FIG. 5).

In an aspect, each stripe or band of reflective material can be about 0.25″ to about 6″ in width. In an aspect, each stripe or band of reflective material can be about 0.5″, about 1″, about 1.5″, about 2.0″, about 2.5″, about 3″, about 3.5″, about 4.0″, about 4.5″, about 5.0″, about 5.5″, or about 6″ in width. In an aspect, each stripe or band of reflective material can be about 2″ in width. In an aspect, one or more stripes of reflective materials can be spaced apart by about 0.5″ to about 6″. In an aspect, each vertical stripe or band of reflective material can be about 3″ to about 36″ in length. In an aspect, each vertical stripe or band of reflective material can be about 2″, about 6″, about 9″, about 12″, about 15″, about 18″, about 21″, about 24″, about 27″, about 29″, about 32″, about 35″, or about 36″ length. In an aspect, a disclosed sleeve can comprise about 2″ to about 3″ strips or bands of reflective material.

In an aspect, each horizontal stripe or band can comprise the same width. In an aspect, each horizontal stripe or band can comprise a different width or a series of different width. In an aspect, it is not necessary for each horizontal stripe or band to be identical in width. In an aspect, each vertical stripe or band can comprise the same length. In an aspect, each vertical stripe or band can comprise a different length or a series of different lengths. In an aspect, it is not necessary for each vertical stripe or band to be identical in width or length.

In an aspect, one or more stripes of reflective materials can be spaced apart by about 0.5″, about 1″, about 1.5″, about 2″, about 2.5″, about 3″, about 3.5″, about 4″, about 4.5″, about 5″ “or, about 5.5, about 6”. In an aspect, stripes or bands of reflective material can be spaced about 0.5″ to about 6″ from the open end of the upper portion of a disclosed sleeve. In an aspect, reflective material can be spaced about 0.5″, about 1″, about 1.5″, about 2″, about 2.5″, about 3″, about 3.5, about 4″, about 4.5″, about 5″, about 5.5″, or about 6″ from the open end of the upper portion of a disclosed sleeve.

In an aspect, a disclosed sleeve can comprise one or more horizontal stripes of reflective material, wherein the one or more stripes of a disclosed width can be spaced apart by a disclosed width, wherein the first of the one or more stripes can be spaced a disclosed width from the open end of the upper portion of a disclosed sleeve. For example, a first 2″ stripe of reflective material can be spaced about 3″ from the open end of a disclosed sleeve, which can be followed by 3″ without a reflective material, which can be followed by a second 2″ stripe of reflective material, which can be followed by 3″ without a reflective material, and which can be followed by a third 2″ stripe of reflective materials. The pattern can continue. In an aspect, for example, a first 1″ stripe of reflective material can be spaced about 3″ from the open end of a disclosed sleeve, which can be followed by 1″ without a reflective material, which can be followed by a second 1″ stripe of reflective material, which can be followed by 1″ without a reflective material, and which can be followed by a third 1″ stripe of reflective materials. The pattern can continue. In an aspect, a disclosed sleeve can comprise one or more stripes or bands of reflective material, wherein the one or more stripes or bands can be about 2″ in width, and wherein the one or more stripes or bands can be spaced apart by about 3″.

In an aspect, a disclosed sleeve can comprise one or more vertical stripes of reflective material, wherein the one or more stripes of a disclosed width can be spaced apart by a disclosed width, wherein the first of the one or more stripes can be spaced a disclosed width from the open end of the upper portion of a disclosed sleeve, wherein the stripes can be a disclosed length. In an aspect, a disclosed sleeve can comprise one or more vertical stripes of reflective material, wherein the one or more stripes can be about 1″ in width, wherein the one or more stripes can be spaced apart by about 2″, and wherein the top of each vertical stripe can be spaced about 3″ from the open end of the upper portion of a disclosed sleeve. For example, the top of each 0.5″ stripe or band of reflective material can be spaced about 3″ from the open end of a disclosed sleeve, and the 0.5″ stripes of reflective material are separated by 1″ without a reflective material, which vertical pattern of reflective and non-reflective material is repeated for the entire diameter of the vertical protrusion regardless of whether the protrusion is a survey stake, for example, or an electrical or liquid conduit, for example. For example, the top of each 1″ stripe or band of reflective material can be spaced about 3″ from the open end of a disclosed sleeve, and the 1″ stripes or bands of reflective material are separated by 1″ without a reflective material, which vertical pattern of reflective and non-reflective material is repeated for the entire diameter of the vertical protrusion regardless of whether the protrusion is a survey stake, for example, or an electrical or liquid conduit, for example.

In an aspect, reflective material can comprise a chevron pattern or a wavy pattern. FIG. 3A shows a disclosed sleeve for a protrusion (such as a vertical protrusion) or a conduit having reflective material in a chevron pattern. In an aspect, reflective material can comprise a series of one or more dots, wherein the dots can be arranged in various patterns (e.g., rows, columns, waves, crosses, x's, etc.) or can be randomly placed. In an aspect, reflective material can comprise a series of one or more squares, rectangles, triangles, or a combination thereof, wherein the squares, rectangles, triangles, or the combination thereof can be arranged in various patterns (e.g., rows, columns, waves, crosses, x's, etc.) or can be randomly placed. In an aspect, reflective material can comprise a series of one or more known shapes, or a combination of known shapes, wherein the known shapes, or the combination thereof can be arranged in various patterns (e.g., rows, columns, waves, crosses, x's, etc.) or can be randomly placed.

In an aspect, reflective material can comprise reflective fabric, reflective films, reflective tape, reflective yarn, reflective trims, or a combination thereof. In an aspect, reflective material can be created with tiny spherical glass beads. In an aspect, reflective material can comprise any color such as, for example, red, orange, yellow, green, blue, purple, white, or can comprise multiple colors. In an aspect, reflective tape can be outdoor reflective tape.

In an aspect, a disclosed sleeve for a vertical protrusion can be devoid of wind vents. In an aspect, a disclosed sleeve for a vertical protrusion can comprise 1 to 100 wind vents. As known to the art, wind vents can reduce the wind load on a disclosed sleeve. In an aspect, one or more wind vents can allow for wind and/or air to be safely vented through a disclosed sleeve. In an aspect, one or more vents can prolong the physical integrity, and therefore, usability of a disclosed sleeve. In an aspect, a wind vent can be positioned apart about 0.5″ to about 6″ on the upper portion of a disclosed sleeve. In an aspect, one or more wind vents can be positioned in a row. In an aspect, a wind vent can be positioned about 1″ to about 6″ from the open-end of a disclosed sleeve. In an aspect, one or more wind vents can be positions about 3″ from the open-end of a disclosed sleeve. Wind vents can be various shapes and sizes. For example, in an aspect, a wind vent can comprise a circular shape, a crescent-moon shape, an oblong shape, an egg shape, a rectangular shape, a square shape, a slit shape, or a combination thereof. FIG. 4A shows a disclosed sleeve for a protrusion (such as a vertical protrusion) or a conduit having a series of crescent-moon shaped wind vents, FIG. 4B shows a disclosed sleeve for a protrusion (such as a vertical protrusion) or a conduit having circular-shaped wind vents, and FIG. 4C shows a disclosed sleeve for a protrusion (such as a vertical protrusion) or a conduit having slit-shaped wind vents.

Determining the desired number of wind vents can comprise several factors known to the skilled person in the art. For example, as known to the skilled person, wind vent can serve at least two purposes including venting wind around the disclosed sleeve and venting heat from inside and around the disclosed sleeve.

In an aspect, a disclosed sleeve having a rectangular cross-sectional shape can comprise wind vents along all or a portion of the perimeter. For example, in a disclosed sleeve having a rectangular cross-sectional shape, wind vents can be on all four surfaces, or wind vents can be on the two shorter parallel surfaces, or on the two longer parallel surfaces, or one of each, for example. In an aspect a disclosed sleeve having a square cross-sectional shape can comprise wind vents along all or a portion of the perimeter. In an aspect, in a disclosed sleeve having a square cross-sectional shape, wind vents can be on all four surfaces, or on two parallel surfaces. In an aspect, a disclosed sleeve having a circular cross-sectional shape can comprise wind vents along all or a portion of the perimeter.

In an aspect, about 1% to about 50% of a disclosed sleeve can comprise wind vents. For example, in an aspect, about 1% to about 25% of the upper portion of a disclosed sleeve can comprise wind vents. For example, in an aspect, about 5%, about 10%, about 15%, about 20%, or about 25% of the upper portion of a disclosed sleeve can comprise wind vents. In an aspect, a disclosed sleeve can be devoid of wind vents.

In an aspect, the upper portion of a disclosed sleeve for a vertical protrusion can comprise a flag or string or ribbon or the like. In an aspect, a disclosed flag, string, ribbon, or the like can be weather resistant and durable. In an aspect, a disclosed flag, string, ribbon, or the like can comprise a fluorescent or neon coloring. In an aspect, a disclosed flag, string, ribbon, or the like can comprise reflective material. In an aspect, a flag, string, ribbon, or the like can serve to improve visibility of a disclosed sleeve for a vertical protrusion.

In an aspect, a disclosed sleeve for a vertical protrusion can comprise a plastic. In an aspect, a disclosed sleeve for a vertical protrusion can comprise a combination of one or more plastics. In an aspect, a disclosed sleeve can comprise a plastic composite. Plastics are diverse. The art is familiar with plastics, which include, but are not limited to, acrylic or polymethyl methacrylate (PMMA), acrylonitrile-butadiene-styrene (ABS), high density polyethylene (PE), low density polyethylene (PE), polyamide (PA), polycarbonate (PC), polyetherimide, polyethylene (PE), polyethylene terephthalate (PETE or PET), polyoxymethylene (POM), polyphenylene sulfide (PPS), polypropylene (PP), polystyrene (PS), polyurethane (PUR), polyvinyl chloride (PVC), polyvinylidene fluoride (PVDF), and combinations thereof.

In an aspect, a disclosed sleeve for a vertical protrusion can comprise butyrate, a butyrate composite, or a butyrate comprising composition. A disclosed sleeve comprising butyrate (cellulose acetate butyrate) will be transparent and rigid with excellent dimensional stability and high impact strength.

In an aspect, for example, acrylic polymer can be prepared from monomers including but not limited to methyl acrylate, acrylic acid, methacrylic acid, methyl methacrylate, butyl methacrylate, cyclohexyl methacrylate as well as combinations thereof. In an aspect, substituted acrylates and methacrylates such as hydroxyethyl acrylate, hydroxybutyl acrylate, 2-ethylhexyl acrylate, and n-butyl acrylate can also be used. In an aspect, polyesters can be obtained, for example, by reacting an organic polycarboxylic acid with an organic polyol containing primary or secondary hydroxyl groups (e.g., ethylene glycol, butylene glycol, neopentyl glycol, and cyclohexane dimethanol) such as phthalic acid, hexahydrophthalic acid, adipic acid, maleic acid, terephthalic acid, isophthalic acid, sebacic acid, dodecanedioic acid, etc., or anhydrides thereof. In an aspect, polyurethanes can be used to make a disclosed sleeve. Polyurethanes can be prepared by the reaction of polyisocyanates with polyols, polyamines, or water. Examples of polyisocyanates include hexamethylene diisocyanate, toluene diisocyanate, diphenylmethane diisocyanate (MDI), isophorone diisocyanate, and biuret and thiocyanurate of these diisocyanates. Examples of polyols can include but are not limited to low molecular weight aliphatic polyols, polyester polyols, polyether polyols, fatty alcohols and the like. Examples of other materials from which a disclosed sleeve can be made include but are not limited to acrylonitrile-butadiene-styrene, VALOX™ (polybutylene phthalate, commercially available from SABIC's Innovative Plastics), and XENOY™ (LEXAN™ and VALOX™ Blend, commercially available from SABIC's Innovative Plastics).

In an aspect, plastics include thermoplastics, which are softened by heat and can be molded (e.g., injection molded, blow molded, vacuum formed, etc.). Thermoplastics include, but are not limited to, the following: acrylic, polypropylene, polystyrene, polythene, and PVC. Plastics include thermosets, which are formed by a heat process but are then set (for example, like concrete) and cannot change shape by reheating. Thermosets include, but are not limited to, the following: melamine (e.g., kitchen worktops), bakelite (e.g., black saucepan handles), polyester, and epoxy resins.

In an aspect, a plastic or plastic composite may also contain additives such as one or more colorants, one or more release agent, one or more antioxidant, one or more surfactant, plasticizer, one or more infrared absorber, one or more antistatic agent, one or more dispersant, one or more compatibilizer, one or more ultraviolet absorber, and combinations thereof.

In an aspect, a disclosed sleeve for a vertical protrusion can be resistant to ultraviolet (UV) light, tolerant of ultraviolet (UV) light, ultraviolet (UV) light stable, or a combination thereof. For example, in an aspect, a disclosed sleeve comprising acrylic, polymethyl methacrylate (PMMA), PVDF, PTFE, a combination thereof, or a composite thereof can be UV resistant, UV tolerant, UV stable, or a combination thereof. In an aspect, the inherent UV resistance of a plastic used for a disclosed sleeve for a vertical protrusion can be improved or enhanced by adding UV stabilizers or UV resistant caps to protect the base polymer. For example, UV stabilizers can be added to a polymer to inhibit one or more photoinitiation processes. UV Stabilizers include ultraviolet absorbers, quenchers, and hindered amine light stabilizers (HALS). Absorbers, quenchers, and HALS are three types of UV stabilizers function by different mechanisms, one or more of them can be combined to create a synergistic effect. In an aspect, for example, benzotriazoles can be combined with HALS to protect pigmented systems from fading and color changes. In an aspect, a composite can comprise a combination of one or more plastics and one or more non-plastic materials. In an aspect, a composite can demonstrate enhanced properties (such as, for example, enhanced physical and mechanical properties).

In an aspect, a disclosed sleeve for a vertical protrusion can comprise a weather-resistant layer (e.g., a coating). A weather-resistant layer can be applied in various ways, including dipping the plastic substrate at room temperature and atmospheric pressure into the coating solution (i.e., dip coating). weather-resistant layer can also be applied by other methods including, but not limited to, flow coating, curtain coating, and spray coating. A weather-resistant layer can comprise silicon (e.g., silicone hard coat), polyurethane (e.g., polyurethane acrylate), acrylic, polyacrylate (e.g., polymethacrylate, polymethylmethacrylate), polyvinylidene fluoride, esters, epoxides, or combinations thereof. A weather-resistant layer can also comprise one or more ultraviolet absorbing molecules (e.g., hydroxyphenyltazine, hydroxybenzophenone, hydroxylphenylbenzotazol, hydroxyphenyltriazine, polyarylresorcinol, and cyanoacrylate, or a combination thereof). In an aspect, for example, a weather-resistant layer can comprise a silicone hard coat layer (AS4000 or AS4700, commercially available from Momentive Performance Materials). In an aspect, a weathering layer can include a primer layer and a coating (e.g., a topcoat). A primer layer can help with adherence to the sleeve. A primer layer can include, but is not limited to, acrylic, polyester, epoxide, and combinations thereof. A primer layer can contain an ultraviolet absorber in addition to or instead of being present in the top coat of the weathering layer. For example, in an aspect, a primer layer can comprise an acrylic primer (SHP401 or SHP470, commercially available from Momentive Performance Materials).

In an aspect, a disclosed sleeve for a vertical protrusion can comprise one or more abrasion resistant layer (e.g., a coating or a plasma coating). An abrasion resistant layer can comprise a single layer or multiple layers, and can enhance functionality by improving the abrasion resistance of the glaze. For example, in an aspect, an abrasion resistant layer on a disclosed sleeve can be comprise aluminum oxide, barium fluoride, boron nitride, hafnium oxide, lanthanum fluoride, magnesium fluoride, magnesium oxide, scandium oxide, silicon monoxide, silicon dioxide, silicon oxide, zirconium oxide, zinc oxide, zinc oxide, zinc oxide, zinc sulfide, zirconium oxide, zirconium titanate, zirconium titanate, zirconium titanate, zirconium titanate, zirconium titanate, zirconium titanate, organic coatings, inorganic coatings, and combinations thereof.

In an aspect, a weather-resistant layer can be applied by various deposition techniques such as a vacuum assisted deposition process and an atmospheric coating process. For example, in an aspect, a vacuum assisted deposition processes can include plasma enhanced chemical vapor deposition (PECVD), arc-PECVD, expanding thermal plasma PECVD (PECVD), ion assisted plasma deposition, magnetron sputtering but are not limited to, sputtering, electron beam evaporation, and ion beam sputtering, while atmospheric pressure coating processes can include curtain coating, spray coating, but are not limited to, spin coating, dip coating, and flow coating.

In an aspect, disclosed layer can comprise one or more antioxidants, one or more flow additives, one or more dispersants, one or more antioxidants, one or more surfactants, one or more plasticizers, one or more infrared absorbers, one or more compatibilizing agents, one or more curing catalysts, one or more ultraviolet absorber, and combinations thereof. The skilled person in the art can optimize the amount of each of the aforementioned additives based on desired characteristics and performance of a disclosed sleeve.

In an aspect, a disclosed sleeve for a vertical protrusion can be formed in various ways well known to the art including, but not limited to, injection molding, extrusion, cold forming, vacuum forming, extrusion molding, transfer molding, thermal forming, and the like.

### 3. Sleeves for a Survey Stake

Disclosed herein are sleeves for a survey stake. Disclosed herein is a sleeve for placement on a survey stake, comprising an elongate body comprising an upper portion and a lower portion, wherein each portion of the elongate body comprises an open end, wherein the upper portion comprises a reflective material, and wherein the lower portion directly contacts a survey stake. Disclosed herein is a sleeve for placement on a survey stake, comprising an elongate body comprising an upper portion and a lower portion, wherein the upper portion of elongate body comprises a closed end and wherein the lower portion of the elongate body comprises an open end, wherein the upper portion comprises a reflective material, and wherein the lower portion directly contacts a survey stake. Disclosed herein is a sleeve for placement on a survey stake, comprising an elongate body comprising an upper portion and a lower portion, wherein each portion of the elongate body comprises an open end, wherein the upper portion comprises a reflective material and one or more wind vents, and wherein the lower portion directly contacts a survey stake. Disclosed herein is a sleeve for placement on a survey stake, comprising an elongate body comprising an upper portion and a lower portion, wherein the upper portion of elongate body comprises a closed end and wherein the lower portion of the elongate body comprises an open end, wherein the upper portion comprises a reflective material and one or more wind vents, and wherein the lower portion directly contacts a survey stake.

FIG. 1C shows an exemplary disclosed sleeve (4) positioned on the exposed aspect of a vertical protrusion (such as a survey stake) or a conduit (1). The lower portion of the exemplary disclosed sleeve directly contacts the exposed aspect (1) of the vertical protrusion (such as a survey stake) or the conduit. The unexposed or nonexposed aspect (3) of the vertical protrusion (such as a survey stake) or the conduit is below the surface of the ground or floor or other surface (2). The disclosed sleeve comprises an upper portion and a lower portion, which is indicated (for convenience only) by a dotted line (8). The upper portion comprises reflective material (6) and one or more wind vents (5). The end (7) of the upper portion of the disclosed sleeve can either be opened or closed. In an aspect, the upper portion of a disclosed sleeve can comprise a cap (see, e.g., FIG. 5). In an aspect, a disclosed sleeve for a survey stake can be one piece having no seam. In an aspect, a disclosed sleeve for a survey stake can be one piece having a connectable or closeable seam along part of or the whole length of the sleeve. In an aspect, a disclosed sleeve for a survey stake can be one piece having an open seam along part of or the whole length of the sleeve.

In an aspect, a disclosed sleeve is reusable. Reusable means that a disclosed sleeve is capable of being used again or repeatedly.

In an aspect, a disclosed sleeve can be positioned on the exposed aspect of a survey stake. In an aspect, the term “positioned on” can mean that the inside of a disclosed sleeve can directly contact the exposed survey stake. For example, a disclosed sleeve can fit over and around an exposed survey stake. In an aspect, the term “exposed” can refer to that aspect of a survey stake that extends from the surface of the ground or the earth, or the surface of a floor or wall or ceiling or roof, or the surface of a construction site, or the like. The non-exposed or unexposed aspect of a survey stake is that aspect that is below the surface of the ground or the earth, or the surface of a floor or wall or ceiling or roof, or the surface of construction site, or the like. In an aspect, a disclosed sleeve can directly contact about 12″ to about 60″ or about 24″ to about 48″ of an exposed survey stake. In an aspect, a disclosed sleeve can directly contact about 24″, about 36″, or about 48″ of an exposed survey stake.

In an aspect, a disclosed sleeve for a survey stake can comprise a rectangular cross-sectional shape. FIG. 2A is a cross-sectional view showing a disclosed sleeve (solid border) positioned on a protrusion (such as a survey stake) or conduit having a rectangular cross-sectional shape (hatched). In an aspect, disclosed sleeve comprising a rectangular cross-sectional shape can be about ¼″ in width to about ¾″ in width and about 1¼″ to about 1¾″ in height. In an aspect, disclosed sleeve comprising a rectangular cross-sectional shape can be about ½″ in width and about 1½″ in height. In an aspect, a disclosed sleeve comprising a rectangular cross-sectional shape can accommodate the size of any exposed survey stake also having a rectangular cross-sectional shape. For example, if an exposed survey stake is about ½″ in width and about 1½″ in height, then the disclosed sleeve is at least ½″ in width and at least 1½″ in height. For example, if an exposed survey stake is about 1″ in width and about 3″ in height, then the disclosed sleeve is at least 1″ in width and at least 3″ in height.

In an aspect, a disclosed sleeve for a survey stake can comprise a square cross-sectional shape. FIG. 2B is a cross-sectional view showing a disclosed sleeve (solid border) positioned on a protrusion (such as a survey stake) or conduit having a square cross-sectional shape (hatched). In an aspect, a disclosed sleeve comprising a square cross-sectional shape can be about ¾″ to about 6″ both in width and in height. In an aspect, for a survey stake, a disclosed sleeve comprising a square cross-sectional shape can be about ¾″ in width and in height, or about ½″ in width and in height, or about ¾″ in width and in height, or about 1″ in width and in height, or about 1¼″ in width and in height, or about 1½″ in width and in height, or about 1¾″ in width and in height, or about 2″ in width and in height, or about 2¼″ in width and in height, or about 2½″ in width and in height, or about 2¾″ in width and in height, or about 3″ in width and in height, or about 3V in width and in height, or about 3½″ in width and in height, or about 3¾″ in width and in height, or about 4″ in width and in height, or about 4V in width and in height, or about 4½″ in width and in height, or about 4¾″ in width and in height, or about 5″ in width and in height, or about 5V in width and in height, or about 5½″ in width and in height, or about 5¾″ in width and in height, or about 6″ in width and in height. In an aspect, a disclosed sleeve comprising a square cross-sectional shape can accommodate the size of any exposed survey stake also having a square cross-sectional shape. For example, if an exposed survey stake is about ½″ in width and about ½″ in height, then the disclosed sleeve is at least ½″ in width and at least ½″ in height. For example, if an exposed survey is about 1½″ in width and about 1½″ in height, then the disclosed sleeve is at least 1½″ in width and at least 1½″ in height.

Several factors contribute to the determination of the most appropriate length of a disclosed sleeve for a survey stake. For example, the need for visibility of the survey stake in the surrounding environment (e.g., an active or inactive construction zone or site, a wooded area, a grassy area, etc.), weather conditions (e.g., rain, sleet, snow, fog, smoke, haze, etc.), the amount of exposed survey stake, the purpose of the survey stake, the type of equipment employed in the surrounding environment (e.g., tractors, harvesting machines, dump trucks, cement trucks, excavation equipment, utility trucks, and other heavy machinery). In an aspect, a disclosed sleeve for a survey stake can be about 24″ to about 72″ in length, or about 48″ to about 60″ in length, or about 24″, or about 30″, or about 36″, or about 42″, or about 48″, or about 54″, or about 60″, or about 66″, or about 72″ in length. In an aspect, a disclosed sleeve can about 54″ in length.

Several factors contribute to the determination of the most appropriate wall thickness of a disclosed sleeve for a survey stake. For example, a disclosed sleeve can have a wall thick enough to confer durability onto the disclosed sleeve. In an aspect, for example, a disclosed sleeve can have wall thick enough to ensure that the sleeve is reusable or that it can be used repeatedly. In an aspect, a disclosed sleeve can have a wall thickness of about 0.01″ to about 0.1″. In an aspect, a disclosed sleeve can have a wall thickness of about 0.04″. In an aspect, all walls of a disclosed sleeve having a square or rectangular cross-sectional shape can comprise the same thickness. In an aspect, one, two, three, or four walls of a disclosed sleeve having a square or rectangular cross-sectional shape can comprise the same thickness. In an aspect, two of the walls of a disclosed sleeve having a square or rectangular cross-sectional shape can comprise the same thickness. In an aspect, two of the walls of a disclosed sleeve having a square or rectangular cross-sectional shape can comprise the same thickness while the other two walls can comprise the same thickness, which can be (but does not have to be) the same thickness as the first two walls.

In an aspect, a wall of a disclosed sleeve comprising a square or rectangular cross-sectional shape can have a thickness of about 0.01″ to about 0.1″. In an aspect, a disclosed sleeve can have a wall thickness of about 0.04″. In an aspect, a wall of a disclosed sleeve comprising a square or rectangular cross-sectional shape can have a thickness of about 1/16″ to about ⅞″. In an aspect, a wall of a disclosed sleeve comprising a square or rectangular cross-sectional shape can have a thickness of about 3/16″ or about 1/10″. In an aspect, a wall of a disclosed sleeve comprising a square or rectangular cross-sectional shape can have a thickness of about 10 mil to about 300 mil. In an aspect, a wall of a disclosed sleeve comprising a square or rectangular cross-sectional shape can have a thickness of about 10 mil to about 30 mil, about 30 mil to about 50 mil, about 50 mil to about 70 mil, about 70 mil to about 90 mil, about 90 mil to about 110 mil, about 110 mil to about 130 mil, about 130 mil to about 150 mil, about 150 mil to about 170 mil, about 170 mil to about 190 mil, about 190 mil to about 210 mil, about 210 mil to about 230 mil, about 230 mil to about 250 mil, about 250 mil to about 270 mil, or about 270 mil to about 300 mil. In an aspect, a wall of a disclosed sleeve comprising a square or rectangular cross-sectional shape can have a thickness of about 30 mil, about 40 mil, about 50 mil, about 60 mil, about 70 mil, about 80 mil, about 90 mil, or about 100 mil. In an aspect, a disclosed sleeve comprising a circular cross-sectional shape can have a thickness of about 40 mil.

In an aspect, the lower portion of a disclosed sleeve can be in direct contact with an exposed survey stake. In an aspect, for example, a disclosed sleeve can fit over and around an exposed survey stake, whereby the lower portion of the sleeve physically contacts the exposed survey stake. In an aspect, the physical contact can be direct physical contact. In an aspect, a disclosed sleeve can envelop the exposed aspect of a survey stake. In an aspect, the lower portion of a disclosed sleeve can be in direct contact with the entire length of the exposed survey stake.

In an aspect, the lower portion of a disclosed sleeve directly can be in direct contact with about 12″ to about 72″, or about 12″ to about 60″, or about 12″ to about 48″, or about 12″ to about 36″, or about 12″ to about 24″ of the exposed survey stake. In an aspect, the lower portion of a disclosed sleeve directly can be in direct contact with about 12″ to about 24″, or about 24″ to about 36″, or about 36″ to about 48″, or about 48″ to about 60″, or about 60″ to about 72″ of the exposed survey stake.

In an aspect, the upper portion of a disclosed sleeve for a survey stake can comprise about 6″ to about 24″, about 12″ to about 18″, or about 14″ to about 16″ of reflective material. In an aspect, the upper portion of a disclosed sleeve can comprise about 6″, about 7″, about 8″, about 9″, about 10″, about 11″ “ ” “ ” “ ” “ ” “, about 12, about 13, about 14, about 15, about 16, about 17, about 18, about 19, about 20, about 21”, about 22″, about 23″, or about 24″ of reflective material. In an aspect, the upper portion of a disclosed sleeve can comprise about 15″ of reflective material. In an aspect, about 10% to about 40%, or about 10% to about 15%, or about 15% to about 20%, or about 20% to about 25%, or about 25% to about 30%, or about 30% to about 35%, or about 35% to about 40% of the upper portion of a disclosed sleeve can comprise reflective material. In an aspect, about 10%, about 15%, about 20%, about 25%, about 30%, about 35%, or about 40% of the upper portion of a disclosed sleeve can comprise reflective material. In an aspect, a disclosed sleeve can comprise about 54″ in length and the upper portion of a disclosed sleeve can comprise about 6″ to about 24″ of reflective material. In an aspect, a disclosed sleeve can comprise about 54″ in length and the upper portion of a disclosed sleeve can comprise about 12″ of reflective material, or about 15″ of reflective material, or about 18″ of reflective material, or about 21″ of reflective material, or about 24″ of reflective material.

In an aspect, a disclosed sleeve for a survey stake can comprise about 48″ in length and the upper portion of a disclosed sleeve can comprise about 6″ to about 24″ of reflective material. In an aspect, a disclosed sleeve for a survey stake can comprise about 48″ in length and the upper portion of a disclosed sleeve for a survey stake can comprise about 12″ of reflective material, or about 15″ of reflective material, or about 18″ of reflective material, or about 21″ of reflective material, or about 24″ of reflective material. In an aspect, a disclosed sleeve for a survey stake can comprise about 60″ in length and the upper portion of a disclosed sleeve can comprise about 8″ to about 24″ of reflective material. In an aspect, a disclosed sleeve for a survey stake can comprise about 60″ in length and the upper portion of a disclosed sleeve can comprise about 12″ of reflective material, or about 15″ of reflective material, or about 18″ of reflective material, or about 21″ of reflective material, or about 24″ of reflective material. In an aspect, a disclosed sleeve can comprise about 54″ in length and the upper portion of a disclosed sleeve can comprise about 3″, about 4″ about 5″, about 6″, about 7″, about 8″, about 9″, or about 10″ to about 24″ of reflective material. In an aspect, a disclosed sleeve can comprise about 54″ in length and the upper portion of a disclosed sleeve can comprise about 8″ of reflective material, about 12″ of reflective material, or about 15″ of reflective material, or about 18″ of reflective material, or about 21″ of reflective material, or about 24″ of reflective material.

In an aspect, reflective material can be continuously or discontinuously applied on the upper portion of a disclosed sleeve. In an aspect, the upper portion of a disclosed sleeve can comprise reflective material applied in a continuous manner or in a discontinuous manner. In an aspect, continuous can mean having an unbroken whole, without interruption, constant, continual, and/or unbroken. In an aspect, discontinuous can mean having intervals or gaps, sporadic, interrupted, patterned, and/or intermittent. In an aspect, the upper portion of a disclosed sleeve can comprise reflective material applied in a continuous manner, such as, for example, a block of reflective material. In an aspect, a block of reflective material can comprise various thicknesses, such as, for example, a 2″ block, a 3″ block, a 4″ block, a 5″ block, a 6″ block, a 9″ block, a 12″ block, a 15″ block, an 18″ block, a 21″ block, or a 24″ block of reflective material. In an aspect, a block of reflective material can be about 2″ to about 24″ thick. In an aspect, the upper portion of a disclosed sleeve can comprise reflective material applied in a discontinuous manner, such as, for example, a series of stripes, bands, stars, dots, triangles, squares, rectangles, or any other shape, or combination of shapes, or combination of shapes and stripes.

For example, in an aspect, reflective material can comprise stripes or bands of reflective material. In an aspect, stripes or bands of reflective material can be horizontal stripes, vertical stripes, or diagonal stripes. FIG. 3B shows a disclosed sleeve for a protrusion (such as a survey stake) or a conduit having horizontal stripes or bands of reflective material while FIG. 3C shows a disclosed sleeve for a protrusion (such as a survey stake) or a conduit having vertical strips or bands of reflective material.

In an aspect, a disclosed sleeve can comprise one or more stripes or bands of reflective material. In an aspect, a disclosed sleeve can comprise about 1 strip to about 20 stripes or bands of reflective material. In an aspect, a disclosed sleeve can comprise 1, 2, 3, 4, 5, 6, 7, 8, 9, or 10 stripes or bands of reflective material. The skilled person recognizes that a disclosed sleeve can comprise any number of stripes or bands of reflective material so long as the number or stripes or bands sufficiently performs the role of the reflective material. In an aspect, a disclosed sleeve can comprise 3 strips or bands of reflective material. (see, e.g., FIG. 5).

In an aspect, each stripe or band of reflective material can be about 0.25″ to about 6″ in width. In an aspect, each stripe or band of reflective material can be about 0.5″, about 1″, about 1.5″, about 2.0″, about 2.5″, about 3″, about 3.5″, about 4.0″, about 4.5″, about 5.0″, about 5.5″, or about 6″ in width. In an aspect, each stripe or band of reflective material can be about 2″ in width. In an aspect, one or more stripes of reflective materials can be spaced apart by about 0.5″ to about 6″. In an aspect, each vertical stripe or band of reflective material can be about 2″ to about 36″ in length. In an aspect, each vertical stripe or band of reflective material can be about 2″, about 3″, about 6″, about 9″, about 12″, about 15″, about 18″, about 21″, about 24″, about 27″, about 29″, about 32″, about 35″, or about 36″ length. In an aspect, a disclosed sleeve can comprise about 2″ to about 3″ strips or bands of reflective material. In an aspect, each horizontal stripe or band can comprise the same width. In an aspect, each horizontal stripe or band can comprise a different width or a series of different width. In an aspect, it is not necessary for each horizontal stripe or band to be identical in width. In an aspect, each vertical stripe or band can comprise the same length. In an aspect, each vertical stripe or band can comprise a different length or a series of different lengths. In an aspect, it is not necessary for each vertical stripe or band to be identical in width or length.

In an aspect, one or more stripes of reflective materials can be spaced apart by about 0.5″, about 1″, about 1.5″, about 2″, about 2.5″, about 3″, about 3.5″, about 4″, about 4.5″, about 5″ “or, about 5.5, about 6”. In an aspect, stripes or bands of reflective material can be spaced about 0.5″ to about 6″ from the open end of the upper portion of a disclosed sleeve. In an aspect, reflective material can be spaced about 0.5″, about 1″, about 1.5″, about 2″, about 2.5″, about 3″, about 3.5, about 4″, about 4.5″, about 5″, about 5.5″, or about 6″ from the open end of the upper portion of a disclosed sleeve.

In an aspect, a disclosed sleeve can comprise one or more horizontal stripes of reflective material, wherein the one or more stripes of a disclosed width can be spaced apart by a disclosed width, wherein the first of the one or more stripes can be spaced a disclosed width from the open end of the upper portion of a disclosed sleeve. For example, a first 2″ stripe of reflective material can be spaced about 3″ from the open end of a disclosed sleeve, which can be followed by 3″ without a reflective material, which can be followed by a second 2″ stripe of reflective material, which can be followed by 3″ without a reflective material, and which can be followed by a third 2″ stripe of reflective materials. The pattern can continue. In an aspect, for example, a first 1″ stripe of reflective material can be spaced about 3″ from the open end of a disclosed sleeve, which can be followed by 1″ without a reflective material, which can be followed by a second 1″ stripe of reflective material, which can be followed by 1″ without a reflective material, and which can be followed by a third 1″ stripe of reflective materials. The pattern can continue. In an aspect, a disclosed sleeve can comprise one or more stripes or bands of reflective material, wherein the one or more stripes or bands can be about 2″ in width, and wherein the one or more stripes or bands can be spaced apart by about 3″.

In an aspect, a disclosed sleeve can comprise one or more vertical stripes of reflective material, wherein the one or more stripes of a disclosed width can be spaced apart by a disclosed width, wherein the first of the one or more stripes can be spaced a disclosed width from the open end of the upper portion of a disclosed sleeve, wherein the stripes can be a disclosed length. In an aspect, a disclosed sleeve can comprise one or more vertical stripes of reflective material, wherein the one or more stripes can be about 1″ in width, wherein the one or more stripes can be spaced apart by about 2″, and wherein the top of each vertical stripe can be spaced about 3″ from the open end of the upper portion of a disclosed sleeve. For example, the top of each 0.5″ stripe or band of reflective material can be spaced about 3″ from the open end of a disclosed sleeve, and the 0.5″ stripes of reflective material are separated by 1″ without a reflective material, which vertical pattern of reflective and non-reflective material is repeated for the entire perimeter of a survey stake. For example, the top of each 1″ stripe or band of reflective material can be spaced about 3″ from the open end of a disclosed sleeve, and the 1″ stripes or bands of reflective material are separated by 1″ without a reflective material, which vertical pattern of reflective and non-reflective material is repeated for the entire perimeter of the survey stake.

In an aspect, reflective material can comprise a chevron pattern or a wavy pattern. FIG. 3A shows a disclosed sleeve for a protrusion (such as a survey stake) or a conduit having reflective material in a chevron pattern. In an aspect, reflective material can comprise a series of one or more dots, wherein the dots can be arranged in various patterns (e.g., rows, columns, waves, crosses, x's, etc.) or can be randomly placed. In an aspect, reflective material can comprise a series of one or more squares, rectangles, triangles, or a combination thereof, wherein the squares, rectangles, triangles, or the combination thereof can be arranged in various patterns (e.g., rows, columns, waves, crosses, x's, etc.) or can be randomly placed. In an aspect, reflective material can comprise a series of one or more known shapes, or a combination of known shapes, wherein the known shapes, or the combination thereof can be arranged in various patterns (e.g., rows, columns, waves, crosses, x's, etc.) or can be randomly placed.

In an aspect, reflective material can comprise reflective fabric, reflective films, reflective tape, reflective yarn, reflective trims, or a combination thereof. In an aspect, reflective material can be created with tiny spherical glass beads. In an aspect, reflective material can comprise any color such as, for example, red, orange, yellow, green, blue, purple, white, or can comprise multiple colors. In an aspect, reflective tape can be outdoor reflective tape.

In an aspect, a disclosed sleeve for a survey stake can be devoid of wind vents. In an aspect, a disclosed sleeve for a survey stake can comprise 1 to 100 wind vents. As known to the art, wind vents can reduce the wind load on a disclosed sleeve. In an aspect, one or more wind vents can allow for wind and/or air to be safely vented through a disclosed sleeve. In an aspect, one or more vents can prolong the physical integrity, and therefore, usability of a disclosed sleeve. In an aspect, a wind vent can be positioned apart about 0.5″ to about 6″ on the upper portion of a disclosed sleeve. In an aspect, one or more wind vents can be positioned in a row. In an aspect, a wind vent can be positioned about 1″ to about 6″ from the open-end of a disclosed sleeve. In an aspect, one or more wind vents can be positions about 3″ from the open-end of a disclosed sleeve. Wind vents can be various shapes and sizes. For example, in an aspect, a wind vent can comprise a circular shape, a crescent-moon shape, an oblong shape, an egg shape, a rectangular shape, a square shape, a slit shape, or a combination thereof. FIG. 4A shows a disclosed sleeve for a protrusion (such as a survey stake) or a conduit having a series of crescent-moon shaped wind vents, FIG. 4B shows a disclosed sleeve for a protrusion (such as a survey stake) or a conduit having circular-shaped wind vents, and FIG. 4C shows a disclosed sleeve for a protrusion (such as a survey stake) or a conduit having slit-shaped wind vents.

Determining the desired number of wind vents can comprise several factors known to the skilled person in the art. For example, as known to the skilled person, wind vent can serve at least two purposes including venting wind around the disclosed sleeve and venting heat from inside and around the disclosed sleeve.

In an aspect, a disclosed sleeve having a rectangular cross-sectional shape can comprise wind vents along all or a portion of the perimeter. For example, in a disclosed sleeve having a rectangular cross-sectional shape, wind vents can be on all four surfaces, or wind vents can be on the two shorter parallel surfaces, or on the two longer parallel surfaces, or one of each, for example. In an aspect a disclosed sleeve having a square cross-sectional shape can comprise wind vents along all or a portion of the perimeter. In an aspect, in a disclosed sleeve having a square cross-sectional shape, wind vents can be on all four surfaces, or on two parallel surfaces. In an aspect, a disclosed sleeve having a circular cross-sectional shape can comprise wind vents along all or a portion of the perimeter.

In an aspect, about 1% to about 50% of a disclosed sleeve can comprise wind vents. For example, in an aspect, about 1% to about 25% of the upper portion of a disclosed sleeve can comprise wind vents. For example, in an aspect, about 5%, about 10%, about 15%, about 20%, or about 25% of the upper portion of a disclosed sleeve can comprise wind vents. In an aspect, a disclosed sleeve can be devoid of wind vents.

In an aspect, the upper portion of a disclosed sleeve for a survey stake can comprise a flag or string or ribbon or the like. In an aspect, a disclosed flag, string, ribbon, or the like can be weather resistant and durable. In an aspect, a disclosed flag, string, ribbon, or the like can comprise a fluorescent or neon coloring. In an aspect, a disclosed flag, string, ribbon, or the like can comprise reflective material. In an aspect, a flag, string, ribbon, or the like can serve to improve visibility of a disclosed sleeve for a survey stake.

In an aspect, a disclosed sleeve for a survey stake can comprise a plastic. In an aspect, a disclosed sleeve for a survey stake can comprise a combination of one or more plastics. In an aspect, a disclosed sleeve can comprise a plastic composite. Plastics are diverse. The art is familiar with plastics, which include, but are not limited to, acrylic or polymethyl methacrylate (PMMA), acrylonitrile-butadiene-styrene (ABS), high density polyethylene (PE), low density polyethylene (PE), polyamide (PA), polycarbonate (PC), polyetherimide, polyethylene (PE), polyethylene terephthalate (PETE or PET), polyoxymethylene (POM), polyphenylene sulfide (PPS), polypropylene (PP), polystyrene (PS), polyurethane (PUR), polyvinyl chloride (PVC), polyvinylidene fluoride (PVDF), and combinations thereof. In an aspect, for example, acrylic polymer can be prepared from monomers including but not limited to methyl acrylate, acrylic acid, methacrylic acid, methyl methacrylate, butyl methacrylate, cyclohexyl methacrylate as well as combinations thereof. In an aspect, substituted acrylates and methacrylates such as hydroxyethyl acrylate, hydroxybutyl acrylate, 2-ethylhexyl acrylate, and n-butyl acrylate can also be used. In an aspect, polyesters can be obtained, for example, by reacting an organic polycarboxylic acid with an organic polyol containing primary or secondary hydroxyl groups (e.g., ethylene glycol, butylene glycol, neopentyl glycol, and cyclohexane dimethanol) such as phthalic acid, hexahydrophthalic acid, adipic acid, maleic acid, terephthalic acid, isophthalic acid, sebacic acid, dodecanedioic acid, etc., or anhydrides thereof. In an aspect, polyurethanes can be used to make a disclosed sleeve. Polyurethanes can be prepared by the reaction of polyisocyanates with polyols, polyamines, or water. Examples of polyisocyanates include hexamethylene diisocyanate, toluene diisocyanate, diphenylmethane diisocyanate (MDI), isophorone diisocyanate, and biuret and thiocyanurate of these diisocyanates. Examples of polyols can include but are not limited to low molecular weight aliphatic polyols, polyester polyols, polyether polyols, fatty alcohols and the like. Examples of other materials from which a disclosed sleeve can be made include but are not limited to acrylonitrile-butadiene-styrene, VALOX™ (polybutylene phthalate, commercially available from SABIC's Innovative Plastics), and XENOY™ (LEXAN™ and VALOX™ Blend, commercially available from SABIC's Innovative Plastics).

In an aspect, plastics include thermoplastics, which are softened by heat and can be molded (e.g., injection molded, blow molded, vacuum formed, etc.). Thermoplastics include, but are not limited to, the following: acrylic, polypropylene, polystyrene, polythene, and PVC. Plastics include thermosets, which are formed by a heat process but are then set (for example, like concrete) and cannot change shape by reheating. Thermosets include, but are not limited to, the following: melamine (e.g., kitchen worktops), bakelite (e.g., black saucepan handles), polyester, and epoxy resins.

In an aspect, a disclosed sleeve for a survey stake can comprise butyrate, a butyrate composite, or a butyrate comprising composition. A disclosed sleeve comprising butyrate (cellulose acetate butyrate) will be transparent and rigid with excellent dimensional stability and high impact strength.

In an aspect, a plastic or plastic composite may also contain additives such as one or more colorants, one or more release agent, one or more antioxidant, one or more surfactant, plasticizer, one or more infrared absorber, one or more antistatic agent, one or more dispersant, one or more compatibilizer, one or more ultraviolet absorber, and combinations thereof. In an aspect, a disclosed sleeve for a survey stake can be resistant to ultraviolet (UV) light, tolerant of ultraviolet (UV) light, ultraviolet (UV) light stable, or a combination thereof. For example, in an aspect, a disclosed sleeve comprising acrylic, polymethyl methacrylate (PMMA), PVDF, PTFE, a combination thereof, or a composite thereof can be UV resistant, UV tolerant, UV stable, or a combination thereof. In an aspect, the inherent UV resistance of a plastic used for a disclosed sleeve for a survey stake can be improved or enhanced by adding UV stabilizers or UV resistant caps to protect the base polymer. For example, UV stabilizers can be added to a polymer to inhibit one or more photoinitiation processes. UV Stabilizers include ultraviolet absorbers, quenchers, and hindered amine light stabilizers (HALS). Absorbers, quenchers, and HALS are three types of UV stabilizers function by different mechanisms, one or more of them can be combined to create a synergistic effect. In an aspect, for example, benzotriazoles can be combined with HALS to protect pigmented systems from fading and color changes. In an aspect, a composite can comprise a combination of one or more plastics and one or more non-plastic materials. In an aspect, a composite can demonstrate enhanced properties (such as, for example, enhanced physical and mechanical properties).

In an aspect, a disclosed sleeve for a survey stake can comprise a weather-resistant layer (e.g., a coating). A weather-resistant layer can be applied in various ways, including dipping the plastic substrate at room temperature and atmospheric pressure into the coating solution (i.e., dip coating). weather-resistant layer can also be applied by other methods including, but not limited to, flow coating, curtain coating, and spray coating. A weather-resistant layer can comprise silicon (e.g., silicone hard coat), polyurethane (e.g., polyurethane acrylate), acrylic, polyacrylate (e.g., polymethacrylate, polymethylmethacrylate), polyvinylidene fluoride, esters, epoxides, or combinations thereof. A weather-resistant layer can also comprise one or more ultraviolet absorbing molecules (e.g., hydroxyphenyltazine, hydroxybenzophenone, hydroxylphenylbenzotazol, hydroxyphenyltriazine, polyarylresorcinol, and cyanoacrylate, or a combination thereof). In an aspect, for example, a weather-resistant layer can comprise a silicone hard coat layer (AS4000 or AS4700, commercially available from Momentive Performance Materials). In an aspect, a weathering layer can include a primer layer and a coating (e.g., a topcoat). A primer layer can help with adherence to the sleeve. A primer layer can include, but is not limited to, acrylic, polyester, epoxide, and combinations thereof. A primer layer can contain an ultraviolet absorber in addition to or instead of being present in the top coat of the weathering layer. For example, in an aspect, a primer layer can comprise an acrylic primer (SHP401 or SHP470, commercially available from Momentive Performance Materials).

In an aspect, a disclosed sleeve for a survey stake can comprise one or more abrasion resistant layer (e.g., a coating or a plasma coating). An abrasion resistant layer can comprise a single layer or multiple layers, and can enhance functionality by improving the abrasion resistance of the glaze. For example, in an aspect, an abrasion resistant layer on a disclosed sleeve can be comprise aluminum oxide, barium fluoride, boron nitride, hafnium oxide, lanthanum fluoride, magnesium fluoride, magnesium oxide, scandium oxide, silicon monoxide, silicon dioxide, silicon oxide, zirconium oxide, zinc oxide, zinc oxide, zinc oxide, zinc sulfide, zirconium oxide, zirconium titanate, zirconium titanate, zirconium titanate, zirconium titanate, zirconium titanate, zirconium titanate, organic coatings, inorganic coatings, and combinations thereof.

In an aspect, a weather-resistant layer can be applied by various deposition techniques such as a vacuum assisted deposition process and an atmospheric coating process. For example, in an aspect, a vacuum assisted deposition processes can include plasma enhanced chemical vapor deposition (PECVD), arc-PECVD, expanding thermal plasma PECVD (PECVD), ion assisted plasma deposition, magnetron sputtering but are not limited to, sputtering, electron beam evaporation, and ion beam sputtering, while atmospheric pressure coating processes can include curtain coating, spray coating, but are not limited to, spin coating, dip coating, and flow coating.

In an aspect, disclosed layer can comprise one or more antioxidants, one or more flow additives, one or more dispersants, one or more antioxidants, one or more surfactants, one or more plasticizers, one or more infrared absorbers, one or more compatibilizing agents, one or more curing catalysts, one or more ultraviolet absorber, and combinations thereof. The skilled person in the art can optimize the amount of each of the aforementioned additives based on desired characteristics and performance of a disclosed sleeve.

In an aspect, a disclosed sleeve for a survey stake can be formed in various ways well known to the art including, but not limited to, injection molding, extrusion, cold forming, vacuum forming, extrusion molding, transfer molding, thermal forming, and the like.

### 4. Sleeves for an Electrical Conduit

Disclosed herein are sleeves for an electrical conduit. Disclosed herein is a sleeve for placement on an electrical conduit, comprising an elongate body comprising an upper portion and a lower portion, wherein each portion of the elongate body comprises an open end, wherein the upper portion comprises a reflective material, and wherein the lower portion directly contacts an electrical conduit. Disclosed herein is a sleeve for placement on an electrical conduit, comprising an elongate body comprising an upper portion and a lower portion, wherein the upper portion of elongate body comprises a closed end and wherein the lower portion of the elongate body comprises an open end, wherein the upper portion comprises a reflective material, and wherein the lower portion directly contacts an electrical conduit. Disclosed herein is a sleeve for placement on an electrical conduit, comprising an elongate body comprising an upper portion and a lower portion, wherein each portion of the elongate body comprises an open end, wherein the upper portion comprises a reflective material and one or more wind vents, and wherein the lower portion directly contacts an electrical conduit. Disclosed herein is a sleeve for placement on an electrical conduit, comprising an elongate body comprising an upper portion and a lower portion, wherein the upper portion of elongate body comprises a closed end and wherein the lower portion of the elongate body comprises an open end, wherein the upper portion comprises a reflective material and one or more wind vents, and wherein the lower portion directly contacts an electrical conduit.

FIG. 1C shows an exemplary disclosed sleeve (4) positioned on the exposed aspect of a vertical protrusion or a conduit (such as an electrical conduit) (1). The lower portion of the exemplary disclosed sleeve directly contacts the exposed aspect (1) of the vertical protrusion or the conduit (such as an electrical conduit). The unexposed or nonexposed aspect (3) of the vertical protrusion or the conduit (such as an electrical conduit) is below the surface of the ground or floor or other surface (2). The disclosed sleeve comprises an upper portion and a lower portion, which is indicated (for convenience only) by a dotted line (8). The upper portion comprises reflective material (6) and one or more wind vents (5). The end (7) of the upper portion of the disclosed sleeve can either be opened or closed. In an aspect, the upper portion of a disclosed sleeve can comprise a cap (see, e.g., FIG. 5).

In an aspect, a disclosed sleeve for an electrical conduit n can be one piece having no seam. In an aspect, a disclosed sleeve for an electrical conduit can be one piece having a connectable or closeable seam along part of or the whole length of the sleeve. In an aspect, a disclosed sleeve for an electrical conduit can be one piece having an open seam along part of or the whole length of the sleeve.

In an aspect, an electrical conduit can comprise a tube or trough for protecting electrical wiring. In an aspect, an electrical conduit can be a rigid metal conduit, an intermediate metal conduit, an electrical metallic tubing, an electrical non-metallic tubing, a flexible metal conduit, a liquid-tight flexible metal conduit, or a rigid polyvinyl chloride conduit.

In an aspect, a disclosed sleeve is reusable. Reusable means that a disclosed sleeve is capable of being used again or repeatedly.

In an aspect, a disclosed sleeve can be positioned on the exposed aspect of an electrical conduit. In an aspect, the term “positioned on” can mean that the inside of a disclosed sleeve can directly contact the exposed electrical conduit. For example, a disclosed sleeve can fit over and around an exposed electrical conduit. In an aspect, the term “exposed” can refer to that aspect of an electrical conduit that extends from the surface of the ground or the earth, or the surface of a floor or wall or ceiling or roof, or the surface of a construction site, or the like. The non-exposed or unexposed aspect of an electrical conduit is that aspect that is below the surface of the ground or the earth, or the surface of a floor or wall or ceiling or roof, or the surface of construction site, or the like. In an aspect, a disclosed sleeve can directly contact about 12″ to about 60″ or about 24″ to about 48″ of an exposed electrical conduit. In an aspect, a disclosed sleeve can directly contact about 24″, about 36″, or about 48″ of an exposed electrical conduit.

In an aspect, a disclosed sleeve for an electrical conduit can comprise a circular cross-sectional shape. FIG. 2C is a cross-sectional view showing a disclosed sleeve (solid border) positioned on a protrusion or a conduit (such as an electrical conduit) having a circular cross-sectional shape (hatched).

In an aspect, a disclosed sleeve comprising a circular cross-sectional shape can be about ¾″ to about 6″ in diameter. In an aspect, a disclosed sleeve comprising a circular cross-sectional shape can be about ¾″ in diameter, about ½″ in diameter, about ¾″ in diameter, about 1″ in diameter, about 1¾″ in diameter, about 1½″ in diameter, about 1¾″ in diameter, about 2″ in diameter, about 2¾″ in diameter, about 2½″ in diameter about 2¾″ in diameter, about 3″ in diameter, about 3¼″ in diameter, about 3½″ in diameter, about 3¾″ in diameter, about 4″ in diameter, about 4V in diameter, about 4½″ in diameter, about 4¾″ in diameter, about 5″ in diameter, about 5V in diameter, about 5½″ in diameter, about 5¾″ in diameter, or about 6″ in diameter. In an aspect, a disclosed sleeve comprising a circular cross-sectional shape can be about ½″ in diameter, about 1″ in diameter, about 2″ in diameter, about 3″ in diameter, about 4″ in diameter, about 5″ in diameter, or about 6″ in diameter. In an aspect, for a disclosed sleeve comprising a circular cross-sectional shape can accommodate the size of an electrical conduit also having a circular cross-sectional shape. For example, if an exposed electrical conduit is about 2″ in diameter, then the disclosed sleeve is at least 2″ in diameter. For example, if an exposed electrical conduit is about 4″ in diameter, then the disclosed sleeve is at least 4″ in diameter. In an aspect, a disclosed sleeve can be about 1.5″ in diameter.

Several factors contribute to the determination of the most appropriate length of a disclosed sleeve for an electrical conduit. For example, the need for visibility of an electrical conduit in the surrounding environment (e.g., an active or inactive construction zone or site, a wooded area, a grassy area, etc.), weather conditions (e.g., rain, sleet, snow, fog, smoke, haze, etc.), the amount of exposed electrical conduit, the purpose of the electrical conduit, the type of equipment employed in the surrounding environment (e.g., tractors, harvesting machines, dump trucks, cement trucks, excavation equipment, utility trucks, and other heavy machinery). In an aspect, a disclosed sleeve for an electrical conduit can be about 24″ to about 72″ in length, or about 48″ to about 60″ in length, or about 24″, or about 30″, or about 36″, or about 42″, or about 48″, or about 54″, or about 60″, or about 66″, or about 72″ in length. In an aspect, a disclosed sleeve can about 54″ in length.

Several factors contribute to the determination of the most appropriate wall thickness of a disclosed sleeve for an electrical conduit. For example, a disclosed sleeve can have a wall thick enough to confer durability onto the disclosed sleeve. In an aspect, for example, a disclosed sleeve can have wall thick enough to ensure that the sleeve is reusable or that it can be used repeatedly. In an aspect, a disclosed sleeve can have a wall thickness of about 0.01″ to about 0.1″. In an aspect, a disclosed sleeve can have a wall thickness of about 0.04″.

In an aspect, a wall of a disclosed sleeve comprising a square or rectangular cross-sectional shape can have a thickness of about 0.01″ to about 0.1″. In an aspect, a disclosed sleeve can have a wall thickness of about 0.04″. In an aspect, a wall of a disclosed sleeve comprising a circular cross-sectional shape can have a thickness of about 1/16″ to about ⅞″. In an aspect, a wall of a disclosed sleeve comprising a circular cross-sectional shape can have a thickness of about 3/16″ or about 1/10″. In an aspect, a wall of a disclosed sleeve comprising a circular cross-sectional shape can have a thickness of about 10 mil to about 300 mil. In an aspect, a wall of a disclosed sleeve comprising a circular cross-sectional shape can have a thickness of about 10 mil to about 30 mil, about 30 mil to about 50 mil, about 50 mil to about 70 mil, about 70 mil to about 90 mil, about 90 mil to about 110 mil, about 110 mil to about 130 mil, about 130 mil to about 150 mil, about 150 mil to about 170 mil, about 170 mil to about 190 mil, about 190 mil to about 210 mil, about 210 mil to about 230 mil, about 230 mil to about 250 mil, about 250 mil to about 270 mil, or about 270 mil to about 300 mil. In an aspect, a wall of a disclosed sleeve comprising a circular cross-sectional shape can have a thickness of about 30 mil, about 40 mil, about 50 mil, about 60 mil, about 70 mil, about 80 mil, about 90, or about 100 mil. In an aspect, a disclosed sleeve comprising a circular cross-sectional shape can have a thickness of about 40 mil.

In an aspect, the lower portion of a disclosed sleeve can be in direct contact with an exposed electrical conduit. In an aspect, for example, a disclosed sleeve can fit over and around an exposed electrical conduit, whereby the lower portion of the sleeve physically contacts the exposed electrical conduit. In an aspect, the physical contact can be direct physical contact. In an aspect, a disclosed sleeve can envelop the exposed aspect of an exposed electrical conduit. In an aspect, the lower portion of a disclosed sleeve can be in direct contact with the entire length of the exposed electrical conduit.

In an aspect, the lower portion of a disclosed sleeve directly can be in direct contact with about 12″ to about 72″, or about 12″ to about 60″, or about 12″ to about 48″, or about 12″ to about 36″, or about 12″ to about 24″ of the exposed electrical conduit. In an aspect, the lower portion of a disclosed sleeve directly can be in direct contact with about 12″ to about 24″, or about 24″ to about 36″, or about 36″ to about 48″, or about 48″ to about 60″, or about 60″ to about 72″ of the exposed electrical conduit.

In an aspect, the upper portion of a disclosed sleeve for an electrical conduit can comprise about 6″ to about 24″, about 12″ to about 18″, or about 14″ to about 16″ of reflective material. In an aspect, the upper portion of a disclosed sleeve can comprise about 6″, about 7″, about 8″, about 9″, about 10″, about 11″ “ ” “ ” “ ” “ ” “, about 12, about 13, about 14, about 15, about 16, about 17, about 18, about 19, about 20, about 21”, about 22″, about 23″, or about 24″ of reflective material. In an aspect, the upper portion of a disclosed sleeve can comprise about 15″ of reflective material. In an aspect, about 10% to about 40%, or about 10% to about 15%, or about 15% to about 20%, or about 20% to about 25%, or about 25% to about 30%, or about 30% to about 35%, or about 35% to about 40% of the upper portion of a disclosed sleeve can comprise reflective material. In an aspect, about 10%, about 15%, about 20%, about 25%, about 30%, about 35%, or about 40% of the upper portion of a disclosed sleeve can comprise reflective material.

In an aspect, a disclosed sleeve can comprise about 48″ in length and the upper portion of a disclosed sleeve can comprise about 6″ to about 24″ of reflective material. In an aspect, a disclosed sleeve can comprise about 48″ in length and the upper portion of a disclosed sleeve can comprise about 12″ of reflective material, or about 15″ of reflective material, or about 18″ of reflective material, or about 21″ of reflective material, or about 24″ of reflective material. In an aspect, a disclosed sleeve can comprise about 60″ in length and the upper portion of a disclosed sleeve can comprise about 8″ to about 24″ of reflective material. In an aspect, a disclosed sleeve can comprise about 60″ in length and the upper portion of a disclosed sleeve can comprise about 12″ of reflective material, or about 15″ of reflective material, or about 18″ of reflective material, or about 21″ of reflective material, or about 24″ of reflective material. In an aspect, a disclosed sleeve can comprise about 54″ in length and the upper portion of a disclosed sleeve can comprise about 6″ to about 24″ of reflective material. In an aspect, a disclosed sleeve can comprise about 54″ in length and the upper portion of a disclosed sleeve can comprise about 12″ of reflective material, or about 15″ of reflective material, or about 18″ of reflective material, or about 21″ of reflective material, or about 24″ of reflective material.

In an aspect, a disclosed sleeve can comprise about 54″ in length and the upper portion of a disclosed sleeve can comprise about 3″, about 4″ about 5″, about 6″, about 7″, about 8″, about 9″, or about 10″ to about 24″ of reflective material. In an aspect, a disclosed sleeve can comprise about 54″ in length and the upper portion of a disclosed sleeve can comprise about 8″ of reflective material, about 12″ of reflective material, or about 15″ of reflective material, or about 18″ of reflective material, or about 21″ of reflective material, or about 24″ of reflective material.

In an aspect, reflective material can be continuously or discontinuously applied on the upper portion of a disclosed sleeve. In an aspect, the upper portion of a disclosed sleeve can comprise reflective material applied in a continuous manner or in a discontinuous manner. In an aspect, continuous can mean having an unbroken whole, without interruption, constant, continual, and/or unbroken. In an aspect, discontinuous can mean having intervals or gaps, sporadic, interrupted, patterned, and/or intermittent. In an aspect, the upper portion of a disclosed sleeve can comprise reflective material applied in a continuous manner, such as, for example, a block of reflective material. In an aspect, a block of reflective material can comprise various thicknesses, such as, for example, a 2″ block, a 3″ block, a 4″ block, a 5″ block, a 6″ block, a 9″ block, a 12″ block, a 15″ block, an 18″ block, a 21″ block, or a 24″ block of reflective material. In an aspect, a block of reflective material can be about 2″ to about 24″ thick. In an aspect, the upper portion of a disclosed sleeve can comprise reflective material applied in a discontinuous manner, such as, for example, a series of stripes, bands, stars, dots, triangles, squares, rectangles, or any other shape, or combination of shapes, or combination of shapes and stripes.

For example, in an aspect, reflective material can comprise stripes or bands of reflective material. In an aspect, stripes or bands of reflective material can be horizontal stripes, vertical stripes, or diagonal stripes. FIG. 3B shows a disclosed sleeve for a protrusion or a conduit (such as an electrical conduit) having horizontal stripes or bands of reflective material while FIG. 3C shows a disclosed sleeve for a protrusion or a conduit (such as an electrical conduit) having vertical strips or bands of reflective material.

In an aspect, a disclosed sleeve can comprise one or more stripes or bands of reflective material. In an aspect, a disclosed sleeve can comprise about 1 strip to about 20 stripes or bands of reflective material. In an aspect, a disclosed sleeve can comprise 1, 2, 3, 4, 5, 6, 7, 8, 9, or 10 stripes or bands of reflective material. The skilled person recognizes that a disclosed sleeve can comprise any number of stripes or bands of reflective material so long as the number or stripes or bands sufficiently performs the role of the reflective material. In an aspect, a disclosed sleeve can comprise 3 strips or bands of reflective material.

In an aspect, each stripe or band of reflective material can be about 0.25″ to about 6″ in width. In an aspect, each stripe or band of reflective material can be about 0.5″, about 1″, about 1.5″, about 2.0″, about 2.5″, about 3″, about 3.5″, about 4.0″, about 4.5″, about 5.0″, about 5.5″, or about 6″ in width. In an aspect, each stripe or band of reflective material can be about 2″ in width. In an aspect, one or more stripes of reflective materials can be spaced apart by about 0.5″ to about 6″. In an aspect, each vertical stripe or band of reflective material can be about 2″ to about 36″ in length. In an aspect, each vertical stripe or band of reflective material can be about 2″, about 6″, about 9″, about 12″, about 15″, about 18″, about 21″, about 24″, about 27″, about 29″, about 32″, about 35″, or about 36″ length. In an aspect, a disclosed sleeve can comprise about 2″ to about 3″ strips or bands of reflective material.

In an aspect, each horizontal stripe or band can comprise the same width. In an aspect, each horizontal stripe or band can comprise a different width or a series of different width. In an aspect, it is not necessary for each horizontal stripe or band to be identical in width. In an aspect, each vertical stripe or band can comprise the same length. In an aspect, each vertical stripe or band can comprise a different length or a series of different lengths. In an aspect, it is not necessary for each vertical stripe or band to be identical in width or length. In an aspect, one or more stripes of reflective materials can be spaced apart by about 0.5″, about 1″, about 1.5″, about 2″, about 2.5″, about 3″, about 3.5″, about 4″, about 4.5″, about 5″, about 5.5″, or about 6″.

In an aspect, stripes or bands of reflective material can be spaced about 0.5″ to about 6″ from the open end of the upper portion of a disclosed sleeve. In an aspect, reflective material can be spaced about 0.5″, about 1″, about 1.5″, about 2″, about 2.5″, about 3″, about 3.5, about 4″, about 4.5″, about 5″, about 5.5″, or about 6″ from the open end of the upper portion of a disclosed sleeve.

In an aspect, a disclosed sleeve can comprise one or more horizontal stripes of reflective material, wherein the one or more stripes of a disclosed width can be spaced apart by a disclosed width, wherein the first of the one or more stripes can be spaced a disclosed width from the open end of the upper portion of a disclosed sleeve. For example, a first 2″ stripe of reflective material can be spaced about 3″ from the open end of a disclosed sleeve, which can be followed by 3″ without a reflective material, which can be followed by a second 2″ stripe of reflective material, which can be followed by 3″ without a reflective material, and which can be followed by a third 2″ stripe of reflective materials. The pattern can continue. In an aspect, for example, a first 1″ stripe of reflective material can be spaced about 3″ from the open end of a disclosed sleeve, which can be followed by 1″ without a reflective material, which can be followed by a second 1″ stripe of reflective material, which can be followed by 1″ without a reflective material, and which can be followed by a third 1″ stripe of reflective materials. The pattern can continue. In an aspect, a disclosed sleeve can comprise one or more stripes or bands of reflective material, wherein the one or more stripes or bands can be about 2″ in width, and wherein the one or more stripes or bands can be spaced apart by about 3″.

In an aspect, a disclosed sleeve can comprise one or more vertical stripes of reflective material, wherein the one or more stripes of a disclosed width can be spaced apart by a disclosed width, wherein the first of the one or more stripes can be spaced a disclosed width from the open end of the upper portion of a disclosed sleeve, wherein the stripes can be a disclosed length. In an aspect, a disclosed sleeve can comprise one or more vertical stripes of reflective material, wherein the one or more stripes can be about 1″ in width, wherein the one or more stripes can be spaced apart by about 2″, and wherein the top of each vertical stripe can be spaced about 3″ from the open end of the upper portion of a disclosed sleeve. For example, the top of each 0.5″ stripe or band of reflective material can be spaced about 3″ from the open end of a disclosed sleeve, and the 0.5″ stripes of reflective material are separated by 1″ without a reflective material, which vertical pattern of reflective and non-reflective material is repeated for the entire diameter of an electrical conduit. For example, the top of each 1″ stripe or band of reflective material can be spaced about 3″ from the open end of a disclosed sleeve, and the 1″ stripes or bands of reflective material are separated by 1″ without a reflective material, which vertical pattern of reflective and non-reflective material is repeated for the entire diameter of an electrical conduit.

In an aspect, reflective material can comprise a chevron pattern or a wavy pattern. FIG. 3A shows a disclosed sleeve for a protrusion or a conduit (such as an electrical conduit) having reflective material in a chevron pattern. In an aspect, reflective material can comprise a series of one or more dots, wherein the dots can be arranged in various patterns (e.g., rows, columns, waves, crosses, x's, etc.) or can be randomly placed. In an aspect, reflective material can comprise a series of one or more squares, rectangles, triangles, or a combination thereof, wherein the squares, rectangles, triangles, or the combination thereof can be arranged in various patterns (e.g., rows, columns, waves, crosses, x's, etc.) or can be randomly placed. In an aspect, reflective material can comprise a series of one or more known shapes, or a combination of known shapes, wherein the known shapes, or the combination thereof can be arranged in various patterns (e.g., rows, columns, waves, crosses, x's, etc.) or can be randomly placed.

In an aspect, reflective material can comprise reflective fabric, reflective films, reflective tape, reflective yarn, reflective trims, or a combination thereof. In an aspect, reflective material can be created with tiny spherical glass beads. In an aspect, reflective material can comprise any color such as, for example, red, orange, yellow, green, blue, purple, white, or can comprise multiple colors. In an aspect, reflective tape can be outdoor reflective tape.

In an aspect, a disclosed sleeve for a horizontal or angular protrusion can be devoid of wind vents. In an aspect, a disclosed sleeve for an electrical conduit can comprise 1 to 100 wind vents. As known to the art, wind vents can reduce the wind load on a disclosed sleeve. In an aspect, one or more wind vents can allow for wind and/or air to be safely vented through a disclosed sleeve. In an aspect, one or more vents can prolong the physical integrity, and therefore, usability of a disclosed sleeve. In an aspect, a wind vent can be positioned apart about 0.5″ to about 6″ on the upper portion of a disclosed sleeve. In an aspect, one or more wind vents can be positioned in a row. In an aspect, a wind vent can be positioned about 1″ to about 6″ from the open-end of a disclosed sleeve. In an aspect, one or more wind vents can be positions about 3″ from the open-end of a disclosed sleeve. Wind vents can be various shapes and sizes. For example, in an aspect, a wind vent can comprise a circular shape, a crescent-moon shape, an oblong shape, an egg shape, a rectangular shape, a square shape, a slit shape, or a combination thereof. FIG. 4A shows a disclosed sleeve for a protrusion or a conduit (such as an electrical conduit) having a series of crescent-moon shaped wind vents, FIG. 4B shows a disclosed sleeve for a protrusion or a conduit (such as an electrical conduit) having circular-shaped wind vents, and FIG. 4C shows a disclosed sleeve for a protrusion or a conduit (such as an electrical conduit) having slit-shaped wind vents.

Determining the desired number of wind vents can comprise several factors known to the skilled person in the art. For example, as known to the skilled person, wind vent can serve at least two purposes including venting wind around the disclosed sleeve and venting heat from inside and around the disclosed sleeve. In an aspect, a disclosed sleeve having a circular cross-sectional shape can comprise wind vents along all or a portion of the perimeter.

In an aspect, about 1% to about 50% of a disclosed sleeve can comprise wind vents. For example, in an aspect, about 1% to about 25% of the upper portion of a disclosed sleeve can comprise wind vents. For example, in an aspect, about 5%, about 10%, about 15%, about 20%, or about 25% of the upper portion of a disclosed sleeve can comprise wind vents. In an aspect, a disclosed sleeve can be devoid of wind vents.

In an aspect, the upper portion of a disclosed sleeve for an electrical conduit can comprise a flag or string or ribbon or the like. In an aspect, a disclosed flag, string, ribbon, or the like can be weather resistant and durable. In an aspect, a disclosed flag, string, ribbon, or the like can comprise a fluorescent or neon coloring. In an aspect, a disclosed flag, string, ribbon, or the like can comprise reflective material. In an aspect, a flag, string, ribbon, or the like can serve to improve visibility of a disclosed sleeve for an electrical conduit.

In an aspect, a disclosed sleeve for a an electrical conduit can comprise a plastic. In an aspect, a disclosed sleeve for an electrical conduit can comprise a combination of one or more plastics. In an aspect, a disclosed sleeve can comprise a plastic composite. Plastics are diverse. The art is familiar with plastics, which include, but are not limited to, acrylic or polymethyl methacrylate (PMMA), acrylonitrile-butadiene-styrene (ABS), high density polyethylene (PE), low density polyethylene (PE), polyamide (PA), polycarbonate (PC), polyetherimide, polyethylene (PE), polyethylene terephthalate (PETE or PET), polyoxymethylene (POM), polyphenylene sulfide (PPS), polypropylene (PP), polystyrene (PS), polyurethane (PUR), polyvinyl chloride (PVC), polyvinylidene fluoride (PVDF), and combinations thereof.

In an aspect, a disclosed sleeve for a horizontal or angular protrusion can comprise butyrate, a butyrate composite, or a butyrate comprising composition. A disclosed sleeve comprising butyrate (cellulose acetate butyrate) will be transparent and rigid with excellent dimensional stability and high impact strength.

In an aspect, for example, acrylic polymer can be prepared from monomers including but not limited to methyl acrylate, acrylic acid, methacrylic acid, methyl methacrylate, butyl methacrylate, cyclohexyl methacrylate as well as combinations thereof. In an aspect, substituted acrylates and methacrylates such as hydroxyethyl acrylate, hydroxybutyl acrylate, 2-ethylhexyl acrylate, and n-butyl acrylate can also be used. In an aspect, polyesters can be obtained, for example, by reacting an organic polycarboxylic acid with an organic polyol containing primary or secondary hydroxyl groups (e.g., ethylene glycol, butylene glycol, neopentyl glycol, and cyclohexane dimethanol) such as phthalic acid, hexahydrophthalic acid, adipic acid, maleic acid, terephthalic acid, isophthalic acid, sebacic acid, dodecanedioic acid, etc., or anhydrides thereof. In an aspect, polyurethanes can be used to make a disclosed sleeve. Polyurethanes can be prepared by the reaction of polyisocyanates with polyols, polyamines, or water. Examples of polyisocyanates include hexamethylene diisocyanate, toluene diisocyanate, diphenylmethane diisocyanate (MDI), isophorone diisocyanate, and biuret and thiocyanurate of these diisocyanates. Examples of polyols can include but are not limited to low molecular weight aliphatic polyols, polyester polyols, polyether polyols, fatty alcohols and the like. Examples of other materials from which a disclosed sleeve can be made include but are not limited to acrylonitrile-butadiene-styrene, VALOX™ (polybutylene phthalate, commercially available from SABIC's Innovative Plastics), and XENOY™ (LEXAN™ and VALOX™ Blend, commercially available from SABIC's Innovative Plastics).

In an aspect, plastics include thermoplastics, which are softened by heat and can be molded (e.g., injection molded, blow molded, vacuum formed, etc.). Thermoplastics include, but are not limited to, the following: acrylic, polypropylene, polystyrene, polythene, and PVC. Plastics include thermosets, which are formed by a heat process but are then set (for example, like concrete) and cannot change shape by reheating. Thermosets include, but are not limited to, the following: melamine (e.g., kitchen worktops), bakelite (e.g., black saucepan handles), polyester, and epoxy resins.

In an aspect, a plastic or plastic composite may also contain additives such as one or more colorants, one or more release agent, one or more antioxidant, one or more surfactant, plasticizer, one or more infrared absorber, one or more antistatic agent, one or more dispersant, one or more compatibilizer, one or more ultraviolet absorber, and combinations thereof.

In an aspect, a disclosed sleeve for an electrical conduit can be resistant to ultraviolet (UV) light, tolerant of ultraviolet (UV) light, ultraviolet (UV) light stable, or a combination thereof. For example, in an aspect, a disclosed sleeve comprising acrylic, polymethyl methacrylate (PMMA), PVDF, PTFE, a combination thereof, or a composite thereof can be UV resistant, UV tolerant, UV stable, or a combination thereof. In an aspect, the inherent UV resistance of a plastic used for a disclosed sleeve for an electrical conduit can be improved or enhanced by adding UV stabilizers or UV resistant caps to protect the base polymer. For example, UV stabilizers can be added to a polymer to inhibit one or more photoinitiation processes. UV Stabilizers include ultraviolet absorbers, quenchers, and hindered amine light stabilizers (HALS). Absorbers, quenchers, and HALS are three types of UV stabilizers function by different mechanisms, one or more of them can be combined to create a synergistic effect. In an aspect, for example, benzotriazoles can be combined with HALS to protect pigmented systems from fading and color changes. In an aspect, a composite can comprise a combination of one or more plastics and one or more non-plastic materials. In an aspect, a composite can demonstrate enhanced properties (such as, for example, enhanced physical and mechanical properties).

In an aspect, a disclosed sleeve for an electrical conduit can comprise a weather-resistant layer (e.g., a coating). A weather-resistant layer can be applied in various ways, including dipping the plastic substrate at room temperature and atmospheric pressure into the coating solution (i.e., dip coating). weather-resistant layer can also be applied by other methods including, but not limited to, flow coating, curtain coating, and spray coating. A weather-resistant layer can comprise silicon (e.g., silicone hard coat), polyurethane (e.g., polyurethane acrylate), acrylic, polyacrylate (e.g., polymethacrylate, polymethylmethacrylate), polyvinylidene fluoride, esters, epoxides, or combinations thereof. A weather-resistant layer can also comprise one or more ultraviolet absorbing molecules (e.g., hydroxyphenyltazine, hydroxybenzophenone, hydroxylphenylbenzotazol, hydroxyphenyltriazine, polyarylresorcinol, and cyanoacrylate, or a combination thereof). In an aspect, for example, a weather-resistant layer can comprise a silicone hard coat layer (AS4000 or AS4700, commercially available from Momentive Performance Materials). In an aspect, a weathering layer can include a primer layer and a coating (e.g., a topcoat). A primer layer can help with adherence to the sleeve. A primer layer can include, but is not limited to, acrylic, polyester, epoxide, and combinations thereof. A primer layer can contain an ultraviolet absorber in addition to or instead of being present in the top coat of the weathering layer. For example, in an aspect, a primer layer can comprise an acrylic primer (SHP401 or SHP470, commercially available from Momentive Performance Materials).

In an aspect, a disclosed sleeve for an electrical conduit can comprise one or more abrasion resistant layer (e.g., a coating or a plasma coating). An abrasion resistant layer can comprise a single layer or multiple layers, and can enhance functionality by improving the abrasion resistance of the glaze. For example, in an aspect, an abrasion resistant layer on a disclosed sleeve can be comprise aluminum oxide, barium fluoride, boron nitride, hafnium oxide, lanthanum fluoride, magnesium fluoride, magnesium oxide, scandium oxide, silicon monoxide, silicon dioxide, silicon oxide, zirconium oxide, zinc oxide, zinc oxide, zinc oxide, zinc sulfide, zirconium oxide, zirconium titanate, zirconium titanate, zirconium titanate, zirconium titanate, zirconium titanate, zirconium titanate, organic coatings, inorganic coatings, and combinations thereof.

In an aspect, a weather-resistant layer can be applied by various deposition techniques such as a vacuum assisted deposition process and an atmospheric coating process. For example, in an aspect, a vacuum assisted deposition processes can include plasma enhanced chemical vapor deposition (PECVD), arc-PECVD, expanding thermal plasma PECVD (PECVD), ion assisted plasma deposition, magnetron sputtering but are not limited to, sputtering, electron beam evaporation, and ion beam sputtering, while atmospheric pressure coating processes can include curtain coating, spray coating, but are not limited to, spin coating, dip coating, and flow coating.

In an aspect, disclosed layer can comprise one or more antioxidants, one or more flow additives, one or more dispersants, one or more antioxidants, one or more surfactants, one or more plasticizers, one or more infrared absorbers, one or more compatibilizing agents, one or more curing catalysts, one or more ultraviolet absorber, and combinations thereof. The skilled person in the art can optimize the amount of each of the aforementioned additives based on desired characteristics and performance of a disclosed sleeve.

In an aspect, a disclosed sleeve for an electrical conduit can be formed in various ways well known to the art including, but not limited to, injection molding, extrusion, cold forming, vacuum forming, extrusion molding, transfer molding, thermal forming, and the like.

### 5. Sleeves for a Liquid Conduit

Disclosed herein are sleeves for a liquid conduit. Disclosed herein is a sleeve for placement on a liquid conduit, comprising an elongate body comprising an upper portion and a lower portion, wherein each portion of the elongate body comprises an open end, wherein the upper portion comprises a reflective material, and wherein the lower portion directly contacts a liquid conduit. Disclosed herein is a sleeve for placement on a liquid conduit, comprising an elongate body comprising an upper portion and a lower portion, wherein the upper portion of elongate body comprises a closed end and wherein the lower portion of the elongate body comprises an open end, wherein the upper portion comprises a reflective material, and wherein the lower portion directly contacts a liquid conduit. Disclosed herein is a sleeve for placement on a liquid conduit, comprising an elongate body comprising an upper portion and a lower portion, wherein each portion of the elongate body comprises an open end, wherein the upper portion comprises a reflective material and one or more wind vents, and wherein the lower portion directly contacts a liquid conduit. Disclosed herein is a sleeve for placement on a liquid conduit, comprising an elongate body comprising an upper portion and a lower portion, wherein the upper portion of elongate body comprises a closed end and wherein the lower portion of the elongate body comprises an open end, wherein the upper portion comprises a reflective material and one or more wind vents, and wherein the lower portion directly contacts a liquid conduit.

FIG. 1C shows an exemplary disclosed sleeve (4) positioned on the exposed aspect of a vertical protrusion or a conduit (such as liquid conduit) (1). The lower portion of the exemplary disclosed sleeve directly contacts the exposed aspect (1) of the vertical protrusion or the conduit (such as liquid conduit). The unexposed or nonexposed aspect (3) of the vertical protrusion or the conduit (such as liquid conduit) is below the surface of the ground or floor or other surface (2). The disclosed sleeve comprises an upper portion and a lower portion, which is indicated (for convenience only) by a dotted line (8). The upper portion comprises reflective material (6) and one or more wind vents (5). The end (7) of the upper portion of the disclosed sleeve can either be opened or closed. In an aspect, the upper portion of a disclosed sleeve can comprise a cap (see, e.g., FIG. 5).

In an aspect, a disclosed sleeve for a liquid conduit can be one piece having no seam. In an aspect, a disclosed sleeve for a liquid conduit can be one piece having a connectable or closeable seam along part of or the whole length of the sleeve. In an aspect, a disclosed sleeve for a liquid conduit can be one piece having an open seam along part of or the whole length of the sleeve.

In an aspect, a liquid conduit can comprise a tube, pipe, or channel for conveying water or other fluid. In an aspect, a disclosed sleeve is reusable. Reusable means that a disclosed sleeve is capable of being used again or repeatedly.

In an aspect, a disclosed sleeve can be positioned on the exposed aspect of a liquid conduit. In an aspect, the term “positioned on” can mean that the inside of a disclosed sleeve can directly contact the exposed liquid conduit. For example, a disclosed sleeve can fit over and around an exposed liquid conduit. In an aspect, the term “exposed” can refer to that aspect of a liquid conduit that extends from the surface of the ground or the earth, or the surface of a floor or wall or ceiling or roof, or the surface of a construction site, or the like. The non-exposed or unexposed aspect of a liquid conduit is that aspect that is below the surface of the ground or the earth, or the surface of a floor or wall or ceiling or roof, or the surface of construction site, or the like. In an aspect, a disclosed sleeve can directly contact about 12″ to about 60″ or about 24″ to about 48″ of an exposed liquid conduit. In an aspect, a disclosed sleeve can directly contact about 24″, about 36″, or about 48″ of an exposed liquid conduit.

In an aspect, a disclosed sleeve for a liquid conduit can comprise a circular cross-sectional shape. FIG. 2C is a cross-sectional view showing a disclosed sleeve (solid border) positioned on a protrusion or a conduit (such as a liquid conduit) having a circular cross-sectional shape (hatched). In an aspect, a disclosed sleeve comprising a circular cross-sectional shape can be about ¾″ to about 6″ in diameter. In an aspect, a disclosed sleeve comprising a circular cross-sectional shape can be about ¾″ in diameter, about ½″ in diameter, about ¾″ in diameter, about 1″ in diameter, about 1¾″ in diameter, about 1½″ in diameter, about 1¾″ in diameter, about 2″ in diameter, about 2¼″ in diameter, about 2½″ in diameter about 2¾″ in diameter, about 3″ in diameter, about 3¼″ in diameter, about 3½″ in diameter, about 3¾″ in diameter, about 4″ in diameter, about 4V in diameter, about 4½″ in diameter, about 4¾″ in diameter, about 5″ in diameter, about 5V in diameter, about 5½″ in diameter, about 5¾″ in diameter, or about 6″ in diameter. In an aspect, a disclosed sleeve comprising a circular cross-sectional shape can be about ½″ in diameter, about 1″ in diameter, about 2″ in diameter, about 3″ in diameter, about 4″ in diameter, about 5″ in diameter, or about 6″ in diameter. In an aspect, for a disclosed sleeve comprising a circular cross-sectional shape can accommodate the size of liquid conduit also having a circular cross-sectional shape. For example, if an exposed liquid conduit is about 2″ in diameter, then the disclosed sleeve is at least 2″ in diameter. For example, if an exposed liquid conduit is about 4″ in diameter, then the disclosed sleeve is at least 4″ in diameter.

Several factors contribute to the determination of the most appropriate length of a disclosed sleeve for a liquid conduit. For example, the need for visibility of the liquid conduit in the surrounding environment (e.g., an active or inactive construction zone or site, a wooded area, a grassy area, etc.), weather conditions (e.g., rain, sleet, snow, fog, smoke, haze, etc.), the amount of exposed liquid conduit, the purpose of the liquid conduit, the type of equipment employed in the surrounding environment (e.g., tractors, harvesting machines, dump trucks, cement trucks, excavation equipment, utility trucks, and other heavy machinery). In an aspect, a disclosed sleeve for a liquid conduit can be about 24″ to about 72″ in length, or about 48″ to about 60″ in length, or about 24″, or about 30″, or about 36″, or about 42″, or about 48″, or about 54″, or about 60″, or about 66″, or about 72″ in length.

Several factors contribute to the determination of the most appropriate wall thickness of a disclosed sleeve for a liquid conduit. For example, a disclosed sleeve can have a wall thick enough to confer durability onto the disclosed sleeve. In an aspect, for example, a disclosed sleeve can have wall thick enough to ensure that the sleeve is reusable or that it can be used repeatedly. In an aspect, a wall of a disclosed sleeve comprising a circular cross-sectional shape can have a thickness of about 1/16″ to about ⅞″. In an aspect, a wall of a disclosed sleeve comprising a circular cross-sectional shape can have a thickness of about 3/16″ or about 1/10″. In an aspect, a wall of a disclosed sleeve comprising a circular cross-sectional shape can have a thickness of about 10 mil to about 300 mil. In an aspect, a wall of a disclosed sleeve comprising a circular cross-sectional shape can have a thickness of about 10 mil to about 30 mil, about 30 mil to about 50 mil, about 50 mil to about 70 mil, about 70 mil to about 90 mil, about 90 mil to about 110 mil, about 110 mil to about 130 mil, about 130 mil to about 150 mil, about 150 mil to about 170 mil, about 170 mil to about 190 mil, about 190 mil to about 210 mil, about 210 mil to about 230 mil, about 230 mil to about 250 mil, about 250 mil to about 270 mil, or about 270 mil to about 300 mil. In an aspect, a wall of a disclosed sleeve comprising a circular cross-sectional shape can have a thickness of about 50 mil, about 60 mil, about 70 mil, about 80 mil, about 90, or about 100 mil.

In an aspect, the lower portion of a disclosed sleeve can be in direct contact with an exposed liquid conduit. In an aspect, for example, a disclosed sleeve can fit over and around an exposed liquid conduit, whereby the lower portion of the sleeve physically contacts the exposed liquid conduit. In an aspect, the physical contact can be direct physical contact. In an aspect, a disclosed sleeve can envelop the exposed aspect of a liquid conduit. In an aspect, the lower portion of a disclosed sleeve can be in direct contact with the entire length of the exposed liquid conduit.

In an aspect, the lower portion of a disclosed sleeve directly can be in direct contact with about 12″ to about 72″, or about 12″ to about 60″, or about 12″ to about 48″, or about 12″ to about 36″, or about 12″ to about 24″ of the exposed liquid conduit. In an aspect, the lower portion of a disclosed sleeve directly can be in direct contact with about 12″ to about 24″, or about 24″ to about 36″, or about 36″ to about 48″, or about 48″ to about 60″, or about 60″ to about 72″ of the exposed liquid conduit.

In an aspect, the upper portion of a disclosed sleeve for a liquid conduit can comprise about 6″ to about 24″, about 12″ to about 18″, or about 14″ to about 16″ of reflective material. In an aspect, the upper portion of a disclosed sleeve can comprise about 6″, about 7″, about 8″, about 9″, about 10″, about 11″ “ ” “ ” “ ” “ ” “, about 12, about 13, about 14, about 15, about 16, about 17, about 18, about 19, about 20, about 21”, about 22″, about 23″, or about 24″ of reflective material. In an aspect, the upper portion of a disclosed sleeve can comprise about 15″ of reflective material. In an aspect, about 10% to about 40%, or about 10% to about 15%, or about 15% to about 20%, or about 20% to about 25%, or about 25% to about 30%, or about 30% to about 35%, or about 35% to about 40% of the upper portion of a disclosed sleeve can comprise reflective material. In an aspect, about 10%, about 15%, about 20%, about 25%, about 30%, about 35%, or about 40% of the upper portion of a disclosed sleeve can comprise reflective material.

In an aspect, a disclosed sleeve for a liquid conduit can comprise about 48″ in length and the upper portion of a disclosed sleeve can comprise about 8″ to about 24″ of reflective material. In an aspect, a disclosed sleeve for a liquid conduit can comprise about 48″ in length and the upper portion of a disclosed sleeve can comprise about 12″ of reflective material, or about 15″ of reflective material, or about 18″ of reflective material, or about 21″ of reflective material, or about 24″ of reflective material. In an aspect, a disclosed sleeve for a liquid conduit can comprise about 60″ in length and the upper portion of a disclosed sleeve can comprise about 8″ to about 24″ of reflective material. In an aspect, a disclosed sleeve for a liquid conduit can comprise about 60″ in length and the upper portion of a disclosed sleeve can comprise about 12″ of reflective material, or about 15″ of reflective material, or about 18″ of reflective material, or about 21″ of reflective material, or about 24″ of reflective material.

In an aspect, reflective material can be continuously or discontinuously applied on the upper portion of a disclosed sleeve. In an aspect, the upper portion of a disclosed sleeve can comprise reflective material applied in a continuous manner or in a discontinuous manner. In an aspect, continuous can mean having an unbroken whole, without interruption, constant, continual, and/or unbroken. In an aspect, discontinuous can mean having intervals or gaps, sporadic, interrupted, patterned, and/or intermittent. In an aspect, the upper portion of a disclosed sleeve can comprise reflective material applied in a continuous manner, such as, for example, a block of reflective material. In an aspect, a block of reflective material can comprise various thicknesses, such as, for example, a 6″ block, a 9″ block, a 12″ block, a 15″ block, an 18″ block, a 21″ block, or a 24″ block of reflective material. In an aspect, a block of reflective material can be about 6″ to about 24″ thick. In an aspect, the upper portion of a disclosed sleeve can comprise reflective material applied in a discontinuous manner, such as, for example, a series of stripes, bands, stars, dots, triangles, squares, rectangles, or any other shape, or combination of shapes, or combination of shapes and stripes.

For example, in an aspect, reflective material can comprise stripes or bands of reflective material. In an aspect, stripes or bands of reflective material can be horizontal stripes, vertical stripes, or diagonal stripes. FIG. 3B shows a disclosed sleeve for a protrusion or a conduit (such as an liquid conduit) having horizontal stripes or bands of reflective material while FIG. 3C shows a disclosed sleeve for a protrusion or a conduit (such as an liquid conduit) having vertical strips or bands of reflective material.

In an aspect, a disclosed sleeve can comprise one or more stripes or bands of reflective material. In an aspect, a disclosed sleeve can comprise about 1 to about 20 stripes or bands of reflective material. In an aspect, a disclosed sleeve can comprise 1, 2, 3, 4, 5, 6, 7, 8, 9, or 10 stripes or bands of reflective material. The skilled person recognizes that a disclosed sleeve can comprise any number of stripes or bands of reflective material so long as the number or stripes or bands sufficiently performs the role of the reflective material. In an aspect, each stripe or band of reflective material can be about 0.25″ to about 6″ in width. In an aspect, each stripe or band of reflective material can be about 0.5″, about 1″, about 1.5″, about 2.0″, about 2.5″, about 3″, about 3.5″, about 4.0″, about 4.5″, about 5.0″, about 5.5″, or about 6″ in width. In an aspect, each stripe or band of reflective material can be about 2″ in width. In an aspect, one or more stripes of reflective materials can be spaced apart by about 0.5″ to about 6″. In an aspect, each vertical stripe or band of reflective material can be about 3″ to about 36″ in length. In an aspect, each vertical stripe or band of reflective material can be about 3″, about 6″, about 9″, about 12″, about 15″, about 18″, about 21″, about 24″, about 27″, about 29″, about 32″, about 35″, or about 36″ length.

In an aspect, each horizontal stripe or band can comprise the same width. In an aspect, each horizontal stripe or band can comprise a different width or a series of different width. In an aspect, it is not necessary for each horizontal stripe or band to be identical in width. In an aspect, each vertical stripe or band can comprise the same length. In an aspect, each vertical stripe or band can comprise a different length or a series of different lengths. In an aspect, it is not necessary for each vertical stripe or band to be identical in width or length.

In an aspect, one or more stripes of reflective materials can be spaced apart by about 0.5″, about 1″, about 1.5″, about 2″, about 2.5″, about 3″, about 3.5″, about 4″, about 4.5″, about 5″ “or, about 5.5, about 6”. In an aspect, stripes or bands of reflective material can be spaced about 0.5″ to about 6″ from the open end of the upper portion of a disclosed sleeve. In an aspect, reflective material can be spaced about 0.5″, about 1″, about 1.5″, about 2″, about 2.5″, about 3″, about 3.5, about 4″, about 4.5″, about 5″, about 5.5″, or about 6″ from the open end of the upper portion of a disclosed sleeve.

In an aspect, a disclosed sleeve can comprise one or more horizontal stripes of reflective material, wherein the one or more stripes of a disclosed width can be spaced apart by a disclosed width, wherein the first of the one or more stripes can be spaced a disclosed width from the open end of the upper portion of a disclosed sleeve. For example, a first 2″ stripe of reflective material can be spaced about 3″ from the open end of a disclosed sleeve, which can be followed by 3″ without a reflective material, which can be followed by a second 2″ stripe of reflective material, which can be followed by 3″ without a reflective material, and which can be followed by a third 2″ stripe of reflective materials. The pattern can continue. In an aspect, for example, a first 1″ stripe of reflective material can be spaced about 3″ from the open end of a disclosed sleeve, which can be followed by 1″ without a reflective material, which can be followed by a second 1″ stripe of reflective material, which can be followed by 1″ without a reflective material, and which can be followed by a third 1″ stripe of reflective materials. The pattern can continue. In an aspect, a disclosed sleeve can comprise one or more stripes or bands of reflective material, wherein the one or more stripes or bands can be about 2″ in width, and wherein the one or more stripes or bands can be spaced apart by about 3″.

In an aspect, a disclosed sleeve can comprise one or more vertical stripes of reflective material, wherein the one or more stripes of a disclosed width can be spaced apart by a disclosed width, wherein the first of the one or more stripes can be spaced a disclosed width from the open end of the upper portion of a disclosed sleeve, wherein the stripes can be a disclosed length. In an aspect, a disclosed sleeve can comprise one or more vertical stripes of reflective material, wherein the one or more stripes can be about 1″ in width, wherein the one or more stripes can be spaced apart by about 2″, and wherein the top of each vertical stripe can be spaced about 3″ from the open end of the upper portion of a disclosed sleeve. For example, the top of each 0.5″ stripe or band of reflective material can be spaced about 3″ from the open end of a disclosed sleeve, and the 0.5″ stripes of reflective material are separated by 1″ without a reflective material, which vertical pattern of reflective and non-reflective material is repeated for the entire diameter of the vertical protrusion regardless of whether the protrusion is a survey stake, for example, or an electrical or liquid conduit, for example. For example, the top of each 1″ stripe or band of reflective material can be spaced about 3″ from the open end of a disclosed sleeve, and the 1″ stripes or bands of reflective material are separated by 1″ without a reflective material, which vertical pattern of reflective and non-reflective material is repeated for the entire diameter of the vertical protrusion regardless of whether the protrusion is a survey stake, for example, or an electrical or liquid conduit, for example.

In an aspect, reflective material can comprise a chevron pattern or a wavy pattern. FIG. 3A shows a disclosed sleeve for a protrusion or a conduit (such as an liquid conduit) having reflective material in a chevron pattern. In an aspect, reflective material can comprise a series of one or more dots, wherein the dots can be arranged in various patterns (e.g., rows, columns, waves, crosses, x's, etc.) or can be randomly placed. In an aspect, reflective material can comprise a series of one or more squares, rectangles, triangles, or a combination thereof, wherein the squares, rectangles, triangles, or the combination thereof can be arranged in various patterns (e.g., rows, columns, waves, crosses, x's, etc.) or can be randomly placed. In an aspect, reflective material can comprise a series of one or more known shapes, or a combination of known shapes, wherein the known shapes, or the combination thereof can be arranged in various patterns (e.g., rows, columns, waves, crosses, x's, etc.) or can be randomly placed.

In an aspect, reflective material can comprise reflective fabric, reflective films, reflective tape, reflective yarn, reflective trims, or a combination thereof. In an aspect, reflective material can be created with tiny spherical glass beads. In an aspect, reflective material can comprise any color such as, for example, red, orange, yellow, green, blue, purple, white, or can comprise multiple colors. In an aspect, reflective tape can be outdoor reflective tape.

In an aspect, a disclosed sleeve for a liquid conduit can comprise 1 to 100 wind vents. As known to the art, wind vents can reduce the wind load on a disclosed sleeve. In an aspect, one or more wind vents can allow for wind and/or air to be safely vented through a disclosed sleeve. In an aspect, one or more vents can prolong the physical integrity, and therefore, usability of a disclosed sleeve. In an aspect, a wind vent can be positioned apart about 0.5″ to about 6″ on the upper portion of a disclosed sleeve. In an aspect, one or more wind vents can be positioned in a row. In an aspect, a wind vent can be positioned about 1″ to about 6″ from the open-end of a disclosed sleeve. In an aspect, one or more wind vents can be positions about 3″ from the open-end of a disclosed sleeve. Wind vents can be various shapes and sizes. For example, in an aspect, a wind vent can comprise a circular shape, a crescent-moon shape, an oblong shape, an egg shape, a rectangular shape, a square shape, a slit shape, or a combination thereof. FIG. 4A shows a disclosed sleeve for a protrusion or a conduit (such as an liquid conduit) having a series of crescent-moon shaped wind vents, FIG. 4B shows a disclosed sleeve for a protrusion or a conduit (such as an liquid conduit) having circular-shaped wind vents, and FIG. 4C shows a disclosed sleeve for a protrusion or a conduit (such as an liquid conduit) having slit-shaped wind vents.

Determining the desired number of wind vents can comprise several factors known to the skilled person in the art. For example, as known to the skilled person, wind vent can serve at least two purposes including venting wind around the disclosed sleeve and venting heat from inside and around the disclosed sleeve. In an aspect, a disclosed sleeve having a circular cross-sectional shape can comprise wind vents along all or a portion of the perimeter. In an aspect, about 1% to about 50% of a disclosed sleeve can comprise wind vents. For example, in an aspect, about 1% to about 25% of the upper portion of a disclosed sleeve can comprise wind vents. For example, in an aspect, about 5%, about 10%, about 15%, about 20%, or about 25% of the upper portion of a disclosed sleeve can comprise wind vents.

In an aspect, the upper portion of a disclosed sleeve can comprise a flag or string or ribbon or the like. In an aspect, a disclosed flag, string, ribbon, or the like can be weather resistant and durable. In an aspect, a disclosed flag, string, ribbon, or the like can comprise a fluorescent or neon coloring. In an aspect, a disclosed flag, string, ribbon, or the like can comprise reflective material. In an aspect, a flag, string, ribbon, or the like can serve to improve visibility of a disclosed sleeve for a liquid conduit.

In an aspect, a disclosed sleeve for a liquid conduit can comprise a plastic. In an aspect, a disclosed sleeve for a liquid conduit can comprise a combination of one or more plastics. In an aspect, a disclosed sleeve can comprise a plastic composite. Plastics are diverse. The art is familiar with plastics, which include, but are not limited to, acrylic or polymethyl methacrylate (PMMA), acrylonitrile-butadiene-styrene (ABS), high density polyethylene (PE), low density polyethylene (PE), polyamide (PA), polycarbonate (PC), polyetherimide, polyethylene (PE), polyethylene terephthalate (PETE or PET), polyoxymethylene (POM), polyphenylene sulfide (PPS), polypropylene (PP), polystyrene (PS), polyurethane (PUR), polyvinyl chloride (PVC), polyvinylidene fluoride (PVDF), and combinations thereof.

In an aspect, for example, acrylic polymer can be prepared from monomers including but not limited to methyl acrylate, acrylic acid, methacrylic acid, methyl methacrylate, butyl methacrylate, cyclohexyl methacrylate as well as combinations thereof. In an aspect, substituted acrylates and methacrylates such as hydroxyethyl acrylate, hydroxybutyl acrylate, 2-ethylhexyl acrylate, and n-butyl acrylate can also be used. In an aspect, polyesters can be obtained, for example, by reacting an organic polycarboxylic acid with an organic polyol containing primary or secondary hydroxyl groups (e.g., ethylene glycol, butylene glycol, neopentyl glycol, and cyclohexane dimethanol) such as phthalic acid, hexahydrophthalic acid, adipic acid, maleic acid, terephthalic acid, isophthalic acid, sebacic acid, dodecanedioic acid, etc., or anhydrides thereof. In an aspect, polyurethanes can be used to make a disclosed sleeve. Polyurethanes can be prepared by the reaction of polyisocyanates with polyols, polyamines, or water. Examples of polyisocyanates include hexamethylene diisocyanate, toluene diisocyanate, diphenylmethane diisocyanate (MDI), isophorone diisocyanate, and biuret and thiocyanurate of these diisocyanates. Examples of polyols can include but are not limited to low molecular weight aliphatic polyols, polyester polyols, polyether polyols, fatty alcohols and the like. Examples of other materials from which a disclosed sleeve can be made include but are not limited to acrylonitrile-butadiene-styrene, VALOX™ (polybutylene phthalate, commercially available from SABIC's Innovative Plastics), and XENOY™ (LEXAN™ and VALOX™ Blend, commercially available from SABIC's Innovative Plastics).

In an aspect, plastics include thermoplastics, which are softened by heat and can be molded (e.g., injection molded, blow molded, vacuum formed, etc.). Thermoplastics include, but are not limited to, the following: acrylic, polypropylene, polystyrene, polythene, and PVC. Plastics include thermosets, which are formed by a heat process but are then set (for example, like concrete) and cannot change shape by reheating. Thermosets include, but are not limited to, the following: melamine (e.g., kitchen worktops), bakelite (e.g., black saucepan handles), polyester, and epoxy resins.

In an aspect, a plastic or plastic composite may also contain additives such as one or more colorants, one or more release agent, one or more antioxidant, one or more surfactant, plasticizer, one or more infrared absorber, one or more antistatic agent, one or more dispersant, one or more compatibilizer, one or more ultraviolet absorber, and combinations thereof.

In an aspect, a disclosed sleeve for a liquid conduit can be resistant to ultraviolet (UV) light, tolerant of ultraviolet (UV) light, ultraviolet (UV) light stable, or a combination thereof. For example, in an aspect, a disclosed sleeve comprising acrylic, polymethyl methacrylate (PMMA), PVDF, PTFE, a combination thereof, or a composite thereof can be UV resistant, UV tolerant, UV stable, or a combination thereof. In an aspect, the inherent UV resistance of a plastic used for a disclosed sleeve for a liquid conduit can be improved or enhanced by adding UV stabilizers or UV resistant caps to protect the base polymer. For example, UV stabilizers can be added to a polymer to inhibit one or more photoinitiation processes. UV Stabilizers include ultraviolet absorbers, quenchers, and hindered amine light stabilizers (HALS). Absorbers, quenchers, and HALS are three types of UV stabilizers function by different mechanisms, one or more of them can be combined to create a synergistic effect. In an aspect, for example, benzotriazoles can be combined with HALS to protect pigmented systems from fading and color changes. In an aspect, a composite can comprise a combination of one or more plastics and one or more non-plastic materials. In an aspect, a composite can demonstrate enhanced properties (such as, for example, enhanced physical and mechanical properties).

In an aspect, a disclosed sleeve for a liquid conduit can comprise a weather-resistant layer (e.g., a coating). A weather-resistant layer can be applied in various ways, including dipping the plastic substrate at room temperature and atmospheric pressure into the coating solution (i.e., dip coating). weather-resistant layer can also be applied by other methods including, but not limited to, flow coating, curtain coating, and spray coating. A weather-resistant layer can comprise silicon (e.g., silicone hard coat), polyurethane (e.g., polyurethane acrylate), acrylic, polyacrylate (e.g., polymethacrylate, polymethylmethacrylate), polyvinylidene fluoride, esters, epoxides, or combinations thereof. A weather-resistant layer can also comprise one or more ultraviolet absorbing molecules (e.g., hydroxyphenyltazine, hydroxybenzophenone, hydroxylphenylbenzotazol, hydroxyphenyltriazine, polyarylresorcinol, and cyanoacrylate, or a combination thereof). In an aspect, for example, a weather-resistant layer can comprise a silicone hard coat layer (AS4000 or AS4700, commercially available from Momentive Performance Materials). In an aspect, a weathering layer can include a primer layer and a coating (e.g., a topcoat). A primer layer can help with adherence to the sleeve. A primer layer can include, but is not limited to, acrylic, polyester, epoxide, and combinations thereof. A primer layer can contain an ultraviolet absorber in addition to or instead of being present in the top coat of the weathering layer. For example, in an aspect, a primer layer can comprise an acrylic primer (SHP401 or SHP470, commercially available from Momentive Performance Materials).

In an aspect, a disclosed sleeve for a liquid conduit can comprise one or more abrasion resistant layer (e.g., a coating or a plasma coating). An abrasion resistant layer can comprise a single layer or multiple layers, and can enhance functionality by improving the abrasion resistance of the glaze. For example, in an aspect, an abrasion resistant layer on a disclosed sleeve can be comprise aluminum oxide, barium fluoride, boron nitride, hafnium oxide, lanthanum fluoride, magnesium fluoride, magnesium oxide, scandium oxide, silicon monoxide, silicon dioxide, silicon oxide, zirconium oxide, zinc oxide, zinc oxide, zinc oxide, zinc sulfide, zirconium oxide, zirconium titanate, zirconium titanate, zirconium titanate, zirconium titanate, zirconium titanate, zirconium titanate, organic coatings, inorganic coatings, and combinations thereof.

In an aspect, a weather-resistant layer can be applied by various deposition techniques such as a vacuum assisted deposition process and an atmospheric coating process. For example, in an aspect, a vacuum assisted deposition processes can include plasma enhanced chemical vapor deposition (PECVD), arc-PECVD, expanding thermal plasma PECVD (PECVD), ion assisted plasma deposition, magnetron sputtering but are not limited to, sputtering, electron beam evaporation, and ion beam sputtering, while atmospheric pressure coating processes can include curtain coating, spray coating, but are not limited to, spin coating, dip coating, and flow coating.

In an aspect, disclosed layer can comprise one or more antioxidants, one or more flow additives, one or more dispersants, one or more antioxidants, one or more surfactants, one or more plasticizers, one or more infrared absorbers, one or more compatibilizing agents, one or more curing catalysts, one or more ultraviolet absorber, and combinations thereof. The skilled person in the art can optimize the amount of each of the aforementioned additives based on desired characteristics and performance of a disclosed sleeve.

In an aspect, a disclosed sleeve for a liquid conduit can be formed in various ways well known to the art including, but not limited to, injection molding, extrusion, cold forming, vacuum forming, extrusion molding, transfer molding, thermal forming, and the like.

### C. METHODS

### 1. Methods of Using

Disclosed herein are methods for using a disclosed sleeve for a vertical, horizontal, or angular protrusion or for an electrical conduit or a liquid conduit.

### A. Method of Using a Sleeve for a Horizontal or Angular Protrusion

Disclosed herein is a method comprising positioning a sleeve on an exposed aspect of a horizontal or angular protrusion. Disclosed herein is a method comprising identifying a horizontal or angular protrusion and positioning a sleeve on an exposed aspect of the horizontal or angular protrusion.

In an aspect, the term “positioned on” can mean that the inside of a disclosed sleeve can directly contact the exposed aspect of a horizontal or angular protrusion. For example, a disclosed sleeve can fit over and around the exposed aspect of a horizontal or angular protrusion. In an aspect, the term “exposed” can refer to that aspect of a horizontal or angular protrusion that extends from the surface of the ground or the earth, or the surface of a floor or wall or ceiling or roof, or the surface of a construction site, or the like. The non-exposed or unexposed aspect of a horizontal or angular protrusion is that aspect that is below the surface of the ground or the earth, or the surface of a floor or wall or ceiling or roof, or the surface of construction site, or the like.

In an aspect, a disclosed method can comprise identifying a horizontal or angular protrusion. In an aspect, identifying a horizontal or angular protrusion can comprise visually identifying the horizontal or angular protrusion in a given environment (such as, for example, an active or inactive construction zone or site, a wooded area, a grassy area, etc.). In an aspect, identifying a horizontal or angular protrusion can comprise using a map, a guide, a blueprint, a survey, a schematic, or a combination thereof to identify a previously placed horizontal or angular protrusion in a given environment.

In an aspect, positioning the sleeve can comprise fitting the sleeve over and around the exposed horizontal or angular protrusion. In an aspect, positioning the sleeve can ensure that the inside of the sleeve directly contacts the exposed horizontal or angular protrusion. In an aspect, positioning the sleeve can ensure that the disclosed sleeve can directly contact about 12″ to about 60″ or about 24″ to about 48″ of the exposed horizontal or angular protrusion. In an aspect, positioning the sleeve can ensure that the disclosed sleeve can directly contact about 12″, about 18″, about 24″, about 30″, about 36″, about 42″, or about 48″ of the exposed horizontal or angular protrusion.

In an aspect, a disclosed method can comprise identifying an appropriate sleeve for use with the exposed horizontal or angular protrusion. In an aspect, identifying an appropriate sleeve can comprise choosing a sleeve based on dimensions of the exposed horizontal or angular protrusion. In an aspect, a disclosed method can comprise determining the dimensions of the horizontal or angular protrusion. In an aspect, determining the dimensions of the exposed horizontal or angular protrusion can comprise measuring or ascertaining the height, width, length, radius, diameter, or a combination thereof of the horizontal or angular protrusion. Methods and techniques used to determine the dimensions of a horizontal or angular protrusion are well known to the art.

For example, in an aspect, a disclosed sleeve comprising a square or rectangular cross-sectional shape can comprise any width and any height so long as the disclosed sleeve can accommodate the size of the exposed horizontal or angular protrusion. For example, in an aspect, a disclosed sleeve comprising a circular cross-sectional shape can comprise any radius or diameter so long as the disclosed sleeve can accommodate the size of the exposed horizontal or angular protrusion.

In an aspect, a disclosed method can comprise removing the sleeve from the horizontal or angular protrusion. In an aspect, removing the sleeve can comprise allowing a period of time to elapse prior to removing the sleeve. In an aspect, a period of time can be the amount of time required for construction of a bridge, building, road, and other structures that surrounds, incorporates, or is nearby the horizontal or angular protrusion.

In an aspect, a disclosed method can comprise reusing the sleeve one or more times. In an aspect, a disclosed sleeve can be reused with the original horizontal or angular protrusion. In an aspect, a disclosed sleeve can be reused with a different horizontal or angular protrusion. In an aspect, a disclosed sleeve can be reused multiple times with the same horizontal or angular protrusion. In an aspect, a disclosed sleeve can be reused multiple times with a different horizontal or angular protrusion. In an aspect, a disclosed sleeve can be reused multiple times with the same horizontal or angular protrusion, a different horizontal or angular protrusion, or a combination thereof. For example, in an aspect, a disclosed sleeve can be used in connection with a first horizontal or angular protrusion, removed, reused with a second horizontal or angular protrusion, removed, and reused with a third horizontal or angular protrusion. In an aspect, a disclosed sleeve can be used in connection with a first horizontal or angular protrusion, removed, reused with a second horizontal or angular protrusion, removed, and then reused (or used again) with the horizontal or angular protrusion. Theoretically, a disclosed sleeve can be removed and reused multiple times so long as each horizontal or angular protrusion comprises about the same dimensions (e.g., about the same width and about the same height).

In an aspect, a disclosed method can comprise repairing the sleeve prior to reuse. For example, in an aspect, repairing the sleeve prior to reuse can comprise applying reflective material to the upper portion of the sleeve. In an aspect, the reflective material can be additional reflective material (i.e., added to reflective material already on the sleeve) or it can be new reflective material (i.e., added to a naked or bare sleeve). In an aspect, repairing the sleeve prior to reuse can comprise stripping or removing pre-existing reflective material and then adding new reflective material to the sleeve in the same pattern or new pattern (i.e., strips, bands, dots, etc.).

In an aspect, a disclosed method can comprise improving the visibility of the sleeve for a horizontal or angular protrusion. In an aspect, visibility of the sleeve can be improved during the construction of a bridge, a building, a road, or other structure. In an aspect, improving visibility of the sleeve can comprise improving the visibility of the sleeve to an operator of heavy machinery. Heavy machinery can include, but is not limited to, a backhoe, a wheel loader, a scraper, a dump truck, an excavator, a cement truck, a bulldozer, a road grader, a rock truck, a skid steer, and an all-terrain forklift. Heavy machinery can also include heavy-duty vehicles, especially those designed for executing construction tasks and those involving earthwork operations. In an aspect, such machinery can include construction equipment, earth movers, and engineering vehicles. In an aspect, a disclosed method can comprising modifying one or more steps of the method.

b. Method of Using a Sleeve for a Vertical Protrusion

Disclosed herein is a method comprising positioning a sleeve on an exposed aspect of a vertical protrusion. Disclosed herein is a method comprising identifying a vertical protrusion and positioning a sleeve on an exposed aspect of the vertical protrusion.

In an aspect, a vertical protrusion can comprise a survey stake or a conduit. In an aspect, a conduit comprises a liquid conduit or an electrical conduit. In an aspect, a liquid conduit can comprise a tube, pipe, or channel for conveying water or other fluid. In an aspect, an electrical conduit can comprise a tube or trough for protecting electrical wiring. In an aspect, an electrical conduit can be a rigid metal conduit, an intermediate metal conduit, an electrical metallic tubing, an electrical non-metallic tubing, a flexible metal conduit, a liquid-tight flexible metal conduit, or a rigid polyvinyl chloride conduit.

In an aspect, the term “positioned on” can mean that the inside of a disclosed sleeve can directly contact the exposed aspect of a vertical protrusion. For example, a disclosed sleeve can fit over and around the exposed aspect of a vertical protrusion. In an aspect, the term “exposed” can refer to that aspect of a vertical protrusion that extends from the surface of the ground or the earth, or the surface of a floor or wall or ceiling or roof, or the surface of a construction site, or the like. The non-exposed or unexposed aspect of a vertical protrusion is that aspect that is below the surface of the ground or the earth, or the surface of a floor or wall or ceiling or roof, or the surface of construction site, or the like.

In an aspect, a disclosed method can comprise identifying a vertical protrusion. In an aspect, identifying a vertical protrusion can comprise visually identifying the vertical protrusion in a given environment (such as, for example, an active or inactive construction zone or site, a wooded area, a grassy area, etc.). In an aspect, identifying a vertical protrusion can comprise using a map, a guide, a blueprint, a survey, a schematic, or a combination thereof to identify a previously placed vertical protrusion in a given environment.

In an aspect, positioning the sleeve can comprise fitting the sleeve over and around the exposed vertical protrusion. In an aspect, positioning the sleeve can ensure that the inside of the sleeve directly contacts the exposed vertical protrusion. In an aspect, positioning the sleeve can ensure that the disclosed sleeve can directly contact about 12″ to about 60″ or about 24″ to about 48″ of the exposed vertical protrusion. In an aspect, positioning the sleeve can ensure that the disclosed sleeve can directly contact about 12″, about 18″, about 24″, about 30″, about 36″, about 42″, or about 48″ of the exposed vertical protrusion.

In an aspect, a disclosed method can comprise identifying an appropriate sleeve for use with the exposed vertical protrusion. In an aspect, identifying an appropriate sleeve can comprise choosing a sleeve based on dimensions of the exposed vertical protrusion. In an aspect, a disclosed method can comprise determining the dimensions of the vertical protrusion. In an aspect, determining the dimensions of the exposed vertical protrusion can comprise measuring or ascertaining the height, width, length, radius, diameter, or a combination thereof of the vertical protrusion. Methods and techniques used to determine the dimensions of a vertical protrusion are well known to the art.

For example, in an aspect, a disclosed sleeve comprising a square or rectangular cross-sectional shape can comprise any width and any height so long as the disclosed sleeve can accommodate the size of the exposed vertical protrusion. For example, in an aspect, a disclosed sleeve comprising a circular cross-sectional shape can comprise any radius or diameter so long as the disclosed sleeve can accommodate the size of the exposed vertical protrusion.

In an aspect, a disclosed method can comprise removing the sleeve from the vertical protrusion. In an aspect, removing the sleeve can comprise allowing a period of time to elapse prior to removing the sleeve. In an aspect, a period of time can be the amount of time required for construction of a bridge, building, road, and other structures that surrounds, incorporates, or is nearby the vertical protrusion.

In an aspect, a disclosed method can comprise reusing the sleeve one or more times. In an aspect, a disclosed sleeve can be reused with the original vertical protrusion. In an aspect, a disclosed sleeve can be reused with a different vertical protrusion. In an aspect, a disclosed sleeve can be reused multiple times with the same vertical protrusion. In an aspect, a disclosed sleeve can be reused multiple times with a different vertical protrusion. In an aspect, a disclosed sleeve can be reused multiple times with the same vertical protrusion, a different vertical protrusion, or a combination thereof. For example, in an aspect, a disclosed sleeve can be used in connection with a first vertical protrusion, removed, reused with a second vertical protrusion, removed, and reused with a third vertical protrusion. In an aspect, a disclosed sleeve can be used in connection with a first vertical protrusion, removed, reused with a second vertical protrusion, removed, and then reused (or used again) with the vertical protrusion. Theoretically, a disclosed sleeve can be removed and reused multiple times so long as each vertical protrusion comprises about the same dimensions (e.g., about the same width and about the same height).

In an aspect, a disclosed method can comprise repairing the sleeve prior to reuse. For example, in an aspect, repairing the sleeve prior to reuse can comprise applying reflective material to the upper portion of the sleeve. In an aspect, the reflective material can be additional reflective material (i.e., added to reflective material already on the sleeve) or it can be new reflective material (i.e., added to a naked or bare sleeve). In an aspect, repairing the sleeve prior to reuse can comprise stripping or removing pre-existing reflective material and then adding new reflective material to the sleeve in the same pattern or new pattern (i.e., strips, bands, dots, etc.).

In an aspect, a disclosed method can comprise improving the visibility of the sleeve for a vertical protrusion. In an aspect, visibility of the sleeve can be improved during the construction of a bridge, a building, a road, or other structure. In an aspect, improving visibility of the sleeve can comprise improving the visibility of the sleeve to an operator of heavy machinery. Heavy machinery can include, but is not limited to, a backhoe, a wheel loader, a scraper, a dump truck, an excavator, a cement truck, a bulldozer, a road grader, a rock truck, a skid steer, and an all-terrain forklift. Heavy machinery can also include heavy-duty vehicles, especially those designed for executing construction tasks and those involving earthwork operations. In an aspect, such machinery can include construction equipment, earth movers, and engineering vehicles. In an aspect, a disclosed method can comprising modifying one or more steps of the method.

### C. Method of Using a Sleeve for a Survey Stake

Disclosed herein is a method comprising positioning a sleeve on an exposed aspect of a survey stake. Disclosed herein is a method comprising identifying a survey stake and positioning a sleeve on an exposed aspect of the survey stake.

In an aspect, the term “positioned on” can mean that the inside of a disclosed sleeve can directly contact the exposed aspect of a survey stake. For example, a disclosed sleeve can fit over and around the exposed aspect of a survey stake. In an aspect, the term “exposed” can refer to that aspect of a survey stake that extends from the surface of the ground or the earth, or the surface of a floor or wall or ceiling or roof, or the surface of a construction site, or the like. The non-exposed or unexposed aspect of a survey stake is that aspect that is below the surface of the ground or the earth, or the surface of a floor or wall or ceiling or roof, or the surface of construction site, or the like.

In an aspect, a disclosed method can comprise identifying a survey stake. In an aspect, identifying a survey stake can comprise visually identifying the survey stake in a given environment (such as, for example, an active or inactive construction zone or site, a wooded area, a grassy area, etc.). In an aspect, identifying a survey stake can comprise using a map, a guide, a blueprint, a survey, a schematic, or a combination thereof to identify a previously placed survey stake in a given environment.

In an aspect, positioning the sleeve can comprise fitting the sleeve over and around the exposed survey stake. In an aspect, positioning the sleeve can ensure that the inside of the sleeve directly contacts the exposed survey stake. In an aspect, positioning the sleeve can ensure that the disclosed sleeve can directly contact about 12″ to about 60″ or about 24″ to about 48″ of the exposed survey stake. In an aspect, positioning the sleeve can ensure that the disclosed sleeve can directly contact about 12″, about 18″, about 24″, about 30″, about 36″, about 42″, or about 48″ of the exposed survey stake.

In an aspect, a disclosed method can comprise identifying an appropriate sleeve for use with the exposed survey stake. In an aspect, identifying an appropriate sleeve can comprise choosing a sleeve based on dimensions of the exposed survey stake. In an aspect, a disclosed method can comprise determining the dimensions of the survey stake. In an aspect, determining the dimensions of the exposed survey stake can comprise measuring or ascertaining the height, width, length, radius, diameter, or a combination thereof of the survey stake. Methods and techniques used to determine the dimensions of a survey stake are well known to the art.

For example, in an aspect, a disclosed sleeve comprising a square or rectangular cross-sectional shape can comprise any width and any height so long as the disclosed sleeve can accommodate the size of the exposed survey stake. For example, in an aspect, a disclosed sleeve comprising a circular cross-sectional shape can comprise any radius or diameter so long as the disclosed sleeve can accommodate the size of the exposed survey stake.

In an aspect, a disclosed method can comprise removing the sleeve from the survey stake. In an aspect, removing the sleeve can comprise allowing a period of time to elapse prior to removing the sleeve. In an aspect, a period of time can be the amount of time required for construction of a bridge, building, road, and other structures that surrounds, incorporates, or is nearby the survey stake.

In an aspect, a disclosed method can comprise reusing the sleeve one or more times. In an aspect, a disclosed sleeve can be reused with the original survey stake. In an aspect, a disclosed sleeve can be reused with a different survey stake. In an aspect, a disclosed sleeve can be reused multiple times with the same survey stake. In an aspect, a disclosed sleeve can be reused multiple times with a different survey stake. In an aspect, a disclosed sleeve can be reused multiple times with the same survey stake, a different survey stake, or a combination thereof. For example, in an aspect, a disclosed sleeve can be used in connection with a first survey stake, removed, reused with a second survey stake, removed, and reused with a third survey stake. In an aspect, a disclosed sleeve can be used in connection with a first survey stake, removed, reused with a second survey stake, removed, and then reused (or used again) with the survey stake. Theoretically, a disclosed sleeve can be removed and reused multiple times so long as each survey stake comprises about the same dimensions (e.g., about the same width and about the same height).

In an aspect, a disclosed method can comprise repairing the sleeve prior to reuse. For example, in an aspect, repairing the sleeve prior to reuse can comprise applying reflective material to the upper portion of the sleeve. In an aspect, the reflective material can be additional reflective material (i.e., added to reflective material already on the sleeve) or it can be new reflective material (i.e., added to a naked or bare sleeve). In an aspect, repairing the sleeve prior to reuse can comprise stripping or removing pre-existing reflective material and then adding new reflective material to the sleeve in the same pattern or new pattern (i.e., strips, bands, dots, etc.).

In an aspect, a disclosed method can comprise improving the visibility of the sleeve. In an aspect, visibility of the sleeve can be improved during the construction of a bridge, a building, a road, or other structure. In an aspect, improving visibility of the sleeve can comprise improving the visibility of the sleeve to an operator of heavy machinery. Heavy machinery can include, but is not limited to, a backhoe, a wheel loader, a scraper, a dump truck, an excavator, a cement truck, a bulldozer, a road grader, a rock truck, a skid steer, and an all-terrain forklift. Heavy machinery can also include heavy-duty vehicles, especially those designed for executing construction tasks and those involving earthwork operations. In an aspect, such machinery can include construction equipment, earth movers, and engineering vehicles. In an aspect, a disclosed method can comprising modifying one or more steps of the method.

d. Method of Using a Sleeve for an Electrical Conduit

Disclosed herein is a method comprising positioning a sleeve on an exposed aspect of an electrical conduit. Disclosed herein is a method comprising identifying an electrical conduit and positioning a sleeve on an exposed aspect of the electrical conduit.

In an aspect, the term “positioned on” can mean that the inside of a disclosed sleeve can directly contact the exposed aspect of an electrical conduit. For example, a disclosed sleeve can fit over and around the exposed aspect of an electrical conduit. In an aspect, the term “exposed” can refer to that aspect of an electrical conduit that extends from the surface of the ground or the earth, or the surface of a floor or wall or ceiling or roof, or the surface of a construction site, or the like. The non-exposed or unexposed aspect of an electrical conduit is that aspect that is below the surface of the ground or the earth, or the surface of a floor or wall or ceiling or roof, or the surface of construction site, or the like.

In an aspect, a disclosed method can comprise identifying an electrical conduit. In an aspect, identifying an electrical conduit can comprise visually identifying the electrical conduit in a given environment (such as, for example, an active or inactive construction zone or site, a wooded area, a grassy area, etc.). In an aspect, identifying an electrical conduit can comprise using a map, a guide, a blueprint, a survey, a schematic, or a combination thereof to identify a previously placed electrical conduit in a given environment.

In an aspect, positioning the sleeve can comprise fitting the sleeve over and around the exposed electrical conduit. In an aspect, positioning the sleeve can ensure that the inside of the sleeve directly contacts the exposed electrical conduit. In an aspect, positioning the sleeve can ensure that the disclosed sleeve can directly contact about 12″ to about 60″ or about 24″ to about 48″ of the exposed electrical conduit. In an aspect, positioning the sleeve can ensure that the disclosed sleeve can directly contact about 12″, about 18″, about 24″, about 30″, about 36″, about 42″, or about 48″ of the exposed electrical conduit.

In an aspect, a disclosed method can comprise identifying an appropriate sleeve for use with the exposed electrical conduit. In an aspect, identifying an appropriate sleeve can comprise choosing a sleeve based on dimensions of the exposed electrical conduit. In an aspect, a disclosed method can comprise determining the dimensions of the electrical conduit. In an aspect, determining the dimensions of the exposed electrical conduit can comprise measuring or ascertaining the height, width, length, radius, diameter, or a combination thereof of the electrical conduit. Methods and techniques used to determine the dimensions of an electrical conduit are well known to the art.

For example, in an aspect, a disclosed sleeve comprising a square or rectangular cross-sectional shape can comprise any width and any height so long as the disclosed sleeve can accommodate the size of the exposed electrical conduit. For example, in an aspect, a disclosed sleeve comprising a circular cross-sectional shape can comprise any radius or diameter so long as the disclosed sleeve can accommodate the size of the exposed electrical conduit.

In an aspect, a disclosed method can comprise removing the sleeve from the electrical conduit. In an aspect, removing the sleeve can comprise allowing a period of time to elapse prior to removing the sleeve. In an aspect, a period of time can be the amount of time required for construction of a bridge, building, road, and other structures that surrounds, incorporates, or is nearby the electrical conduit.

In an aspect, a disclosed method can comprise reusing the sleeve one or more times. In an aspect, a disclosed sleeve can be reused with the original electrical conduit. In an aspect, a disclosed sleeve can be reused with a different electrical conduit. In an aspect, a disclosed sleeve can be reused multiple times with the same electrical conduit. In an aspect, a disclosed sleeve can be reused multiple times with a different electrical conduit. In an aspect, a disclosed sleeve can be reused multiple times with the same electrical conduit, a different electrical conduit, or a combination thereof.

For example, in an aspect, a disclosed sleeve can be used in connection with a first electrical conduit, removed, reused with a second electrical conduit, removed, and reused with an electrical conduit. In an aspect, a disclosed sleeve can be used in connection with a first electrical conduit, removed, reused with a second electrical conduit, removed, and then reused (or used again) with the electrical conduit. Theoretically, a disclosed sleeve can be removed and reused multiple times so long as each electrical conduit comprises about the same dimensions (e.g., about the same width and about the same height).

In an aspect, a disclosed method can comprise repairing the sleeve prior to reuse. For example, in an aspect, repairing the sleeve prior to reuse can comprise applying reflective material to the upper portion of the sleeve. In an aspect, the reflective material can be additional reflective material (i.e., added to reflective material already on the sleeve) or it can be new reflective material (i.e., added to a naked or bare sleeve). In an aspect, repairing the sleeve prior to reuse can comprise stripping or removing pre-existing reflective material and then adding new reflective material to the sleeve in the same pattern or new pattern (i.e., strips, bands, dots, etc.).

In an aspect, a disclosed method can comprise improving the visibility of the sleeve. In an aspect, visibility of the sleeve can be improved during the construction of a bridge, a building, a road, or other structure. In an aspect, improving visibility of the sleeve can comprise improving the visibility of the sleeve to an operator of heavy machinery. Heavy machinery can include, but is not limited to, a backhoe, a wheel loader, a scraper, a dump truck, an excavator, a cement truck, a bulldozer, a road grader, a rock truck, a skid steer, and an all-terrain forklift. Heavy machinery can also include heavy-duty vehicles, especially those designed for executing construction tasks and those involving earthwork operations. In an aspect, such machinery can include construction equipment, earth movers, and engineering vehicles. In an aspect, a disclosed method can comprising modifying one or more steps of the method.

e. Method of Using a Sleeve for a Liquid Conduit

Disclosed herein is a method comprising positioning a sleeve on an exposed aspect of a liquid conduit. Disclosed herein is a method comprising identifying a liquid conduit and positioning a sleeve on an exposed aspect of the liquid conduit.

In an aspect, the term “positioned on” can mean that the inside of a disclosed sleeve can directly contact the exposed aspect of a liquid conduit. For example, a disclosed sleeve can fit over and around the exposed aspect of a liquid conduit. In an aspect, the term “exposed” can refer to that aspect of a liquid conduit that extends from the surface of the ground or the earth, or the surface of a floor or wall or ceiling or roof, or the surface of a construction site, or the like. The non-exposed or unexposed aspect of a liquid conduit is that aspect that is below the surface of the ground or the earth, or the surface of a floor or wall or ceiling or roof, or the surface of construction site, or the like.

In an aspect, a disclosed method can comprise identifying a liquid conduit. In an aspect, identifying a liquid conduit can comprise visually identifying the liquid conduit in a given environment (such as, for example, an active or inactive construction zone or site, a wooded area, a grassy area, etc.). In an aspect, identifying a liquid conduit can comprise using a map, a guide, a blueprint, a survey, a schematic, or a combination thereof to identify a previously placed electrical conduit in a given environment.

In an aspect, positioning the sleeve can comprise fitting the sleeve over and around the exposed liquid conduit. In an aspect, positioning the sleeve can ensure that the inside of the sleeve directly contacts the exposed liquid conduit. In an aspect, positioning the sleeve can ensure that the disclosed sleeve can directly contact about 12″ to about 60″ or about 24″ to about 48″ of the exposed liquid conduit. In an aspect, positioning the sleeve can ensure that the disclosed sleeve can directly contact about 12″, about 18″, about 24″, about 30″, about 36″, about 42″, or about 48″ of the exposed liquid conduit.

In an aspect, a disclosed method can comprise identifying an appropriate sleeve for use with the exposed liquid conduit. In an aspect, identifying an appropriate sleeve can comprise choosing a sleeve based on dimensions of the exposed liquid conduit. In an aspect, a disclosed can comprise determining the dimensions of the liquid conduit. In an aspect, determining the dimensions of the exposed liquid conduit can comprise measuring or ascertaining the height, width, length, radius, diameter, or a combination thereof of the liquid conduit. Methods and techniques used to determine the dimensions of a liquid conduit are well known to the art.

For example, in an aspect, a disclosed sleeve comprising a square or rectangular cross-sectional shape can comprise any width and any height so long as the disclosed sleeve can accommodate the size of the exposed liquid conduit. For example, in an aspect, a disclosed sleeve comprising a circular cross-sectional shape can comprise any radius or diameter so long as the disclosed sleeve can accommodate the size of the exposed liquid conduit.

In an aspect, a disclosed method can comprise removing the sleeve from the liquid conduit. In an aspect, removing the sleeve can comprise allowing a period of time to elapse prior to removing the sleeve. In an aspect, a period of time can be the amount of time required for construction of a bridge, building, road, and other structures that surrounds, incorporates, or is nearby the liquid conduit.

In an aspect, a disclosed method can comprise reusing the sleeve one or more times. In an aspect, a disclosed sleeve can be reused with the original liquid conduit. In an aspect, a disclosed sleeve can be reused with a different liquid conduit. In an aspect, a disclosed sleeve can be reused multiple times with the same liquid conduit. In an aspect, a disclosed sleeve can be reused multiple times with a different liquid conduit. In an aspect, a disclosed sleeve can be reused multiple times with the same liquid conduit, a different liquid conduit, or a combination thereof.

For example, in an aspect, a disclosed sleeve can be used in connection with a first liquid conduit, removed, reused with a second liquid conduit, removed, and reused with a liquid conduit. In an aspect, a disclosed sleeve can be used in connection with a first liquid conduit, removed, reused with a second liquid conduit, removed, and then reused (or used again) with the liquid conduit. Theoretically, a disclosed sleeve can be removed and reused multiple times so long as each liquid conduit comprises about the same dimensions (e.g., about the same width and about the same height).

In an aspect, a disclosed method can comprise repairing the sleeve prior to reuse. For example, in an aspect, repairing the sleeve prior to reuse can comprise applying reflective material to the upper portion of the sleeve. In an aspect, the reflective material can be additional reflective material (i.e., added to reflective material already on the sleeve) or it can be new reflective material (i.e., added to a naked or bare sleeve). In an aspect, repairing the sleeve prior to reuse can comprise stripping or removing pre-existing reflective material and then adding new reflective material to the sleeve in the same pattern or new pattern (i.e., strips, bands, dots, etc.).

In an aspect, the method can comprise improving the visibility of the sleeve. In an aspect, visibility of the sleeve can be improved during the construction of a bridge, a building, a road, or other structure. In an aspect, improving visibility of the sleeve can comprise improving the visibility of the sleeve to an operator of heavy machinery. Heavy machinery can include, but is not limited to, a backhoe, a wheel loader, a scraper, a dump truck, an excavator, a cement truck, a bulldozer, a road grader, a rock truck, a skid steer, and an all-terrain forklift. Heavy machinery can also include heavy-duty vehicles, especially those designed for executing construction tasks and those involving earthwork operations. In an aspect, such machinery can include construction equipment, earth movers, and engineering vehicles. In an aspect, a disclosed method can comprising modifying one or more steps of the method.

### 2. Methods of Improving Visibility

Disclosed herein are methods of improving visibility of a horizontal, angular, or vertical protrusion. Disclosed herein are methods of improving visibility of an electrical or a liquid conduit.

### A. Method of Improving Visibility of a Horizontal or Angular Protrusion

Disclosed herein is a method comprising positioning a sleeve on an exposed aspect of a horizontal or angular protrusion and improving the visibility of the sleeve.

In an aspect, the term “positioned on” can mean that the inside of a disclosed sleeve can directly contact the exposed aspect of a horizontal or angular protrusion. For example, a disclosed sleeve can fit over and around the exposed aspect of a horizontal or angular protrusion. In an aspect, the term “exposed” can refer to that aspect of a horizontal or angular protrusion that extends from the surface of the ground or the earth, or the surface of a floor or wall or ceiling or roof, or the surface of a construction site, or the like. The non-exposed or unexposed aspect of a horizontal or angular protrusion is that aspect that is below the surface of the ground or the earth, or the surface of a floor or wall or ceiling or roof, or the surface of construction site, or the like.

In an aspect, a disclosed method can comprise identifying a horizontal or angular protrusion. In an aspect, identifying a horizontal or angular protrusion can comprise visually identifying a horizontal or angular protrusion in a given environment (such as, for example, an active or inactive construction zone or site, a wooded area, a grassy area, etc.). In an aspect, identifying a horizontal or angular protrusion can comprise using a map, a guide, a blueprint, a survey, a schematic, or a combination thereof to identify a previously placed horizontal or angular protrusion in a given environment.

In an aspect, positioning the sleeve can comprise fitting the sleeve over and around the exposed horizontal or angular protrusion. In an aspect, positioning the sleeve can ensure that the inside of the sleeve directly contacts the exposed horizontal or angular protrusion. In an aspect, positioning the sleeve can ensure that the disclosed sleeve can directly contact about 12″ to about 60″ or about 24″ to about 48″ of the exposed horizontal or angular protrusion. In an aspect, positioning the sleeve can ensure that the disclosed sleeve can directly contact about 12″, about 18″, about 24″, about 30″, about 36″, about 42″, or about 48″ of the exposed horizontal or angular protrusion.

In an aspect, a disclosed method can comprise identifying an appropriate sleeve for use with the exposed horizontal or angular protrusion. In an aspect, identifying an appropriate sleeve can comprise choosing a sleeve based on dimensions of the exposed horizontal or angular protrusion. In an aspect, a disclosed method can comprise determining the dimensions of the horizontal or angular protrusion. In an aspect, determining the dimensions of the exposed horizontal or angular protrusion can comprise measuring or ascertaining the height, width, length, radius, diameter, or a combination thereof of the horizontal or angular protrusion. Methods and techniques used to determine the dimensions of a horizontal or angular protrusion are well known to the art.

In an aspect, visibility of a disclosed sleeve for a horizontal or angular protrusion can be improved during the construction of a bridge, a building, a road, or other structure. In an aspect, improving visibility of a disclosed sleeve can comprise improving the visibility of the sleeve to an operator of heavy machinery. Heavy machinery can include, but is not limited to, a backhoe, a wheel loader, a scraper, a dump truck, an excavator, a cement truck, a bulldozer, a road grader, a rock truck, a skid steer, and an all-terrain forklift. Heavy machinery can also include heavy-duty vehicles, especially those designed for executing construction tasks and those involving earthwork operations. In an aspect, such machinery can include construction equipment, earth movers, and engineering vehicles. In an aspect, a disclosed method can comprising modifying one or more steps of the method.

b. Method of Improving Visibility of a Vertical Protrusion

Disclosed herein is a method comprising positioning a sleeve on an exposed aspect of a vertical protrusion and improving the visibility of the sleeve.

In an aspect, the term “positioned on” can mean that the inside of a disclosed sleeve can directly contact the exposed aspect of a vertical protrusion. For example, a disclosed sleeve can fit over and around the exposed aspect of a vertical protrusion. In an aspect, the term “exposed” can refer to that aspect of a vertical protrusion that extends from the surface of the ground or the earth, or the surface of a floor or wall or ceiling or roof, or the surface of a construction site, or the like. The non-exposed or unexposed aspect of a vertical protrusion is that aspect that is below the surface of the ground or the earth, or the surface of a floor or wall or ceiling or roof, or the surface of construction site, or the like.

In an aspect, a disclosed method can comprise identifying a vertical protrusion. In an aspect, identifying a vertical protrusion can comprise visually identifying a vertical protrusion in a given environment (such as, for example, an active or inactive construction zone or site, a wooded area, a grassy area, etc.). In an aspect, identifying a vertical protrusion can comprise using a map, a guide, a blueprint, a survey, a schematic, or a combination thereof to identify a previously placed vertical protrusion in a given environment.

In an aspect, positioning the sleeve can comprise fitting the sleeve over and around the exposed vertical protrusion. In an aspect, positioning the sleeve can ensure that the inside of the sleeve directly contacts the exposed vertical protrusion. In an aspect, positioning the sleeve can ensure that the disclosed sleeve can directly contact about 12″ to about 60″ or about 24″ to about 48″ of the exposed vertical protrusion. In an aspect, positioning the sleeve can ensure that the disclosed sleeve can directly contact about 12″, about 18″, about 24″, about 30″, about 36″, about 42″, or about 48″ of the exposed vertical protrusion.

In an aspect, a disclosed method can comprise identifying an appropriate sleeve for use with the exposed vertical protrusion. In an aspect, identifying an appropriate sleeve can comprise choosing a sleeve based on dimensions of the exposed vertical protrusion. In an aspect, a disclosed method can comprise determining the dimensions of the vertical protrusion. In an aspect, determining the dimensions of the exposed vertical protrusion can comprise measuring or ascertaining the height, width, length, radius, diameter, or a combination thereof of the vertical protrusion. Methods and techniques used to determine the dimensions of a vertical protrusion are well known to the art.

In an aspect, visibility of a disclosed sleeve for a vertical protrusion can be improved during the construction of a bridge, a building, a road, or other structure. In an aspect, improving visibility of a disclosed sleeve can comprise improving the visibility of the sleeve to an operator of heavy machinery. Heavy machinery can include, but is not limited to, a backhoe, a wheel loader, a scraper, a dump truck, an excavator, a cement truck, a bulldozer, a road grader, a rock truck, a skid steer, and an all-terrain forklift. Heavy machinery can also include heavy-duty vehicles, especially those designed for executing construction tasks and those involving earthwork operations. In an aspect, such machinery can include construction equipment, earth movers, and engineering vehicles. In an aspect, a disclosed method can comprising modifying one or more steps of the method.

c. Method of Improving Visibility of a Survey Stake

Disclosed herein is a method comprising positioning a sleeve on an exposed aspect of a survey stake and improving the visibility of the sleeve.

In an aspect, the term “positioned on” can mean that the inside of a disclosed sleeve can directly contact the exposed aspect of a survey stake. For example, a disclosed sleeve can fit over and around the exposed aspect of a survey stake. In an aspect, the term “exposed” can refer to that aspect of a survey stake that extends from the surface of the ground or the earth, or the surface of a floor or wall or ceiling or roof, or the surface of a construction site, or the like. The non-exposed or unexposed aspect of a survey stake is that aspect that is below the surface of the ground or the earth, or the surface of a floor or wall or ceiling or roof, or the surface of construction site, or the like.

In an aspect, a disclosed method can comprise identifying a survey stake. In an aspect, identifying a survey stake can comprise visually identifying a survey stake in a given environment (such as, for example, an active or inactive construction zone or site, a wooded area, a grassy area, etc.). In an aspect, identifying a survey stake can comprise using a map, a guide, a blueprint, a survey, a schematic, or a combination thereof to identify a previously placed survey stake in a given environment.

In an aspect, positioning the sleeve can comprise fitting the sleeve over and around the exposed survey stake. In an aspect, positioning the sleeve can ensure that the inside of the sleeve directly contacts the exposed survey stake. In an aspect, positioning the sleeve can ensure that the disclosed sleeve can directly contact about 12″ to about 60″ or about 24″ to about 48″ of the exposed survey stake. In an aspect, positioning the sleeve can ensure that the disclosed sleeve can directly contact about 12″, about 18″, about 24″, about 30″, about 36″, about 42″, or about 48″ of the exposed survey stake.

In an aspect, a disclosed method can comprise identifying an appropriate sleeve for use with the exposed survey stake. In an aspect, identifying an appropriate sleeve can comprise choosing a sleeve based on dimensions of the exposed survey stake. In an aspect, a disclosed method can comprise determining the dimensions of the survey stake. In an aspect, determining the dimensions of the exposed survey stake can comprise measuring or ascertaining the height, width, length, radius, diameter, or a combination thereof of the survey stake. Methods and techniques used to determine the dimensions of a survey stake are well known to the art.

In an aspect, visibility of a disclosed sleeve for a survey stake can be improved during the construction of a bridge, a building, a road, or other structure. In an aspect, improving visibility of a disclosed sleeve can comprise improving the visibility of the sleeve to an operator of heavy machinery. Heavy machinery can include, but is not limited to, a backhoe, a wheel loader, a scraper, a dump truck, an excavator, a cement truck, a bulldozer, a road grader, a rock truck, a skid steer, and an all-terrain forklift. Heavy machinery can also include heavy-duty vehicles, especially those designed for executing construction tasks and those involving earthwork operations. In an aspect, such machinery can include construction equipment, earth movers, and engineering vehicles. In an aspect, a disclosed method can comprising modifying one or more steps of the method.

d. Method of Improving Visibility of an Electrical Conduit

Disclosed herein is a method comprising positioning a sleeve on an exposed aspect of an electrical conduit and improving the visibility of the sleeve.

In an aspect, the term “positioned on” can mean that the inside of a disclosed sleeve can directly contact the exposed aspect of an electrical conduit. For example, a disclosed sleeve can fit over and around the exposed aspect of an electrical conduit. In an aspect, the term “exposed” can refer to that aspect of an electrical conduit that extends from the surface of the ground or the earth, or the surface of a floor or wall or ceiling or roof, or the surface of a construction site, or the like. The non-exposed or unexposed aspect of an electrical conduit is that aspect that is below the surface of the ground or the earth, or the surface of a floor or wall or ceiling or roof, or the surface of construction site, or the like.

In an aspect, a disclosed method can comprise identifying an electrical conduit. In an aspect, identifying an electrical conduit can comprise visually identifying an electrical conduit in a given environment (such as, for example, an active or inactive construction zone or site, a wooded area, a grassy area, etc.). In an aspect, identifying an electrical conduit can comprise using a map, a guide, a blueprint, a survey, a schematic, or a combination thereof to identify a previously placed electrical conduit in a given environment.

In an aspect, positioning the sleeve can comprise fitting the sleeve over and around the exposed electrical conduit. In an aspect, positioning the sleeve can ensure that the inside of the sleeve directly contacts the exposed electrical conduit. In an aspect, positioning the sleeve can ensure that the disclosed sleeve can directly contact about 12″ to about 60″ or about 24″ to about 48″ of the exposed electrical conduit. In an aspect, positioning the sleeve can ensure that the disclosed sleeve can directly contact about 12″, about 18″, about 24″, about 30″, about 36″, about 42″, or about 48″ of the exposed electrical conduit.

In an aspect, a disclosed method can comprise identifying an appropriate sleeve for use with the exposed electrical conduit. In an aspect, identifying an appropriate sleeve can comprise choosing a sleeve based on dimensions of the exposed electrical conduit. In an aspect, a disclosed method can comprise determining the dimensions of the electrical conduit. In an aspect, determining the dimensions of the exposed electrical conduit can comprise measuring or ascertaining the height, width, length, radius, diameter, or a combination thereof of the electrical conduit. Methods and techniques used to determine the dimensions of an electrical conduit are well known to the art.

In an aspect, visibility of a disclosed sleeve for an electrical conduit can be improved during the construction of a bridge, a building, a road, or other structure. In an aspect, improving visibility of a disclosed sleeve can comprise improving the visibility of the sleeve to an operator of heavy machinery. Heavy machinery can include, but is not limited to, a backhoe, a wheel loader, a scraper, a dump truck, an excavator, a cement truck, a bulldozer, a road grader, a rock truck, a skid steer, and an all-terrain forklift. Heavy machinery can also include heavy-duty vehicles, especially those designed for executing construction tasks and those involving earthwork operations. In an aspect, such machinery can include construction equipment, earth movers, and engineering vehicles. In an aspect, a disclosed method can comprising modifying one or more steps of the method.

e. Method of Improving Visibility of a Liquid Conduit

Disclosed herein is a method comprising positioning a sleeve on an exposed aspect of a liquid conduit and improving the visibility of the sleeve.

In an aspect, the term “positioned on” can mean that the inside of a disclosed sleeve can directly contact the exposed aspect of a liquid conduit. For example, a disclosed sleeve can fit over and around the exposed aspect of a liquid conduit. In an aspect, the term “exposed” can refer to that aspect of a liquid conduit that extends from the surface of the ground or the earth, or the surface of a floor or wall or ceiling or roof, or the surface of a construction site, or the like. The non-exposed or unexposed aspect of a liquid conduit is that aspect that is below the surface of the ground or the earth, or the surface of a floor or wall or ceiling or roof, or the surface of construction site, or the like.

In an aspect, a disclosed method can comprise identifying a liquid conduit. In an aspect, identifying a survey stake can comprise visually identifying a liquid conduit in a given environment (such as, for example, an active or inactive construction zone or site, a wooded area, a grassy area, etc.). In an aspect, identifying a liquid conduit can comprise using a map, a guide, a blueprint, a survey, a schematic, or a combination thereof to identify a previously placed liquid conduit in a given environment.

In an aspect, positioning the sleeve can comprise fitting the sleeve over and around the exposed liquid conduit. In an aspect, positioning the sleeve can ensure that the inside of the sleeve directly contacts the exposed liquid conduit. In an aspect, positioning the sleeve can ensure that the disclosed sleeve can directly contact about 12″ to about 60″ or about 24″ to about 48″ of the exposed liquid conduit. In an aspect, positioning the sleeve can ensure that the disclosed sleeve can directly contact about 12″, about 18″, about 24″, about 30″, about 36″, about 42″, or about 48″ of the exposed liquid conduit.

In an aspect, a disclosed method can comprise identifying an appropriate sleeve for use with the exposed liquid conduit. In an aspect, identifying an appropriate sleeve can comprise choosing a sleeve based on dimensions of the exposed liquid conduit. In an aspect, a disclosed method can comprise determining the dimensions of the liquid conduit. In an aspect, determining the dimensions of the exposed liquid conduit can comprise measuring or ascertaining the height, width, length, radius, diameter, or a combination thereof of the liquid conduit. Methods and techniques used to determine the dimensions of a liquid conduit are well known to the art.

In an aspect, visibility of a disclosed sleeve for a liquid conduit can be improved during the construction of a bridge, a building, a road, or other structure. In an aspect, improving visibility of a disclosed sleeve can comprise improving the visibility of the sleeve to an operator of heavy machinery. Heavy machinery can include, but is not limited to, a backhoe, a wheel loader, a scraper, a dump truck, an excavator, a cement truck, a bulldozer, a road grader, a rock truck, a skid steer, and an all-terrain forklift. Heavy machinery can also include heavy-duty vehicles, especially those designed for executing construction tasks and those involving earthwork operations. In an aspect, such machinery can include construction equipment, earth movers, and engineering vehicles. In an aspect, a disclosed method can comprising modifying one or more steps of the method.

### D. Kits

Disclosed herein is a kit comprising one or more disclosed sleeves. Disclosed herein is a kit comprising one or more disclosed sleeves and instructions for using the one or more disclosed sleeves. Disclosed herein is a kit comprising one or more disclosed sleeves and reflective material. Disclosed herein is a kit comprising one or more disclosed sleeves, reflective material, and instructions for using the one or more disclosed sleeves. Disclosed herein is a kit comprising one or more disclosed sleeves, reflective material, and instructions for applying reflective material. Disclosed herein is a kit comprising one or more disclosed sleeves, reflective material, instructions for applying reflective material, and instructions for using the one or more disclosed sleeves. Disclosed herein is a kit comprising one or more disclosed sleeves, and instructions for repairing one or more disclosed sleeves, instructions for using the one or more disclosed sleeves, or a combination thereof.

1. A sleeve for placement on a survey stake, comprising:
an elongate body comprising an upper portion and a lower portion,
wherein each portion of the elongate body comprises an open end,
wherein the upper portion comprises a reflective material, and
wherein the lower portion directly contacts the exposed aspect of a survey stake.

2. The sleeve of claim 1, wherein the sleeve is one piece having no seam.

3. The sleeve of claim 1, wherein the sleeve is reusable.

4. The sleeve of claim 1, wherein the sleeve comprises a circular cross-sectional shape.

5. The sleeve of claim 4, wherein the sleeve is about 1½″ in diameter.

6. The sleeve of claim 1, wherein the wall thickness of the sleeve is about 0.04″.

7. The sleeve of claim 1, wherein the elongate body comprises UV resistant butyrate.

8. The sleeve of claim 1, wherein the sleeve directly contacts about 18″-about 24″ of the exposed survey stake.

9. The sleeve of claim 1, wherein the sleeve is about 48″-about 60″ in length.

10. The sleeve of claim 1, wherein the reflective material comprise horizontal stripes or bands of reflective material.

11. The sleeve of claim 1, wherein the open end of the upper portion comprises a cap.

12. The sleeve of claim 1, wherein the upper portion comprises one or more wind vents.

13. A method, comprising:
identifying a survey stake and positioning a sleeve on the exposed aspect of the survey stake, wherein the sleeve comprises an elongate body comprising an upper portion and a lower portion, wherein each portion of the elongate body comprises an open end, wherein the upper portion comprises a reflective material, and wherein the lower portion directly contacts the exposed aspect of a survey stake.

14. The method of claim 13, wherein identifying a survey stake comprises visually identifying the survey stake in a given environment.

15. The method of claim 13, comprising identifying an appropriate sleeve for use with the survey stake.

16. The method of claim 13, comprising removing the sleeve from the exposed aspect of the survey stake.

17. The method of claim 16, comprising reusing the removed sleeve one or more times.

18. The method of claim 17, comprising repairing the removed sleeve prior to reusing the sleeve.

19. The method of claim 13, comprising improving the visibility of the survey stake.
